(19) United States
(12) Patent Application Publication
(10) Pub. No.: US 2026/0297283 A1
(43) Pub. Date: Oct. 1, 2026

(54) UPCYCLING OF POLYETHYLENE AND POLYPROPYLENE AND THEIR MIXTURES TO HIGH-VALUE SURFACTANTS

(71) Applicant: VIRGINIA TECH INTELLECTUAL PROPERTIES, Blacksburg, VA (US)

(72) Inventors: Guoliang LIU, Blacksburg, VA (US); Zhen XU, Blacksburg, VA (US); Eric MUNYANEZA NUWAYO, Blacksburg, VA (US)

(21) Appl. No.: 19/479,708

(22) PCT Filed: Apr. 28, 2024
(86) PCT No.: PCT/US2024/026720

§ 371 Date: Oct. 28, 2025

Related U.S. Application Data
(60) Provisional application No. 63/462,863, filed on Apr. 28, 2023.

(51) Int. Cl. C08J 11/10

(52) U.S. Cl. CPC C08J 11/10; C08J 2323/06; C08J 2323/12

(57) ABSTRACT

Herein, a method for controlling the thermolysis products molar mass using a coolant fluid (e.g., water) to modulate the final products' condensation temperatures. With this strategy, the thermolysis of polyethylene (PE) and polypropylene (PP) is tailored to generate liquid oil, without any catalysts or additives. Subsequent addition of sulfuric acid across the alkenyl groups, followed by the neutralization with sodium hydroxide affords sulfate detergents with excellent foaming behavior.

### CROSS-REFERENCE TO RELATED APPLICATIONS

This application claims priority to, and the benefit of, co-pending U.S. provisional application entitled “UPCYCLING OF POLYETHYLENE AND POLYPROYLENE AND THEIR MIXTURES TO HIGH-VALUE SURFACTANTS” having Ser. No. 63/462,863 filed Apr. 28, 2023, the contents of which are incorporated by reference herein.

### STATEMENT REGARDING FEDERALLY SPONSORED RESEARCH OR DEVELOPMENT

This invention was made with government support under award DMR1752611, awarded by the National Science Foundation. The government has certain rights in the invention.

### TECHNICAL FIELD

The present disclosure generally relates to manufacturing of ionic detergents/surfactants and diesel fuels, and, in particular, polyethylene and polypropylene-based alkyl sulfates that exhibit excellent foaming properties and can thus be utilized for cleaning purposes, industrial processes, or, once hydrogenated, into inexpensive fuels.

### BACKGROUND

Plastic waste accumulation is one major environmental challenge currently faced by the planet. Globally, 380 million tons of plastics are produced annually, and close to 75% are disposed of after single use.^{[1]} Polyethylene (PE) and polypropylene (PP), in particular, account for 60% of all plastics and constitute a large proportion of the discarded waste.^{[2-3]} To meaningfully disrupt the plastic waste accumulation trend and minimize carbon emission, it is critical to increase the recycling rate and extend the material service life in accordance with the Kyoto Protocols and Paris Accords.^{[4]} Traditional recycling strategies (i.e., mechanical recycling) help close the plastic loop, but the quality of the regenerated plastics inevitably deteriorates and the market value decreases. After a number of cycles, the plastics reach the end of life. Using the end-of-life plastics as an inexpensive feedstock for producing value-added chemicals is a highly attractive alternative to complement traditional approaches.

In this context, conversion of plastics such as PE and PP to liquid fuel and other high-value chemicals is an enticing strategy.^{[5-6]} Typically, elevated temperatures and long reaction times are required to pyrolyze polyolefins into oil.^{[7]} The pyrolysis oil is often subject to additional hydrotreatment to hydrogenate unsaturated hydrocarbons^{[8-9]} and improve the fuel quality. Because the pyrolysis oil is a complex mixture and has a wide range of boiling points, it is fractionated into naphtha and diesel range hydrocarbons to afford specific transportation fuel grades.^{[10]}

In polyolefin pyrolysis, there remains a need for the control over the oil-to-wax selectivity, in other words, hydrocarbon product distribution (HPD).

### SUMMARY OF THE DISCLOSURE

In various aspects, the present disclosure provides methods of preparing fatty acids. The methods of preparing fatty acids described in the present disclosure overcome many of the deficiencies with prior methods of preparing fatty acids, for example the methods described herein uses underutilized resources to generate detergents of high value and ionic detergents. This work highlights a viable chemical strategy to obtain indispensable high-value products from plastic waste, while contributing to the goal of achieving a circular economy. In addition, the fatty acids produced by the methods described herein open up an opportunity for alternative fuel applications.

In some aspects, the techniques described herein relate to a method of preparing waxes and/or oils from olefin-derived products including: heating a polymer selected from the group consisting of a polypropylene, a polyethylene, and a combination thereof, in a vessel in fluid communication with a condenser to provide a sublimated mixture of waxes and/or oils collected on the condenser or heat controlling system, wherein the heating includes raising the temperature of the vessel to a target temperature over a first period of time and maintaining the vessel at or near the target temperature for a second period of time to provide a mixture of waxes and/or oils.

In some aspects, the techniques described herein relate to a method wherein raising the temperature of the vessel includes heating at a rate of about 10° C. to about 30° C. per minute over the first period of time.

In some aspects, the techniques described herein relate to a method, wherein the second period of time is from 1 to 48 hours, from 1 to 24 hours, from 1 to 20 hours, or from 5 to 20 hours.

In some aspects, the techniques described herein relate to a method, wherein raising the temperature of the vessel includes heating a bottom of the vessel to the target temperature in three steps at a step size of about 80° C. to about 120° C. per 5 min.

In some aspects, the techniques described herein relate to a method of preparing mixture of waxes and/or oils including introducing a polymer selected from the group consisting of a polypropylene, a polyethylene, and a combination thereof into a continuous flow reaction vessel in fluid communication with a condenser or heating control system to provide a sublimated mixture of waxes and/or oils collected on the condenser or heating control system, wherein the continuous flow reaction vessel is at or near a target temperature and wherein the polymer has a residence time in the continuous flow reaction vessel to provide a mixture of waxes and/or oils.

In some aspects, the techniques described herein relate to a method, wherein the residence time is from 1 to 48 hours, from 1 to 24 hours, from 1 to 20 hours, or from 5 to 20 hours.

In some aspects, the techniques described herein relate to a method, wherein the target temperature is about 250° C. to 500° C.

In some aspects, the techniques described herein relate to a method, wherein the target temperature is 260° C. to 490° C., 270° C. to 480° C., 290° C. to 460° C., 310° C. to 440° C., 330° C. to 420° C., 350° C. to 400° C., 370° C. to 380° C.

In some aspects, the techniques described herein relate to a method, wherein the target temperature is about 320° C. to 350° C.

In some aspects, the techniques described herein relate to a method, wherein the target temperature is 320° C. to 400° C., or at 340° C. to 380° C., at 320° C. to 370° C., or at 330° C. to 360° C.

In some aspects, the techniques described herein relate to a method, wherein the polymer is exposed to ambient air.

In some aspects, the techniques described herein relate to a method, wherein the polymer is exposed to an inert gas in the vessel.

In some aspects, the techniques described herein relate to a method, wherein the inert gas is nitrogen or argon.

In some aspects, the techniques described herein relate to a method, wherein the polymer is exposed to oxygen gas admixed with an inert gas in the vessel.

In some aspects, the techniques described herein relate to a method, wherein the polymer is exposed to air admixed with an inert gas in the vessel.

In some aspects, the techniques described herein relate to a method, wherein the vessel is heated at atmospheric pressure.

In some aspects, the techniques described herein relate to a method, wherein the polymer is selected from the group consisting of a crosslinked polypropylene, a crosslinked polyethylene, a linear polypropylene, a linear polyethylene, and combinations thereof.

In some aspects, the techniques described herein relate to a method, wherein the polymer is selected from the group consisting of a high-density polyethylene, a low-density polyethylene, a linear low-density polyethylene, a polyethylene copolymer, a polypropylene copolymer, and a high-density crosslinked polyethylene.

In some aspects, the techniques described herein relate to a method, wherein a % mass conversion of the polymer to the mixture of waxes is from about 85% to 99%, or from about 85% to 95%, or from about 85% to 90%, or from about 90% to 95%.

In some aspects, the techniques described herein relate to a method, wherein a temperature difference between the vessel and the condenser surface is about 300° C. to 400° C., or about 325° C. to 375° C.

In some aspects, the techniques described herein relate to a method, wherein the target temperature is about −195° C. to 250° C.

In some aspects, the techniques described herein relate to a method, wherein the condenser surface has a temperature of −185° C. to 240° C., −175° C. to 230° C., −165° C. to 220° C., −155° C. to 210° C., −145° C. to 200° C., −135° C. to 190° C., −125° C. to 180° C., −115° C. to 170° C., −105° C. to 160° C., −95° C. to 150° C., −85° C. to 140° C., −75° C. to 130° C., −65° C. to 120° C., −55° C. to 110° C., −45° C. to 100° C., −35° C. to 90° C., −25° C. to 80° C., −15° C. to 70° C., −5° C. to 60° C., 5° C. to 50° C., 15° C. to 40° C., 25° C. to 30° C.

In some aspects, the techniques described herein relate to a method, wherein the vessel, condenser, or both includes a quartz surface.

In some aspects, the techniques described herein relate to a method, wherein a wt % of light hydrocarbons having 8 or fewer carbon atoms in the mixture of waxes and/or oils is about 10 wt %, 8 wt %, 5 wt %, or less based upon a total weight of the mixture of waxes and/or oils.

In some aspects, the techniques described herein relate to a method, wherein the method further includes adding sulfuric acid to the mixture of waxes and/or oils.

In some aspects, the techniques described herein relate to a method, wherein the mixture of waxes and/or oils independently has a hydrocarbon length of C7-C26 and is either acyclic, cyclic or a combination thereof.

In some aspects, the techniques described herein relate to a method, wherein the mixture of waxes and/or oils are independently unsaturated hydrocarbons, saturated hydrocarbons, or a combination thereof.

In some aspects, the techniques described herein relate to a method, wherein the method further includes neutralization.

In some aspects, the techniques described herein relate to a method, wherein neutralization includes of adding of sodium hydroxide or potassium hydroxide.

In some aspects, the techniques described herein relate to a method, wherein the condenser includes of liquid circulation, optionally wherein the liquid is water, glycol, mineral oil, dielectric fluids, or a combination thereof.

In some aspects, the techniques described herein relate to a method, wherein the waxes and/or oils are further hydrogenated or hydroborated.

In some aspects, the techniques described herein relate to a method, further including admixing the mixture of fatty acids with a base to provide a mixture of fatty acid carboxylate salts.

In some aspects, the techniques described herein relate to a method, further including treating the mixture of fatty acid carboxylate salts with acid to provide a purified mixture of fatty acids.

In some aspects, the techniques described herein relate to a method, wherein manganese alkyl carboxylate is added to the mixture of waxes and/or oils.

In some aspects, the techniques described herein relate to a method, wherein the manganese alkyl carboxylate is manganese stearate.

In some aspects, the techniques described herein relate to a method, wherein the alkyl carboxylate is selected from the group consisting of C12-C24-alkyl carboxylates and combinations thereof.

In some aspects, the techniques described herein relate to a method, wherein the mixture of waxes and/or oils includes waxes with an average carbon chain length of about C18 to C47, wherein the mixture of fatty acids includes fatty acids with an average carbon chain length of about C18 to C47, or both.

In some aspects, the techniques described herein relate to a method, wherein a w/w ratio of manganese alkyl carboxylate to the mixture of waxes is from about 0.001 to about 0.10.

Other systems, methods, features, and advantages of preparing fatty acids will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description, described below, when taken in conjunction with the accompanying drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1D is upcycling of PE and PP to fatty acids in a temperature-gradient reactor. (FIG. 1A) Schematic process flow of separation and upcycling commercial polyolefins, including high-density PE (HDPE), low-density PE (LDPE), high-density crosslinked PE (XLPE), and PP to soap products using a custom-designed gradient thermal reactor. The temperature-gradient reactor has a hot and cold zone, preventing complete thermolysis of PE and PP to small molecules, and is key to controlling the chain length of fragmented products. Photographs show representative PE and PP wastes used in this study and the end products of soap and surfactant solution. (FIG. 1B) Reaction schemes of upcycling PE and PP to fatty acids. (FIG. 1C) Product distributions after PE degradation in the reactor with and without temperature gradient. The distribution and abundance were measured with GC. Signals from 3 to 7 overlapped with the toluene solvent and thus were not shown for clarity. (insert) Infrared thermal image of the reactor with and without temperature gradient. (FIG. 1D) The acid number of resulting fatty acids, in comparison with stearic acid (SA, C18) and theoretical values of fatty acids with average carbon numbers of C47 for PE and C46 for PP.

FIGS. 2A-2D is degradation of PE into intermediate waxes and upcycling into fatty acids. (FIG. 2A) Yields and (FIG. 2B) GC-MS chromatograms of intermediate waxes after degrading PE in N₂, 10 vol % of 02 balanced with N₂, and air. (FIG. 2C) NMR-HMBC spectra of PE-N₂-wax in deuterated p-xylene; (c inset) chemical structure of the major alkene product. The circles highlight the C—H correlations of the major and minor alkene products, respectively. The minor alkenes showed weak signals on the NMR-HMBC of PE-O-wax (FIG. 11B), but only a weak correlation was discovered in (FIG. 2C) due to overlapping with solvent. (FIG. 2D) NMR-HMBC spectrum of the fatty acid derived from PE-O-wax. The black box highlights the two carboxyl carbon correlations with protons.

FIGS. 3A-3D is degradation of PP and PE/PP mixture into intermediate waxes and upcycling into fatty acids. (FIG. 3A) The intermediate wax yield of PP upon degradation in N₂, N₂/O₂ mixture with 10 vol % of O₂, and air. (FIG. 3B) Wax yield from the degradation of a mixture of HDPE (25 wt. %), PP (25 wt. %), LDPE (25 wt. %), and XLPE (25 wt. %). The acid number of the polymer mixture is shown in Table 4. (FIG. 3C) NMR-HMBC of PP—N₂-wax in deuterated p-xylene (c inset, chemical structures of the major alkene product). The circles highlight the C—H correlations of the major and minor alkene products, respectively. The minor alkenes showed signals in FIG. 17A, but only a weak correlation was discovered in (c) due to overlapping with deuterated p-xylene solvent. (FIG. 3D) NMR-HMBC of PP-air-FA; inset, chemical structures of the major fatty acid product. The black box highlights the three carboxyl carbon correlations with protons.

FIG. 4 is a reactor design and PE/PP degradation procedures. (left) Design of the quartz reactor. Fluorinated rubber parts were used to minimize potential degradation of the O-ring and septum and to reduce the absorption of gaseous products. (right) Step-by-step procedures of PE/PP degradation: Step 1, loading polymer wastes; Step 2, purging the reactor with gases while heating the reactor bottom and supplying cooling water; Step 3, stepwise heating the bottom of the reactor to 360° C. (~100° C./5 min); stopping purging and capping the gas outlet as soon as the polymers start to “smoke”; Step 4, providing a stream of cooling air to keep the cap at low temperatures.

FIGS. 5A-5B is (FIG. 5A) an infrared thermogram of the reactor when the bottom was heated to ~360° C. (FIG. 5B) A photograph of the reactor during PE/PP degradation. The degraded waxes appeared as “smoke”, which scattered the red laser beam and showed a faint red tail.

FIG. 6 is a GC-MS of the gaseous products from PE degradation. Chemicals with a probability match of <70% are not shown. The total amount of gas products was <10 wt. %.

FIG. 7 is a GC-MS of the wax products from PE degradation.

FIG. 8 is a magnified view of the chromatograms of FIG. 2B. Chromatograms of PE-O-wax and PE-air-wax exhibited no evident peak shifting or new signals compared to PE-N₂-wax.

FIGS. 9A-9C is a characterization of PE and PP wax and their fatty acids. (FIG. 9A) GC-FID chromatograms of PP degradation products in air, 10 vol. % of O₂ balanced with N₂, and N₂. (FIG. 9B) HT-GPC chromatograms of the polymers and their degradation products in 10 vol. % of O₂, air, and N₂, and the derived fatty acids. (FIG. 9C) APCI-MS spectra of PE-N₂-wax, PE-O-wax, and PE-O-FA (left), PP—N₂-wax, PP-air-wax, and PP-air-FA (right). Molecular weights were calculated based on spectra using Equation S2. Note that due to fragmentation during MS analysis, the calculated molecular weights could be lower than the actual molecular weights. The results are tabulated in Table 3.

FIGS. 10A-10B is a NMR spectra of PE-N₂-wax. (FIG. 10A) NMR-HMBC spectra of PE-N₂-wax in deuterated p-xylene (identical to FIG. 2C) and a magnified view to show the major and minor alkenyl signals, as highlighted by the circles. (FIG. 10B) HSQC spectrum of PE-N₂-wax and a magnified view of the alkenyl signals. It was observed that carbons bearing an even (CH₂) number of hydrogens are typically up-field compared to carbons bearing an odd (CH, CH₃) number of hydrogens which are typically down-field (e.g., Hₐ compared to H_{b}).

FIGS. 11A-11B is a NMR spectra of PE-O-wax. (FIG. 11A) HMBC spectrum of PE-O-wax and the magnified views of alkenyl and carbonyl signals. Alkenyl and carbonyl signals are highlighted by circles and boxes, respectively. (FIG. 11B) HSQC spectrum of PE-O-wax and the magnified views of alkenyl signals. It was observed that carbons bearing an even (CH₂) number of hydrogens are typically up-field compared to carbons bearing an odd (CH, CH₃) number of hydrogens which are typically down-field (e.g., Hₐ compared to H_{b}).

FIGS. 12A-12E is a FTIR of PE- and PP-derived waxes oxidation. (FIG. 12A) Temporal evolution of (top) PE-N₂-wax and (bottom) PP—N₂-wax oxidation over Mn stearate. (FIG. 12B) Temporal evolution of (top) PE-O-wax and (bottom) PP-air-wax oxidation over Mn stearate, along with the FTIR spectrum of the resultant fatty acids of PE-O-FA and PP-air-FA. (FIG. 12C) Time evolution of the carbonyl indices (CI) of PE- and PP-derived waxes. CI is defined as the ratio of carbonyl to C—H signals in FTIR. (FIG. 12D) FTIR spectra of MnO₂ catalyst (black) and PE-N₂-wax before (red) and after (blue) oxidation over MnO₂. (FIG. 12E) FTIR spectrum of standard stearic acid (CI=0.78).

FIG. 13 is a NMR HMBC of PE-O-wax after oxidation over Mn stearate for 6 h. The magnified views of alkenyl and carbonyl signals are highlighted by solid circles and boxes, respectively.

FIG. 14 is a NMR HMBC of a fatty acid derived from PE-O-wax. The magnified view highlights the alkenyl (circles) and acid (box) signals. The insert shows the potential fatty acid structure.

FIG. 15 is a GC-MS of the gas products from PP degradation. Chemicals with probabilities lower than 70% are not shown. The total amount of gas products was <10 wt. %.

FIG. 16 is a GC-MS of the wax products from PP degradation.

FIGS. 17A-17B is a 2D NMR spectra of PP—N₂-wax. (FIG. 17A) NMR HMBC spectrum of PP—N₂-wax with magnified alkenyl signals. Unsaturated carbon signals δ111-112 include several correlations with protons. The minor C¹³-proton correlations (C¹³ NMR, δ 111.3-111.8, H¹ NMR, δ 4.68, 4.89, and ~2.2) and the major C¹³-proton correlations (C¹³ NMR, δ 111-112, H¹ NMR, δ 1.7) indicate overlapping of terminal alkene signals. (FIG. 17B) NMR HSQC spectrum shows a strong correlation with protons, suggesting 2-methyl-2-propenyl as the primary form of the terminal alkenes.

FIGS. 18A-18B is a NMR spectra of PP-air-wax. (FIG. 18A) NMR HMBC spectrum of PP-air-wax with magnified views of the alkenyl (circles) and carbonyl (boxes) signals. (FIG. 18B) NMR HSQC spectrum of the PP-air-wax with a magnified view of the alkenyl signal, showing only one strong correlation with protons, similar to that of PP—N₂-wax. The HMBC and HSQC spectra of PP-air-wax and PP—N₂-wax suggest a primary 2-methyl-2-propenyl structure in the terminal alkenes.

FIG. 19 is a NMR HMBC of a PP-air-wax oxidized for 2 h. The magnified views highlight the alkenyl (circles) and carbonyl (boxes) signals.

FIG. 20 is a NMR HMBC of a fatty acid derived from PP-air-wax. The magnified view highlights the alkenyl (circles) and acid (boxes) signals.

FIG. 21 is a temporal evolution of alkene concentration upon oxidation. The data points are listed in Table 5. PP-derived waxes show higher alkene concentrations than PE-derived waxes. Oxygen significantly reduces the initial alkene concentration in PE-air-wax and PP-air-wax.

FIG. 22 is a temperature-dependent alkene yield from the thermolysis of PE (black squares) and PP (gray squares) in flow-bed reactors,¹²⁻¹⁹ compared with the alkene yields from this work.

FIGS. 23A-23E is controlling the hydrocarbon product distribution from plastic thermolysis. (FIG. 23A) Various plastic waste utilized in the degradation experiments. (FIG. 23B) IR camera photographs showing the temperature of the condensation region of the reactor. (FIG. 23C) PE-wax and PE-oil generated upon thermolysis by circulating cold and hot water, respectively. (FIG. 23D) GC traces of the PE-oil and PE-wax generated from the two sets of conditions. (FIG. 23E) Market prices of virgin plastics, feedstock chemicals and materials employed, and upcycling products, as of 2023.

FIGS. 24A-24D is tuning the molar mass of hydrocarbon products from PP and mixed PE/PP thermolysis. (FIG. 24A) Analysis and quantification of various product phases generated in the thermolysis reaction of PE, PP, and PE/PP mixture (mix ratio=75 wt. % PE and 25 wt. % PP). Circulating hot water through the reactor afforded 51 wt. %, 62 wt. %, and 54 wt. % of thermolysis oil for PE, PP, PE/PP mixture, respectively. (FIG. 24B) Distribution of naphthenes and acyclic products in PE, PP, and PE/PP thermolysis oil, revealing a high concentration of acyclic alkenes and alkanes suitable for downstream detergent application (FIG. 24C) and (FIG. 24D) GC traces of the oil and wax products from PP and PE/PP mixture under different reaction conditions. The carbon number distribution shift to lower values upon circulating water at 90° C. All hydrocarbons observed in PP-oil-90C were s C20.

FIGS. 25A-25C is upcycling PE and PP thermolysis oil into sulfate detergents. (FIG. 25A) Scheme of the sulfation of alkene oils and subsequent neutralization to ionic detergents. (FIG. 25B) ¹H NMR of HDPE oil sulfation in CDCl₃. All terminal olefin groups were fully reacted as evidenced by the ¹H NMR. (FIG. 25C) HSQC NMR of HDPE-oil alkyl hydrogen sulfate in CDCl₃ highlighting the correlation pertaining to the sulfation reaction.

FIGS. 26A-26C is a determination of the wettability of PE-, PP-, and PE/PP-detergents. (FIG. 26A) Illustration of the substrate for the contact angle measurements. Photographs of detergents droplets on a glass substrate covered with parafilm. (FIG. 26B) In all cases, the contact angle decreased with an increasing detergent concentration. (FIG. 26C) Contact angle as a function of the PE-, PP-, and PE/PP-detergent concentration.

FIGS. 27A-27D is physicochemical properties of sulfate detergents. (FIG. 27A) Foam stability of HDPE, PP, and mixed PE/PP-derived detergents. HDPE-detergent exhibited higher foam stability than PP- and PE/PP-detergent. (FIG. 27B) Emulsifying power of detergents obtained by recording the separation time of 10 ml of water from a paraffin oil-water mixture. (FIG. 27C,D) Plots of surface tension vs. (FIG. 27C) PE-detergent and (FIG. 27D) PE/PP-detergent concentration for determining CMC.

FIG. 28 is selective upcycling of the PE and PP-derived oils to primary alkyl sulfates.

FIG. 29 is an olefinic oil treated with sulfuric acid and neutralized with dilute sodium hydroxide solution exhibited excellent foam forming properties. Additionally, the upcycled mixture of HDPE and PP wax, demonstrated good foaming behavior at room temperature.

FIGS. 30A-30B is a determination of alkenyl concentration in PE thermolysis products. (FIG. 30A) mmol/g alkenyl concentration of PE-oil and PE-wax. The higher alkenyl concentration in the oil is ascribed to longer duration of degraded products in the reactive zone. (FIG. 30B) ¹H NMR in C₆D₆ highlighting alkene peaks utilized in the estimation of the concentration.

FIG. 31 is a structural analysis of HDPE thermolysis gas phase. (FIG. 31) Chromatogram and GC-MS of gas phase products. The gas phase may contain some liquid fraction hydrocarbons with sufficiently high vapor pressure, such as hexane and heptane. Breakdown of thermolysis products into acyclic vs. cyclic hydrocarbons, illustrating that acyclic hydrocarbons dominate the PE products stream.

FIG. 32 is a fate of vaporized hydrocarbons under the two thermolysis conditions. At T2=28° C. the vaporized hydrocarbons (typically in the wax range) solidify on the reactor walls, as the wall temperature is cooler than the melting point of wax (m.p. range of PE=68.8-80.1° C.). On the contrary, the T2=90° C., the vaporized products liquify and flow back to the reactor bottom to undergo further chain cleavages.

FIG. 33 is a molecular weight characterization. The experiments were run in 1, 3, 5-trichlorobenzene at 160° C. GPC chromatograms of wax products generated at T2=28° C. Similarly, the experiments were conducted using a high-temperature GCP flowing 1, 3, 5-trichlorobenzene at 50° C. GPC chromatograms of oils produced when T2=90° C. The experiments were performed on a lignin-GPC flowing THF at ambient temperature.

FIG. 34 is a structural analysis of PP thermolysis gas phase. Chromatogram and GC-MS of gas phase products. The elevated intensity of compound 12 is likely caused by the high vapor pressure of the same product detected in the liquid fraction.

FIG. 35 is a structural analysis of PP oil. ¹H NMR in C₆D₆ highlighting the alkene peaks between 4.5 and 5.0 ppm. Notably, the alkene groups appeared to be predominantly terminal alkenes as no significant resonance peaks were detected beyond 5.0 ppm region, where internal olefin groups are expected to appear.

FIG. 36 is a GC-MS of PP-oil products. The product stream is composed mostly of acyclic methyl-substituted alkanes and alkenes. Cyclic hydrocarbons account for only ~15.3% of PP thermolysis oil.

FIG. 37 is a structural analysis of plastic mixture thermolysis gas phase. Chromatogram and GC-MS of gas phase products. The gas phase is dominated by ≤C6 alkenes and alkane while cyclic hydrocarbons make up only a small fraction of products.

FIG. 38 is a GC-MS of mixed (75% PE and 25% PP) oil products. The oil fraction features mostly linear alkenes and alkanes, along with minor diene compounds in the C₁₁ through C₁₄ region. In addition, methyl-substituted hydrocarbons arising from PP decomposition were detected before 12 minutes.

FIGS. 39A-39B is a determination of alkenyl concentration in mixed plastics thermolysis products. (FIG. 39A)¹H NMR in C₆D₆ highlighting alkene peaks utilized in the estimation of the concentration and evaluating the ratio of terminal to internal olefin. (FIG. 39B) mmol/g alkenyl concentration of mixed-oil and mixed-wax.

FIGS. 40A-40B is wetting properties of mixed detergents at low PP loading. (FIG. 40A) Contact angles on a hydrophobic surface as a function of concentration. (FIG. 40B) photographs of detergent droplets at different concentrations overlayed with the contact angle values. Overall, the wetting ability of this detergent formulation is comparable to that of pure PE-derived detergent.

FIG. 41 is an emulsification of paraffin oil and water by detergents. left) 40 ml of paraffin oil and 40 ml of PE detergent solution before shaking. middle) Mixture of the two components after shaking. c) 10 ml of detergent solution separated from the homogenized mixture; the separation time for 10 ml detergent solution is denoted as emulsifying time.

FIG. 42 is emulsification properties of plastic waste-based detergents. Detergent solutions (1.2 mL) mixed with 50 μL of hexane results in a significant reduction of dispersed phase particle size in contrast to the control experiment where no detergent is employed.

FIGS. 43A-43B is surface tension properties of PP products-containing detergents. Methyl-substituted products from PP degradation are associated with poor micellization at low detergent concentration and negligibly affect the surface tension (FIG. 43A). However, detergent formulations containing up to 10 wt. % of PP products (FIG. 43B) still exhibited good detergency comparable to PE-derived detergents solutions.

FIGS. 44A-44B is a purification of the sulfation reaction after work up. (FIG. 44A) Gas chromatograms of oil from plastic waste before sulfation. Each carbon number signal features alkene and alkane peaks; minor dienes are detected in a specific carbon number range (FIG. 44B) chromatograms of hexane extracts of unreacted fraction of the oil. Only single peaks were observed for each carbon number signal and were confirmed to be alkanes by GC-MS.

FIG. 45 is a GC and GC-MS of Unreacted extracts from HDPE oil.

FIG. 46 is a GC and GC-MS of Unreacted extracts from PP oil.

FIG. 47 is a GC and GC-MS of Unreacted extracts from mixed oil (75 wt. % PE, 25 wt. % PP).

### DETAILED DESCRIPTION

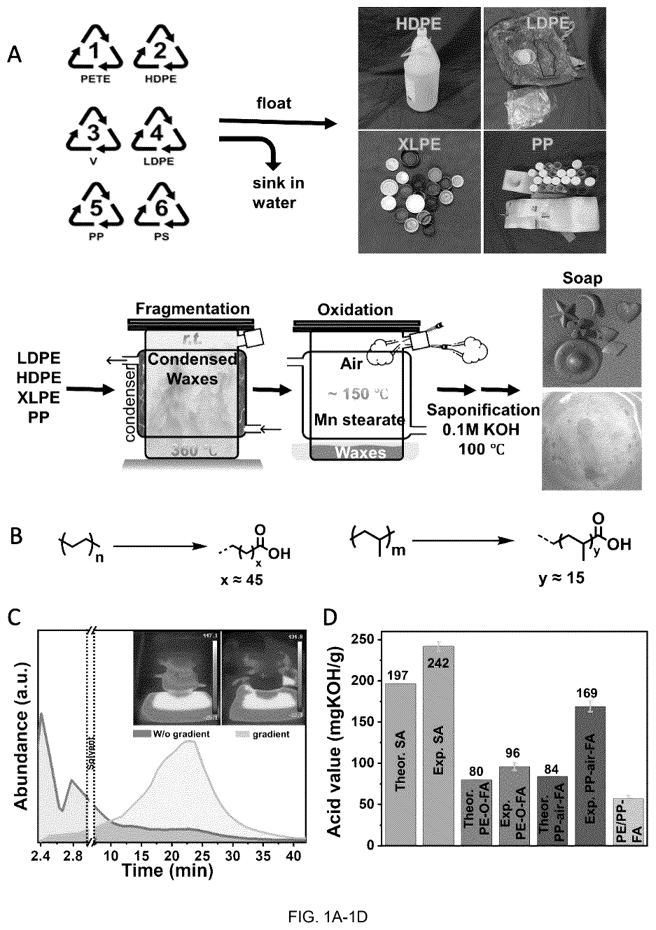

As the two most widely used commodity plastics, polyethylene (PE) and polypropylene (PP) together contribute nearly 60% of the world's plastic production (~400 MT), primarily for short-term applications.¹ Thus, the manufacturing of PE and PP is associated with the highest energy consumption among all plastics and contributes substantially to annual greenhouse gas emissions.² Short-term plastics quickly turn into waste and cause significant pollution.³ To recycle PE and PP, the waste collection and sorting processes must be economically efficient to ratchet down the cost,⁴ and the recycled products ideally should have a high value to be profitable and a large market volume to be impactful on plastic waste reduction. Although PE and PP can be separated from heavier-than-water polymers such as polyvinyl chloride (PVC) and polyethylene terephthalate (PET) by using a sink-float method with water as the medium (FIG. 1A), further separation of PE and PP is much more challenging due to their similar structures and densities. And worse, the two polymers are incompatible and cannot make blends unless expensive and sophisticated compatibilizers are used.⁵ A generic and profitable method that can recycle both PE and PP while increasing the final product value over virgin plastics is thus imperative.^{3, 6-8}

Herein are described gradient-temperature thermolysis methods that can selectively break both PE and PP into smaller alkyl chains. The temperature gradient in the reactor “quenches” the vaporized waxes and stops further degradations to smaller molecules. The methods described herein convert health- and environmental-concerning polyolefin waste into biologically and environmentally benign chemicals.

Although any methods and materials similar or equivalent to those described herein can also be used in the practice or testing of the present disclosure, the preferred methods and materials are now described. Functions or constructions well-known in the art may not be described in detail for brevity and/or clarity. Aspects of the present disclosure will employ, unless otherwise indicated, techniques of chemistry (e.g., polymer chemistry), material science, and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g., the phrase “x to y” includes the range from ‘x’ to ‘y’ as well as the range greater than ‘x’ and the range less than ‘y’. The range can also be expressed as an upper limit e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In some aspects, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

The disclosure has been organized with aide of various section headings, which are used for convenience and readability, and should not be construed in any way as limiting the disclosure or the scope of the claims. The claims may, in some instances, incorporate aspects that fall under different section headings and such combinations of aspects are understood to be encompassed by the instant disclosure.

The disclosure will be better understood with the aid of certain definitions and prescribed methods, which are described in detail in the sections entitled Definitions and Methods. Other terms and methods may be described elsewhere in the disclosure, including in the Examples, and yet others will be understood by those skilled in the art upon reading the disclosure provided herein. All definitions and methods described herein should be understood to control over dictionary definitions, definitions in documents incorporated by reference, and/or ordinary meanings of the defined terms.

### Methods of Preparing Fatty Acids

In various aspects, the disclosure provides a method of preparing fatty acids including: heating a polymer selected from the group consisting of a polypropylene, a polyethylene, and a combination thereof, in a vessel in fluid communication with a condenser to provide a sublimated mixture of waxes collected on the condenser, wherein the heating includes raising the temperature of the vessel to a target temperature over a first period of time and maintaining the vessel at or near the target temperature for a second period of time to provide a mixture of fatty acids.

In various aspects, the disclosure provides a method of preparing fatty acids including introducing a polymer selected from the group consisting of a polypropylene, a polyethylene, and a combination thereof into a continuous flow reaction vessel in fluid communication with a condenser to provide a sublimated mixture of waxes collected on the condenser, wherein the continuous flow reaction vessel is at or near a target temperature and wherein the polymer has a residence time in the continuous flow reaction vessel to provide a mixture of fatty acids.

### Polypropylene and Polyethylene

In some aspects, the polypropylene, a polyethylene, or a combination thereof is introduced/placed/inserted into the vessel for heating. Polypropylene (PP), a polymerization of propene monomer, can include Atactic polypropylene (aPP) defined by irregular methyl group (CH₃) arrangement; Isotactic polypropylene (iPP) defined by methyl groups (CH₃) arranged on one side of the carbon chain; and/or syndiotactic polypropylene (sPP) defined by alternating methyl group (CH₃) arrangement. PP can be a homo polymer or copolymer. In some aspects, PP can be an impact copolymer, expanded PP, PP terpolymer, or a combination thereof. In some aspects, PP can be a film, for example: cast PP film (CPP) or biaxially oriented PP film (BOPP). In some aspects, the PP is any one or more combinations of PP discussed herein.

Polyethylene (PE), a polymerization of ethylene (or ethene) monomer, can include branched, linear versions, cross-linked polyethylene, or a combination thereof. Branch versions can include low-density polyethylene (LDPE) or linear low-density polyethylene (LLDPE). Linear versions can include high-density polyethylene (HDPE) or ultra-high-molecular-weight polyethylene (UHMWPE). Cross-linked polyethylene can include PEX or XLPE. PE can include medium-density polyethylene (MDPE), ultra low-density polyethylene (ULDPE), high-molecular-weight polyethylene (HMWPE), metallocene polyethylene (mPE), chlorinated polyethylene (CPE), or a combination thereof. In some aspects, the PE is any one or more combinations of PE discussed herein.

### Vessels

The vessel can include any shape, construction material, and size for carrying out the methods described herein. For example, the vessel can be square, rectangular, spherical, or cylindrical. The vessel size, for example, can vary depending on the amount of PP and/or PE to be converted and/or the amount of fatty acids to be produced. The vessel can be constructed of any one or more material including but not limited to: stainless steel; nickel-based alloys; carbon steel; refractory materials (e.g., ceramics); low-alloy steels; titanium alloys; tantalum; zirconium; composite materials; clad materials; quartz; or a combination thereof. Refractory materials can include, for example, alumina and silicon carbide.

### Vessel Temperature

In some aspects, the temperature of the vessel includes heating at a rate of about 10° C. to about 30° C. per minute over the first period of time. In some aspects, the temperature of the vessel includes heating at a rate of about 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., or 30° C. per minute over the first period of time or any range between any two temperatures listed per minute over the first period of time. In some aspects, raising the temperature of the vessel includes heating a bottom of the vessel to the target temperature in three steps at a step size of about 80° C. to about 120° C. per 5 min. In some aspects, raising the temperature of the vessel includes heating a bottom of the vessel to the target temperature in three steps at a step size of about 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C. per 5 min or any range between any two temperatures listed per 5 min.

In some aspects, the target temperature is about 250° C. to 500° C. In some aspects, the target temperature is about 250° C., 251° C., 252° C., 253° C., 254° C., 255° C., 256° C., 257° C., 258° C., 259° C., 260° C., 261° C., 262° C., 263° C., 264° C., 265° C., 266° C., 267° C., 268° C., 269° C., 270° C., 271° C., 272° C., 273° C., 274° C., 275° C., 276° C., 277° C., 278° C., 279° C., 280° C., 281° C., 282° C., 283° C., 284° C., 285° C., 286° C., 287° C., 288° C., 289° C., 290° C., 291° C., 292° C., 293° C., 294° C., 295° C., 296° C., 297° C., 298° C., 299° C., 300° C., 301° C., 302° C., 303° C., 304° C., 305° C., 306° C., 307° C., 308° C., 309° C., 310° C., 311° C., 312° C., 313° C., 314° C., 315° C., 316° C., 317° C., 318° C., 319° C., 320° C., 321° C., 322° C., 323° C., 324° C., 325° C., 326° C., 327° C., 328° C., 329° C., 330° C., 331° C., 332° C., 333° C., 334° C., 335° C., 336° C., 337° C., 338° C., 339° C., 340° C., 341° C., 342° C., 343° C., 344° C., 345° C., 346° C., 347° C., 348° C., 349° C., 350° C., 351° C., 352° C., 353° C., 354° C., 355° C., 356° C., 357° C., 358° C., 359° C., 360° C., 361° C., 362° C., 363° C., 364° C., 365° C., 366° C., 367° C., 368° C., 369° C., 370° C., 371° C., 372° C., 373° C., 374° C., 375° C., 376° C., 377° C., 378° C., 379° C., 380° C., 381° C., 382° C., 383° C., 384° C., 385° C., 386° C., 387° C., 388° C., 389° C., 390° C., 391° C., 392° C., 393° C., 394° C., 395° C., 396° C., 397° C., 398° C., 399° C., 400° C., 401° C., 402° C., 403° C., 404° C., 405° C., 406° C., 407° C., 408° C., 409° C., 410° C., 411° C., 412° C., 413° C., 414° C., 415° C., 416° C., 417° C., 418° C., 419° C., 420° C., 421° C., 422° C., 423° C., 424° C., 425° C., 426° C., 427° C., 428° C., 429° C., 430° C., 431° C., 432° C., 433° C., 434° C., 435° C., 436° C., 437° C., 438° C., 439° C., 440° C., 441° C., 442° C., 443° C., 444° C., 445° C., 446° C., 447° C., 448° C., 449° C., 450° C., 451° C., 452° C., 453° C., 454° C., 455° C., 456° C., 457° C., 458° C., 459° C., 460° C., 461° C., 462° C., 463° C., 464° C., 465° C., 466° C., 467° C., 468° C., 469° C., 470° C., 471° C., 472° C., 473° C., 474° C., 475° C., 476° C., 477° C., 478° C., 479° C., 480° C., 481° C., 482° C., 483° C., 484° C., 485° C., 486° C., 487° C., 488° C., 489° C., 490° C., 491° C., 492° C., 493° C., 494° C., 495° C., 496° C., 497° C., 498° C., 499° C., 500° C., or any range between any two temperatures listed. In some aspects, the target temperature is 260° C. to 490° C., 270° C. to 480° C., 290° C. to 460° C., 310° C. to 440° C., 330° C. to 420° C., 350° C. to 400° C., 370° C. to 380° C. In some aspects, the target temperature is about 320° C. to 350° C. In some aspects, the target temperature is 320° C. to 400° C., or at 340° C. to 380° C., at 320° C. to 370° C., or at 330° C. to 360° C.

In some aspects, the vessel includes a heat controlling system. A heat controlling system can include one or more components. For example, a heat controlling system can include: one or more temperature sensor; one or more sensor-transmitter; one or more controllers; one or more control elements; one or more heat exchangers; one or more reactor jackets; or any combination thereof. A temperature sensor can include a thermocouple. For example, control element can include a control valve and/or electric heaters. In some aspects, the vessel and/or heat controlling system include a safety instrumented system.

### Residence Times

In some aspects, the polymer has a residence time in the continuous flow reaction vessel to provide a mixture of fatty acids. The residence time can include the time the polymer is within or in contact with the vessel before converting into a mixture of fatty acids, the amount of time required to convert a desired amount of polymer into a mixture of fatty acids, or desired length of time to perform the method. The residence time can vary depending on the material that will be heated (i.e., PP, PE, or a combination thereof.) In some aspects, the residence time is from 1 to 48 hours, from 1 to 24 hours, from 1 to 20 hours, or from 5 to 20 hours. In some aspects, the residence time is about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, or 72 hours.

### Condensers

In some aspects, a vessel is in fluid communication with a condenser to provide a sublimated mixture of waxes collected on the condenser. In some aspects, a condenser is in fluid communication with a vessel to collect a sublimated mixture of waxes. In some aspects, the vessel is jacketed with a condenser. A jacket allows for circulation of a liquid around the vessel. By way of an example, fluid communication between a condenser jacketing a vessel can include a first opening near a first end of a condenser attached to or otherwise connected to a vessel and a second opening near a second end of the condenser, the condenser includes a fluid passage that provides fluidic communication to the vessel and a sublimated mixture of waxes are collected in the vessel by way of the condenser. The jacketed vessel can be single or double configured. In a double configuration, an outer jacket can be vacuum insulated while an inner jacket provides for liquid circulation. In some aspects, the condenser is jacketed around the vessel. The condenser can jacket the entire wall of the vessel or a portion thereof. For example, the condenser can jacket 90%, 80%, 75%, 70%, 66%, 60%, 50%, 40%, 33%, 30%, 25% 20%, 10%, or any amount between 99% and 1% of the vessel. The condenser jacket can provide for a temperature gradient in the vessel. For example, the condenser can provide an area or zone in the vessel cooler than the heated area or zone of the vessel. By way of an example, the bottom of a vessel is heated to a desired temperature while a condenser jacketed positioned above the bottom of the vessel cools a portion of the vessel above the bottom of the vessel to a desired temperature lower than the temperature at the bottom of the vessel. The mixture of waxes can be collected in the vessel. For example, the mixture of waxes can be collected along the walls of the vessel in liquid communication to the condenser jacketing the vessel, accordingly the mixture of waxes are collected by way of the condenser.

By way of an example, fluid communication can be a first opening near a first end of a condenser attached to or otherwise connected to a vessel and a second opening near a second end of the condenser attached to or otherwise connected to a chamber for collecting a sublimated mixture of waxes, the condenser includes a fluid passage that provides fluidic communication between the vessel and the chamber for collecting a sublimated mixture of waxes. The chamber for collecting a sublimated mixture of waxes can be a separate container or a part of the condenser. In some aspects, the condenser can include Liebig, West, Allihn, Davies, Graham, coil condenser, Dimroth, Friedrichs, cold finder, shell-and-tube, brazed plate, coaxial tube-in-tube or variation thereof.

In some aspects, the condenser comprises liquid circulation. For example, liquid circulation includes introducing a liquid into a condenser to absorb heat from a vessel, the vessel is in fluid communication to the condenser. The heated liquid is removed from the condenser thereby removing the heat from the vessel. In some aspects, the liquid is either discarded and new liquid is introduced into the condenser. In some aspects, the liquid is removed from the condenser, the liquid is cooled, and then reintroduced into the condenser.

In some aspects, the liquid is water, glycol, mineral oil, dielectric fluids, or a combination thereof. The liquid for the condenser can be selected based on the desired cooling properties. For example, a liquid is selected based on the desired temperature difference between the heated portion of a vessel and the cooled portion of the vessel or condenser. For example, the liquid is selected based on the desired temperature of the cooled portion of the vessel or condenser. By way of an example, a liquid is selected by the operational temperature range, such that the different liquids can handle different temperatures. By way of an example, the liquid is selected by the thermal conductivity. In some aspects, the condenser temperature is about −195° C. to 250° C. In some aspects, the condenser surface has a temperature of −185° C. to 240° C., −175° C. to 230° C., −165° C. to 220° C., −155° C. to 210° C., −145° C. to 200° C., −135° C. to 190° C., −125° C. to 180° C., −115° C. to 170° C., −105° C. to 160° C., −95° C. to 150° C., −85° C. to 140° C., −75° C. to 130° C., −65° C. to 120° C., −55° C. to 110° C., −45° C. to 100° C., −35° C. to 90° C., −25° C. to 80° C., −15° C. to 70° C., −5° C. to 60° C., 5° C. to 50° C., 15° C. to 40° C., 25° C. to 30° C. In some aspects, the condenser temperature is about −195° C., −190° C., −185° C., −180° C., −175° C., −170° C., −165° C., −160° C., −155° C., −150° C., −145° C., −140° C., −135° C., −130° C., −125° C., −120° C., −115° C., −110° C., −105° C., −100° C., −95° C., −90° C., −85° C., −80° C., −75° C., −70° C., −65° C., −60° C., −55° C., −50° C., −45° C., −40° C., −35° C., −30° C., −25° C., −20° C., −15° C., −10° C., −5° C., 0° C., 5° C., 10° C., 15° C., 20° C., 25° C., 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C., 240° C., 245° C., or 250° C. or any range between any two temperatures listed.

### Temperature Gradient

In some aspects, the there is a temperature gradient. The temperature gradient can be between the vessel and the condenser. For example, the bottom of the vessel is heated while the top of the vessel is cooled with the condenser. In some aspects, there are two (2) temperature gradients. In some aspects, there are 2, 3, 4, 5, 6, 7, 8, 9, or 10 temperature gradients. A temperature gradient between any two points includes the change in temperature between a first desired temperature and a second desired temperature. In some aspects, a temperature difference between the vessel temperature and condenser temperature is about 700° C., 675° C., 650° C., 625° C., 600° C., 575° C., 550° C., 525° C., 500° C., 475° C., 450° C., 425° C., 400° C., 375° C., 350° C., 325° C., 300° C., 275° C., 250° C., 225° C., 200° C., 175° C., 150° C., 125° C., 100° C., 75° C., 50° C., 25° C., or any combination thereof. In some aspects, a temperature difference between the vessel and the condenser surface is about 300° C. to 400° C., or about 325° C. to 375° C.

### Fatty Acids, Waxes, and Oils

In some aspects, methods described herein provide for preparing waxes, oils, fatty acids, or a combination thereof. Waxes produced by the methods described herein include hydrocarbons derived from heating PP and PE. These wax hydrocarbons can be composed of about 20 to 50 carbon atoms and can be saturated or unsaturated and can be cyclic or acyclic. Oils produced by the methods described herein include hydrocarbons derived from heating PP and PE. These oil hydrocarbons can be composed of about 5 to 26 carbon atoms and can be saturated or unsaturated and can be cyclic or acyclic. Fatty acids produced by the methods described herein include hydrocarbons derived from heating PP and PE. These fatty acids are compositions that can include carboxylic acid hydrocarbons and can be composed of about 7 to 30 carbon atoms and can be saturated or unsaturated and can be cyclic or acyclic. In some aspects, the mixture of waxes and/or oils comprises waxes with an average carbon chain length of about C42 to C47, wherein the mixture of fatty acids comprises fatty acids with an average carbon chain length of about C42 to C47, or both. In some aspects, the waxes and/or oils produced by the methods described herein are oxidized into fatty acids.

### Hydroboration

In some aspects, the methods described herein further include hydroboration, which produces organoborane compounds. Hydroborated hydrocarbons produced by the methods described herein can react with a variety of reagents to produce compounds, such as alcohols, amines, sulfates, or alkyl halides. Example reagents for hydroboration can include borane (BH₃), BH₃·THF, B₂He, BH₃·OEt₂, BH₃·dimethylsulfide, as well as substituted boranes such as disiamyl borane and 9-BEN. Hydroborated hydrocarbons can further be oxidated to produce alcohols, for example, by use of hydrogen peroxide.

### Alkyl Sulfates

In some aspects, fatty acids, waxes, oils, or a combination thereof undergo sulfation to produce alkyl sulfates. Sulfation may include reacting fatty acids, waxes, oils, or a combination thereof with sulfuric acid or sulfur trioxide. Sulfation may include first oxidizing fatty acids, waxes, oils, or a combination thereof then reacting the oxidized fatty acids, waxes, oils, or a combination thereof with chlorosulfuric acid or sulfur trioxide. Alkyl sulfates can be saturated or unsaturated and can be cyclic or acyclic.

### Neutralization

In some aspects, the methods described herein further include neutralized. In some aspects, a sulfation reaction is neutralized. For example, neutralization of a sulfation reaction can include introducing a suitable base to the reaction mixture to neutralize the polar sulfate or sulfonate group with a counter ion. Example counter ions include Na⁺, K⁺, NH₄⁺, Ca²⁺, Mg²⁺, Zn²⁺ or an alkanolamine cation. Example bases that provide a counter ion include sodium hydroxide or potassium hydroxide.

### Hydrogenation

In some aspects, the methods described herein further include hydrogenation, which is used to reduce or saturate unsaturated hydrocarbons produced by the methods described herein. Reduce or saturate unsaturated hydrocarbons, for example, can include the addition of one or more pairs of hydrogen atoms reducing or saturating an unsaturated double bond to a single bond and/or an unsaturated triple bond to a double bond or single bond. In general, hydrogenation comprises the unsaturated substrate (i.e., hydrocarbons produced by the methods described herein), the hydrogens (or hydrogen source) and a catalyst. Hydrogenation can be carried out at different temperatures and pressures, which is selected based on the substrate and the activity of the catalyst. A hydrogen source can include H₂ gas, formic acid, isopropanol, and dihydroanthracene. A catalyst can be either a homogenous or a heterogenous catalyst. A catalyst can include platinum, palladium, rhodium, ruthenium, iridium, nickel. For example, a catalyst can include dichlorotris(triphenylphosphine)ruthenium(II), crabtree's catalyst, cyclooctadiene rhodium chloride dimer, (S)-iPr-PHOX, Wilkinson's catalyst, Lindlar catalyst, and Raney nickel.

### Carboxylate Salts

In some aspects, the methods described herein produce alkyl carboxylate salts. In some aspects, the alkyl carboxylate is selected from the group consisting of C12-C24-alkyl carboxylates and combinations thereof. For example, waxes, oils, fatty acids, or a combination thereof produced by the methods described herein undergo carboxylation. In some aspects, manganese alkyl carboxylate is added to the mixture of waxes, oils, fatty acids, or a combination thereof produced by the methods described. Carboxylate salts produced by the methods described herein can be composed of about 5 to 47 carbon atoms and can be saturated or unsaturated and can be cyclic or acyclic.

### Inert Gas/Ambient Air

In some aspects, a polymer, wax, oil, fatty acid, or a combination thereof is exposed to ambient air or an inert gas in the vessel. The inert gas, for example, can include nitrogen or argon. In some aspects, the polymer is wax, oil, fatty acid, or a combination thereof exposed to oxygen gas admixed with an inert gas in the vessel or the polymer is wax, oil, fatty acid, or a combination thereof exposed to air admixed with an inert gas in the vessel.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the disclosure and relevant art and should not be interpreted in an idealized or overly formal sense unless expressly defined herein.

The articles “a” and “an,” as used herein, mean one or more when applied to any feature in aspects of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Halogen may be F, Cl, Br or I; or F, Cl, or Br; or F or Cl; or F; or Cl. Haloalkyl may be generally lower haloalkyl, or C₁-C₆ haloalkyl, or C₁-C₃ haloalkyl. Examples of C₁-C₃ haloalkyl include CH₂F, CHF₂, CF₃, CH₂Cl, CHCl₂, CCl₃, CF₂CF₃, CF₂CF₂H, and CH₂CF₃. The term “substituted” means that alkyl or aryl may be substituted by from one to five substituents which are fluorine, chlorine, bromine, iodine, C1-12haloalkyl, nitro, C1-12alkyl, C5-12aryl or C1-12alkoxyl, cyano, C1-12haloalkoxyl, C1-12alkylsulfenyl, C1-12alkylsulfinyl, C1-12alkylsulfonyl, C1-12haloalkylsulfenyl, C1-12haloalkylsulfinyl, or C1-12haloalkylsulfonyl, hydroxyl, thiol, amino, oxo, carboxyl, carbonylalkyl, C1-12acylamino, C1-12alkoxy-carbonylamino, C1-12haloalkoxycarbonylamino, C1-12alkoxyimino, C1-12haloalkoxyimino, or C1-12alkylsulfonylamino, or sulfur pentafluoride; such substitution may be fluorine, chlorine, bromine, C1-6haloalkyl, C1-6haloalkoxyl, oxo, carboxyl, carbonylalkyl and cyano.

The term leaving group means is understood by a person of ordinary skill as a halide, e.g., fluoride, chloride, bromide, iodide, an alkylsulfonate e.g., methylsulfonate, trifluoromethylsulfonate, an arylsulfonate, e.g, p-toluenesulfonate, hydroxide, alkoxide, aryloxide, carboxylate, e.g., acetate, ammonia, alkylamine and the like. Such leaving groups include the conjugate acids of the foregoing leaving groups.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

### ASPECTS OF THE DISCLOSURE

The present disclosure will be better understood upon reading the following numbered aspects, which should not be confused with the claims. In some instances, the aspects below may be combined with one or more additional aspects or with other aspects described elsewhere in the disclosure and accompanying examples. All such variations and combinations are intended to be covered by the instant disclosure.
Aspect 1. A method of preparing waxes and/or oils including: heating a polymer selected from the group consisting of a polypropylene, a polyethylene, and a combination thereof, in a vessel in fluid communication with a condenser to provide a sublimated mixture of waxes and/or oils collected on the condenser, wherein the heating includes raising the temperature of the vessel to a target temperature over a first period of time and maintaining the vessel at or near the target temperature for a second period of time to provide a mixture of waxes and/or oils.
Aspect 2. The method according to any one of Aspects 1-40 wherein raising the temperature of the vessel includes heating at a rate of about 10° C. to about 30° C. per minute over the first period of time.
Aspect 3. The method according to any one of Aspects 1-40 wherein the first period of time is from about 5 minutes to about 60 minutes, from about 5 minutes to about 15 minutes, or from about 10 minutes to about 30 minutes.
Aspect 4. The method according to any one of Aspects 1-40 wherein the second period of time is from 1 to 48 hours, from 1 to 24 hours, from 1 to 20 hours, or from 5 to 20 hours.
Aspect 5. The method according to any one of Aspects 1-40 wherein raising the temperature of the vessel includes heating a bottom of the vessel to the target temperature in three steps at a step size of about 80° C. to about 120° C. per 5 min.
Aspect 6. A method of preparing fatty acids including introducing a polymer selected from the group consisting of a polypropylene, a polyethylene, and a combination thereof into a continuous flow reaction vessel in fluid communication with a condenser to provide a sublimated mixture of waxes and/or oils collected on the condenser, wherein the continuous flow reaction vessel is at or near a target temperature and wherein the polymer has a residence time in the continuous flow reaction vessel to provide a mixture of waxes and/or oils.
Aspect 7. The method according to any one of Aspects 1-40 wherein the residence time is from 1 to 48 hours, from 1 to 24 hours, from 1 to 20 hours, or from 5 to 20 hours.
Aspect 8. The method according to any one of Aspects 1-40 wherein the target temperature is about 250° C. to 500° C.
Aspect 9. The method according to any one of Aspects 1-40 wherein the target temperature is 260° C. to 490° C., 270° C. to 480° C., 290° C. to 460° C., 310° C. to 440° C., 330° C. to 420° C., 350° C. to 400° C., 370° C. to 380° C.
Aspect 10. The method according to any one of Aspects 1-40 wherein the target temperature is about 320° C. to 350° C.
Aspect 11. The method according to any one of Aspects 1-40 wherein the target temperature is 320° C. to 400° C., or at 340° C. to 380° C., at 320° C. to 370° C., or at 330° C. to 360° C.
Aspect 12. The method according to any one of Aspects 1-40 wherein the polymer is exposed to ambient air.
Aspect 13. The method according to any one of Aspects 1-40 wherein the polymer is exposed to an inert gas in the vessel.
Aspect 14. The method according to any one of Aspects 1-40 wherein the inert gas is nitrogen or argon.
Aspect 15. The method according to any one of Aspects 1-40 wherein the polymer is exposed to oxygen gas admixed with an inert gas in the vessel.
Aspect 16. The method according to any one of Aspects 1-40 wherein the polymer is exposed to air admixed with an inert gas in the vessel.
Aspect 17. The method according to any one of Aspects 1-40 wherein the vessel is heated at atmospheric pressure.
Aspect 18. The method according to any one of Aspects 1-40 wherein the polymer is selected from the group consisting of a crosslinked polypropylene, a crosslinked polyethylene, a linear polypropylene, a linear polyethylene, and combinations thereof.
Aspect 19. The method according to any one of Aspects 1-40 wherein the polymer is selected from the group consisting of a high-density polyethylene, a low-density polyethylene, and a high-density crosslinked polyethylene.
Aspect 20. The method according to any one of Aspects 1-40 wherein a w/w ratio of manganese alkyl carboxylate to the mixture of waxes is from about 0.001 to about 0.10.
Aspect 21. The method according to any one of Aspects 1-40 further including admixing the mixture of fatty acids with a base to provide a mixture of fatty acid carboxylate salts.
Aspect 22. The method according to any one of Aspects 1-40 further including treating the mixture of fatty acid carboxylate salts with acid to provide a purified mixture of fatty acids.
Aspect 23. The method according to any one of Aspects 1-40 wherein a % mass conversion of the polymer to the mixture of waxes is from about 85% to 99%, or from about 85% to 95%, or from about 85% to 90%, or from about 90% to 95%.
Aspect 24. The method according to any one of Aspects 1-40 wherein a temperature difference between the vessel and the condenser surface is about 300° C. to 400° C., or about 325° C. to 375° C.
Aspect 25. The method according to any one of Aspects 1-40 wherein the target temperature is about −195° C. to 250° C.
Aspect 26. The method according to any one of Aspects 1-40 wherein the condenser surface has a temperature of −185° C. to 240° C., −175° C. to 230° C., −165° C. to 220° C., −155° C. to 210° C., −145° C. to 200° C., −135° C. to 190° C., −125° C. to 180° C., −115° C. to 170° C., −105° C. to 160° C., −95° C. to 150° C., −85° C. to 140° C., −75° C. to 130° C., −65° C. to 120° C., −55° C. to 110° C., −45° C. to 100° C., −35° C. to 90° C., −25° C. to 80° C., −15° C. to 70° C., −5° C. to 60° C., 5° C. to 50° C., 15° C. to 40° C., 25° C. to 30° C.
Aspect 27. The method according to any one of Aspects 1-40 wherein the condenser includes a quartz surface.
Aspect 28. The method according to any one of Aspects 1-40 wherein a wt % of light hydrocarbons having 8 or fewer carbon atoms in the mixture of waxes and/or oils is about 10 wt %, 8 wt %, 5 wt %, or less based upon a total weight of the mixture of waxes and/or oils.
Aspect 29. The method according to any one of Aspects 1-40 wherein the method further includes adding sulfuric acid to the mixture of waxes and/or oils.
Aspect 30. The method according to any one of Aspects 1-40 wherein the mixture of fatty acids is a mixture of alkyl sulfates.
Aspect 31. The method according to any one of Aspects 1-40 wherein the mixture of waxes and/or oils independently has a hydrocarbon length of C7-C26 and is either acyclic, cyclic or a combination thereof.
Aspect 32. The method according to any one of Aspects 1-40 wherein the mixture of waxes and/or oils are independently unsaturated hydrocarbons, saturated hydrocarbons, or a combination thereof.
Aspect 33. The method according to any one of Aspects 1-40 wherein the method further includes neutralization.
Aspect 34. The method according to any one of Aspects 1-40 wherein neutralization includes of adding of sodium hydroxide or potassium hydroxide.
Aspect 35. The method according to any one of Aspects 1-40 wherein the condenser includes of liquid circulation, optionally wherein the liquid is water, glycol, mineral oil, dielectric fluids, or a combination thereof.
Aspect 36. The method according to any one of Aspects 1-40 wherein the waxes and/or oils are further hydrogenated or hydroborated.
Aspect 37. The method according to any one of Aspects 1-40 wherein manganese alkyl carboxylate is added to the mixture of fatty acids.
Aspect 38. The method according to any one of Aspects 1-40 wherein the manganese alkyl carboxylate is manganese stearate.
Aspect 39. The method according to any one of Aspects 1-40 wherein the alkyl carboxylate is selected from the group consisting of C12-C24-alkyl carboxylates and combinations thereof.
Aspect 40. The method according to any one of Aspects 1-40 wherein the mixture of waxes includes waxes with an average carbon chain length of about C42 to C47, wherein the mixture of fatty acids includes fatty acids with an average carbon chain length of about C42 to C47, or both.

### EXAMPLES

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1—High-Conversion Chemical Upcycling of Polyethylene, Polypropylene, and their Mixtures to High-Value Surfactants

### Abstract

On the one hand, plastic wastes raise severe health and environmental concerns. On the other hand, fatty acids are biologically benign; produced by algae, plants, and animals, they are structural building blocks for cells and important dietary fuel sources (e.g., butter). Conversion of plastic wastes to fatty acids is, therefore, a highly attractive approach for addressing plastic waste pollution, turning plastic wastes into high-value, high-volume chemicals. Herein Applicants report a method for converting polyethylene (PE) and polypropylene (PP) at nearly 90% conversion to fatty acids with an average chain length of ~C42-C47. The process can be applied to both linear and crosslinked PE and PP and their mixtures, requiring no sophisticated catalysts, stringent reaction conditions, or separation processes. Temperature-gradient thermolysis is the key to controlling product distribution after degradation. Via a tandem oxidation-hydrolysis reaction, the waxes are upcycled to fatty acids after oxidation over manganese stearate in air and saponification. Thermodynamically and kinetically, PP favors β-scission to produce more olefin wax and yields higher acid-number fatty acids than PE. Applicants further convert the fatty acids to high-value large-market-volume surfactants, opening an avenue to upcycling polyolefin wastes for use in markets including lubrication, cosmetics, cleaning, emulsifying, foaming, and water treatment.

### Introduction

Chemical upcycling increases the product value and is envisioned as a solution that converts post-consumer wastes into high-value chemicals, e.g., the conversion of PS into aryl carboxylic acids and aryl ketones.⁹⁻¹¹ Chemical upcycling of PP and PE, however, is difficult due to the high ceiling temperatures.¹² Moreover, the lack of heteroatoms within the polymer chains (or weak linkages, e.g., esters in PET) provides no selective chain-scission sites. Product control is thus exceptionally challenging. Recently, short-chain olefin-assisted cross-metathesis and hydrogenolysis-aromatization reactions over iridium¹³- and platinum¹⁴-based catalysts, respectively, generated fuels and improved the selectivity towards aryl moiety in the upcycling of PE. PE can also be converted to propylene via dehydrogenation and tandem isomerizing ethenolysis.¹⁵ Considering the techno-economics for increased product value and generalizability to both PE and PP, the conversion of polyolefins to high-value fatty acids or ionic surfactants is appealing because PE and PP are aliphatic by nature. In addition, surfactant products have huge market demands (i.e., comparable to plastics) and high economic values (i.e., higher than fuels, waxes, and regular aromatic compounds) (Table 1). Importantly, surfactant products such as soaps are made from fatty acids of varying chain lengths and are often blended with ketones and aldehydes to soften the product and modulate fragrance release,¹⁶ loosening the need for removing ketone and aldehyde byproducts in the upcycling process of PE and PP. Biodegradation converts PE to fatty acids using microbials, but the fermentation period is too long (>10 days) to be practically deployable in the chemical industry.¹⁷ Chemically, the Novoloop® method and hydrothermal reactions with strong oxidants quickly degrade PE but produce uncontrollable short-chain fatty acids and require harsh reaction conditions, such as strong nitric acid and high pressure.¹⁸ Most recently, metallization of PE over Zr and alkyl aluminum produces better-controlled products at a conversion of at most 40%, and the catalysts operate under O₂, CO₂, and H₂O-free conditions.¹⁹ Therefore, time- and material-efficient methods with non-corrosive chemicals, atmospheric pressure, and air-tolerant reaction conditions are highly sought to efficiently transform both PE and PP into large-market-volume fatty acids, preferably without the need for additional sorting/separation but with high selectivity and conversion.

Herein Applicants report a gradient-temperature thermolysis method that can selectively break both PE and PP into chains of an average carbon number ~42-47 under atmospheric pressure (FIGS. 1A and B). The temperature gradient in the reactor swiftly “quenches” the vaporized waxes and stops further degradations to smaller molecules (FIG. 1C). The intermediate products are then oxidized to ketones and fatty acids with high conversion and high acid values (Table 2 and FIG. 1D) converting health- and environmental-concerning polyolefin waste to biologically and environmentally benign chemicals. Via subsequent saponification, Applicants obtain a soap base product that contains fatty acid salts as ionic surfactants and ketones as soap softeners. Simply mixing the soap base with additives (e.g., fragrances) can produce commercial soap bars and liquid detergents (see example products in FIG. 1A), which have higher market values than typical chemical products such as fuels and alkylaromatics.¹⁰

### Results and Discussion

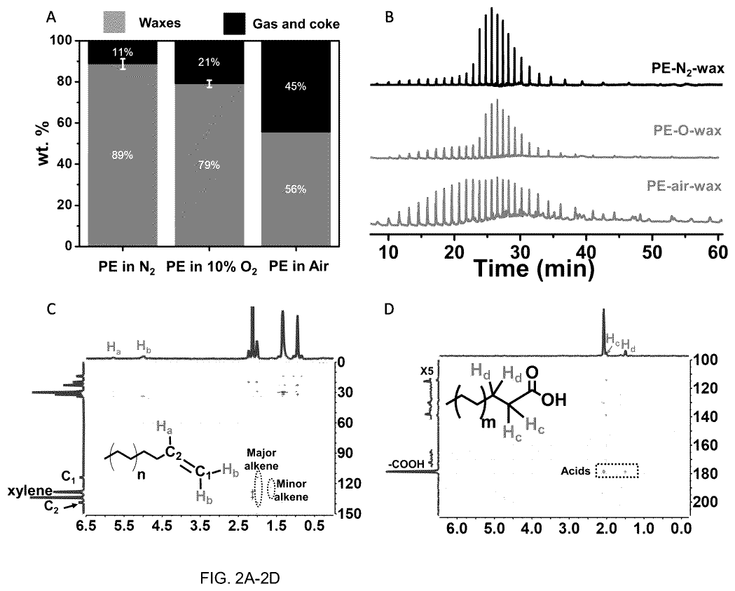

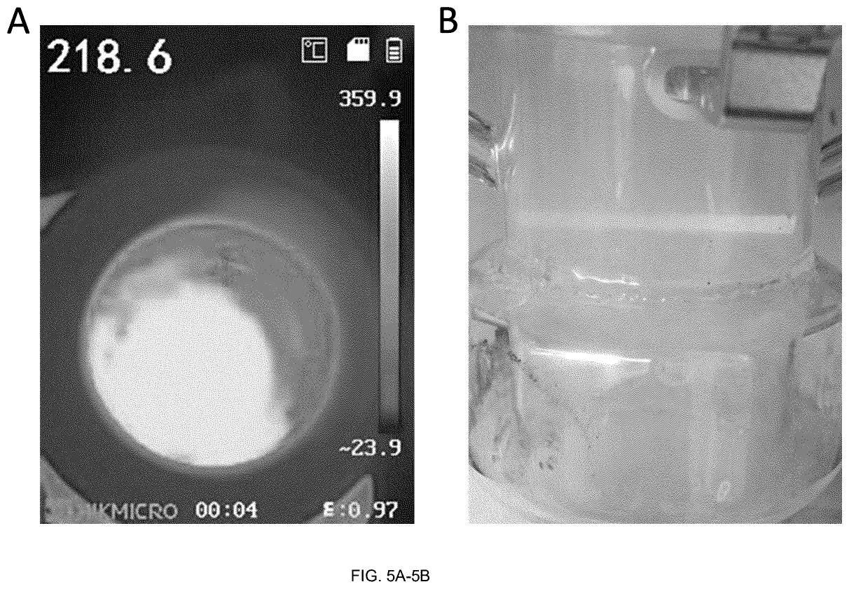

PE (~500 mg) was loaded into a custom-designed quartz reactor (FIG. 1A) and purged with gases of controlled compositions (N₂, 10 vol % O₂ in N₂, or air). The degradation was initiated by heating the bottom of the reactor to ~360° C. in three steps at a step size of ~100° C. per 5 min. Polymer “smokes” (FIG. 5) appeared, indicating the vaporization of fragmented polyolefins or waxes. The waxes were condensed and solidified in the cold part of the reactor, preventing further fragmentation to shorter hydrocarbons. The wax yields from PE degradation in N₂ (PE-N₂-wax), 10 vol % O₂ (PE-O-wax), or air (PE-air-wax) were 89 wt. %, 79 wt. %, and 56 wt. % (FIG. 2A and Table 2, exp. 1-3, 7-9, and 13), respectively. In a control experiment without a temperature gradient under N₂, the carbon number of the intermediate waxes were all short-chain hydrocarbons of C8 and below (FIG. 1C).

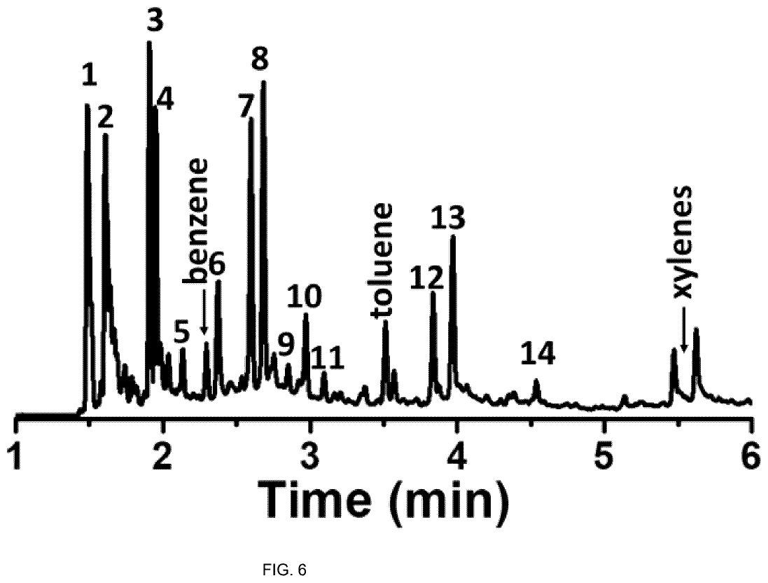

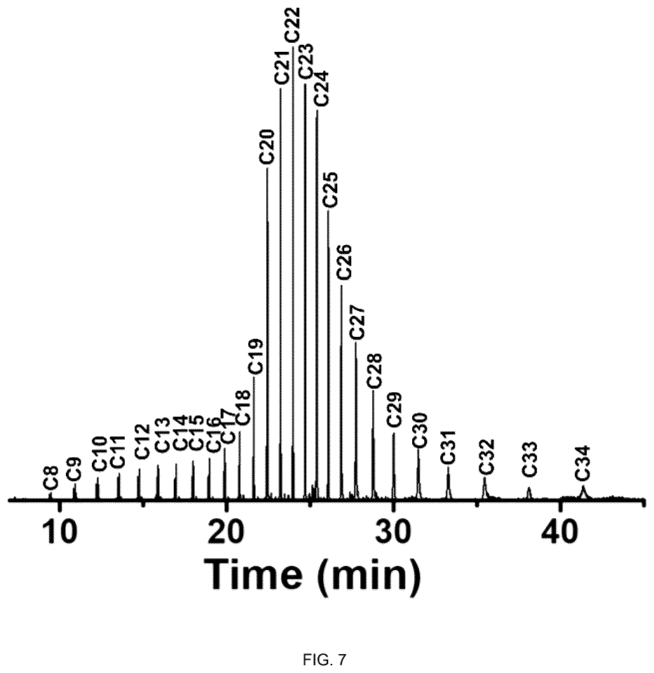

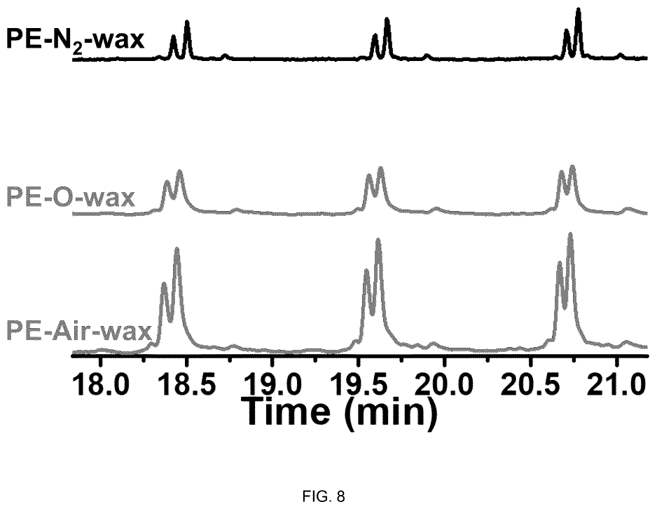

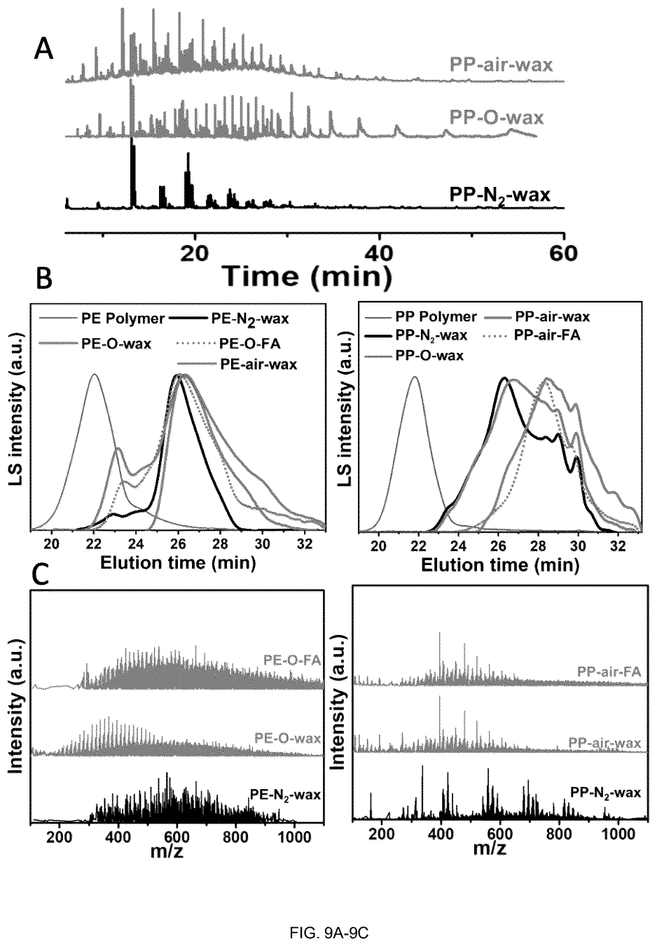

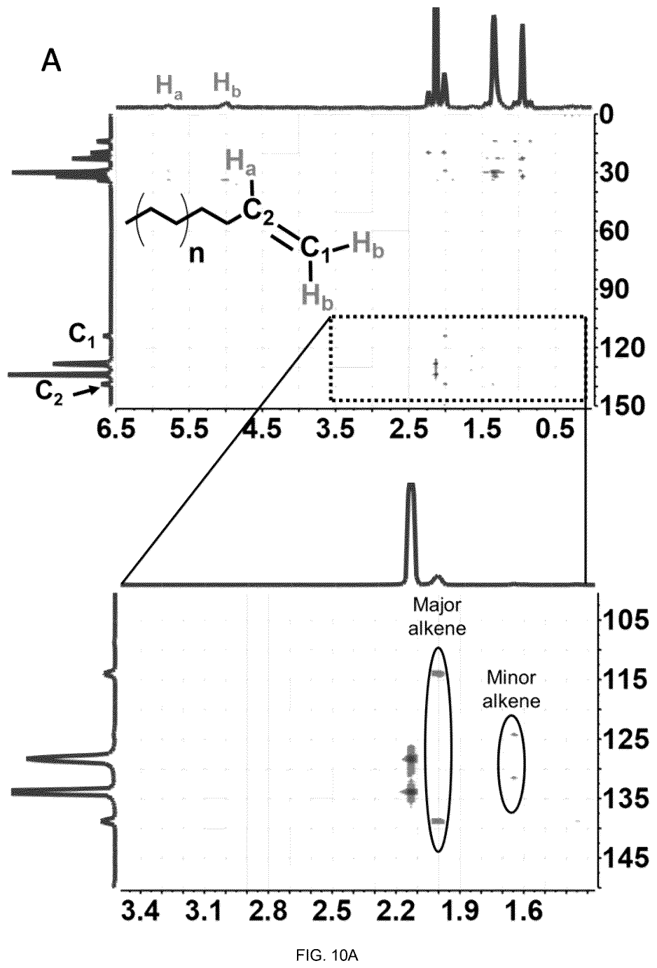

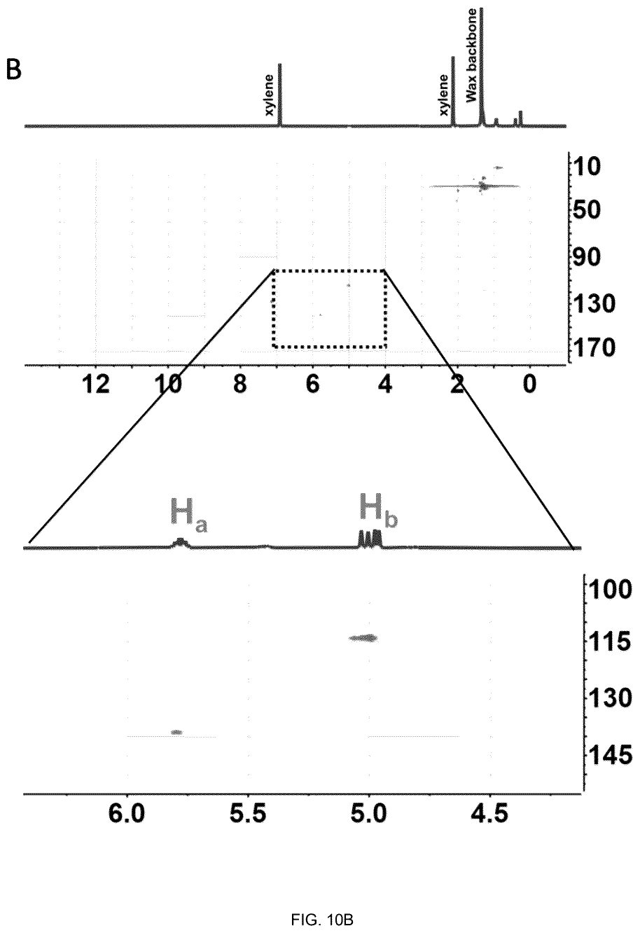

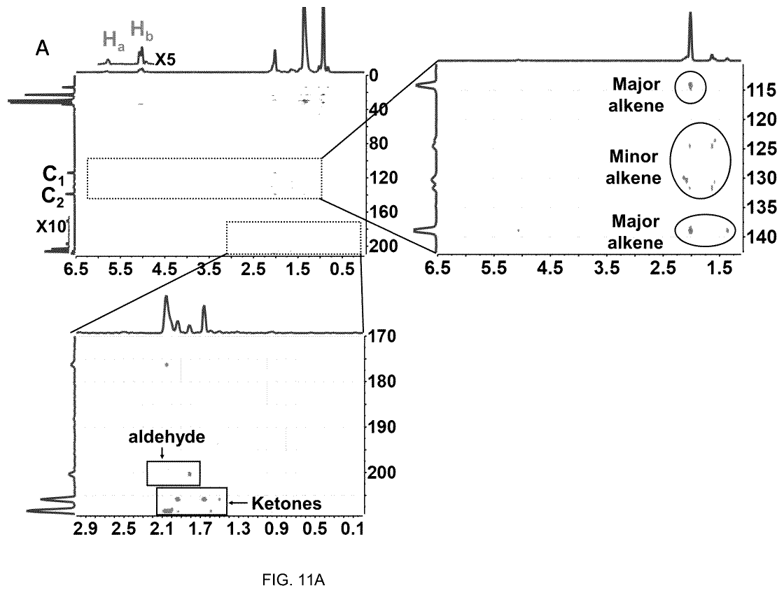

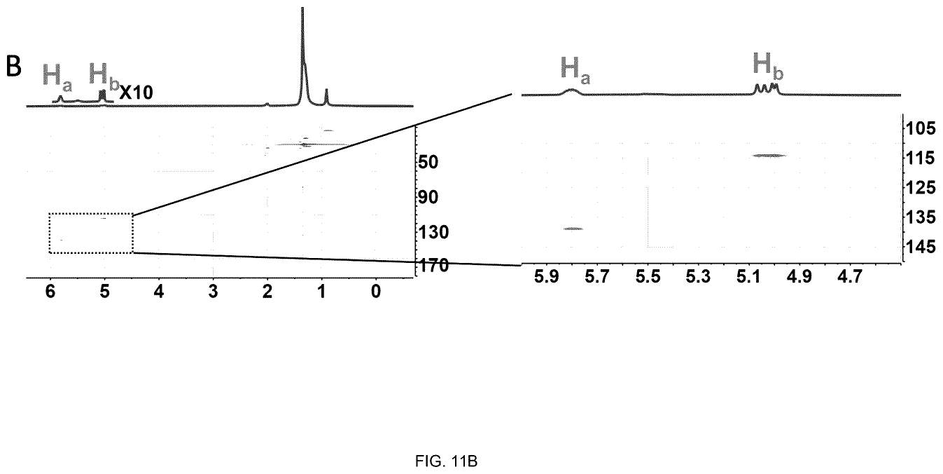

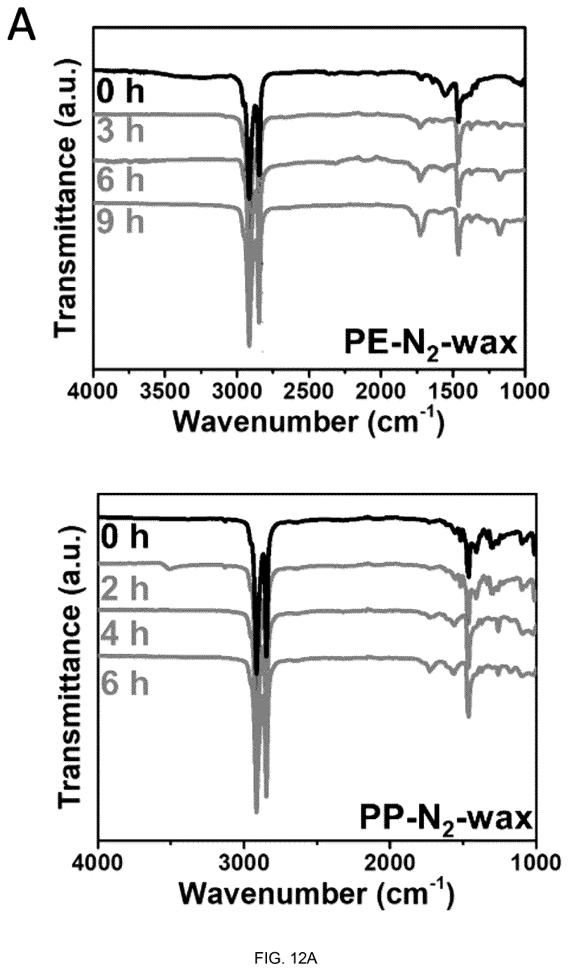

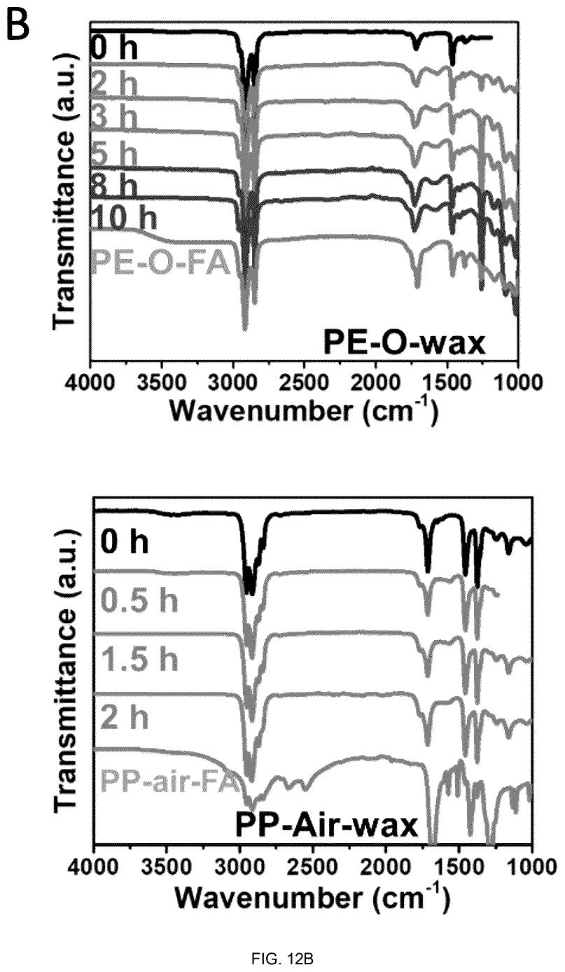

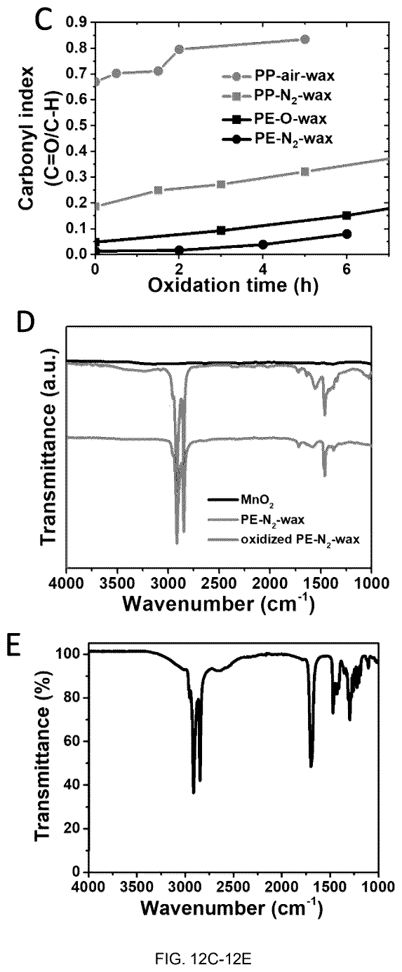

Gas chromatography-mass spectrometry was used to characterize the wax compositions (GC-MS, FIG. 2B), showing mainly solid waxes with minor products of light hydrocarbons (~10 wt. % of C8 and below, FIG. 6). Each primary peak could be resolved into a doublet of alkene and alkane with the same carbon number (FIGS. 7 and 12), similar to degradation in flow reactors.²⁰ In the presence of O₂, PE-O-wax and PE-air-wax exhibited GC-MS peaks and molecular ion signals similar to PE-N₂-wax. PE-O-wax and PE-air-wax showed stronger intensities at shorter elution time than PE-N₂-wax (FIG. 2B), indicating more short hydrocarbons and lower average molecular weights due to the accelerated degradation by oxygen-containing radicals.²¹ The PE-air-wax yield was too low (~56%), albeit higher than those in the literature,^{14, 22, 23} to be practically useful for generating hydrocarbons suitable for downstream production of surfactants (FIG. 2A); therefore, no further characterization of PE-air-wax was conducted. High-temperature gel permeation chromatography (HT-GPC) confirmed the reduced molecular weight of waxes (FIG. 9B). Because HT-GPC cannot resolve the exact molecular weights in this range and GC cannot detect low-volatility long hydrocarbon chains (>C40),²⁴ atmospheric pressure chemical ionization mass spectrometry (APCI-MS) was employed to analyze the less volatile fractions. The spectra of PE-N₂-wax and PE-O-wax showed heavier waxes of average m/z centered near 640 and 590, respectively (FIG. 9C and Table 3). The number average (Mₙ) and weight average (M_{w}) molecular weights of PE-N₂-wax were estimated to be Mₙ~640 Da and Mᵥ~700 Da, corresponding to an average carbon number of ~45. In contrast, the average carbon number of PE-O-wax was ~42 (Mₙ~590 Da and M_{w}~650 Da). The PE-N₂-wax and PE-O-wax were further characterized by nuclear magnetic resonance spectroscopy (NMR) using heteronuclear multiple bond correlation (HMBC) and heteronuclear single quantum correlation (HSQC) experiments (FIGS. 2C, 12, and 13) to investigate the waxes structures. NMR confirmed the presence of unsaturated carbon in both PE-N₂-wax and PE-O-wax, showing primarily 2-propenyl at the chain end (H¹ NMR δ 5.0 and 5.8, C¹³ NMR δ 114 and 138) and minor internal alkenes (C¹³ NMR δ 123-131). The presence of O₂ slightly oxidized PE-O-wax and produced ketones, aldehydes, and esters (FIG. 11).

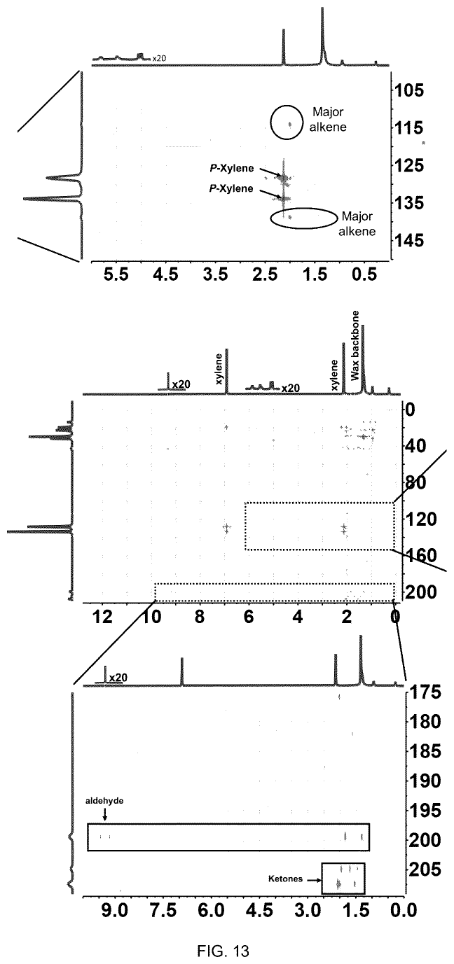

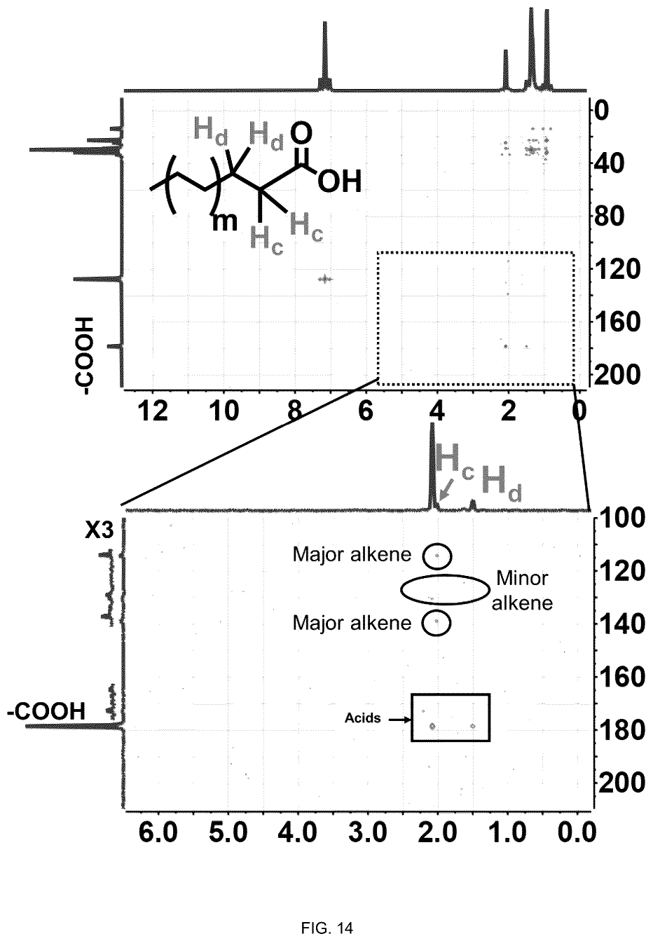

Upcycling of the waxes was conducted over Mn-compounds for 10 h in the air at 150° C. Although inorganic MnO₂ and KMnO₄ have demonstrated great success in paraffin oxidation,^{25, 26} they were ineffective in oxidizing PE-derived wax, probably due to low miscibility, showing no appreciable carbonyl signals after 24 h (FIG. 12). In contrast, Mn stearate catalyzed the oxidization of PE-derived wax much faster thanks to the better dispersion of the catalyst in the organic media.²⁷ The oxidation rate over Mn stearate under a constant air flow, as shown by the carbonyl index (CI), was independent of the substrate being PE-N₂-wax or PE-O-wax. PE-O-wax showed a higher final CI due to the higher initial value than PE-N₂-wax. Supported by HMBC, the oxidation of PE-O-wax over Mn stearate intensified the carbonyl concentration in the first 6 h (FIGS. 12 and 13, C¹³ NMR δ 160-206), producing primarily aldehydes and minor esters, ketone, and carboxylic acids. The dominance of aldehydes intermediates agreed well with the simulation results below. Because aldehydes were susceptible to further oxidation, they were converted to acids in the later 2 h of oxidation and the subsequent saponification (FIG. 2D, C¹³ NMR δ 180). The saponified solution was neutralized with HCl, crashing out fatty acid (PE-O-FA). After washing and drying under a vacuum, PE-O-FA was characterized by HMBC, showing primarily carboxylic acids and minor ketones. Aldehydes were no longer detectable (FIG. 14). The carboxyl in the fatty acid correlated with two types of protons (FIG. 2D, H¹ NMR δ 2.0 and 1.5), indicating potentially a carboxyethyl end-group. The acid number (AN) of the PE-O-FA was determined by titration, giving an ordinary AN of 96 mg KOH/g (FIG. 1D and Table 4) that slightly exceeded the theoretical value of ~80 mg KOH/g for a 700 g/mol monocarboxylic acid (C47).

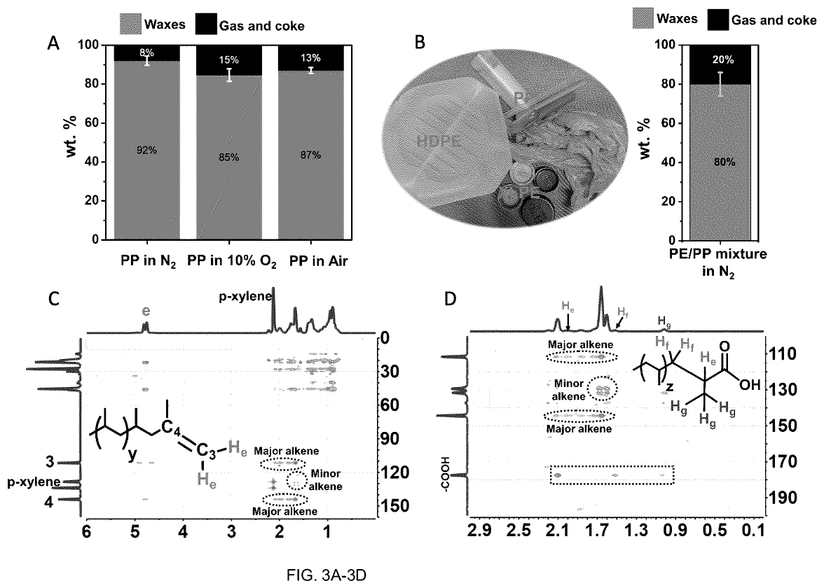

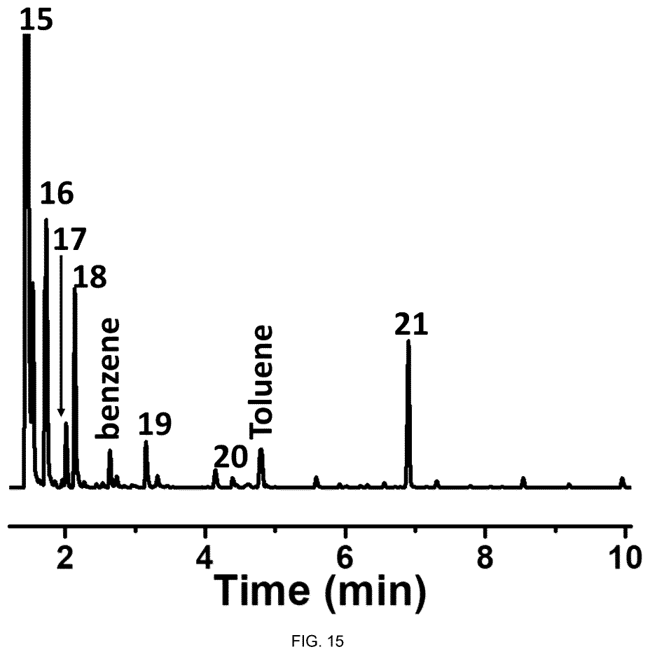

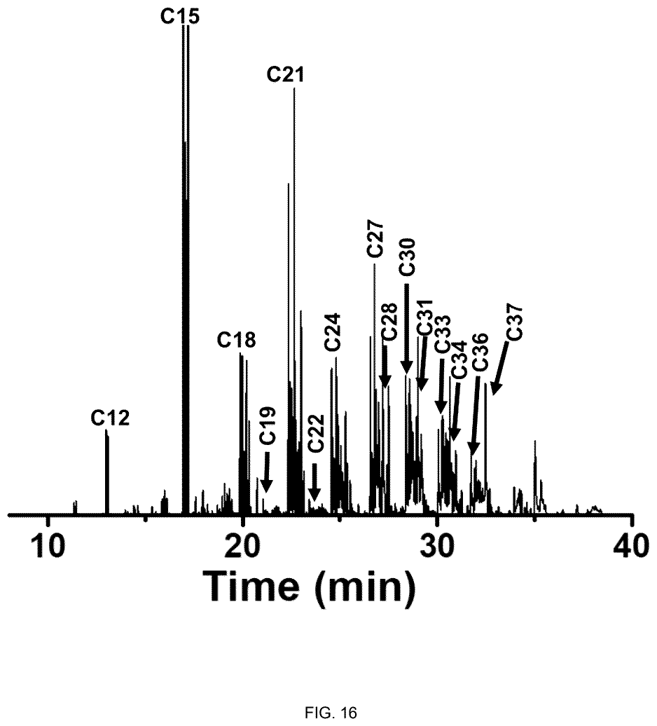

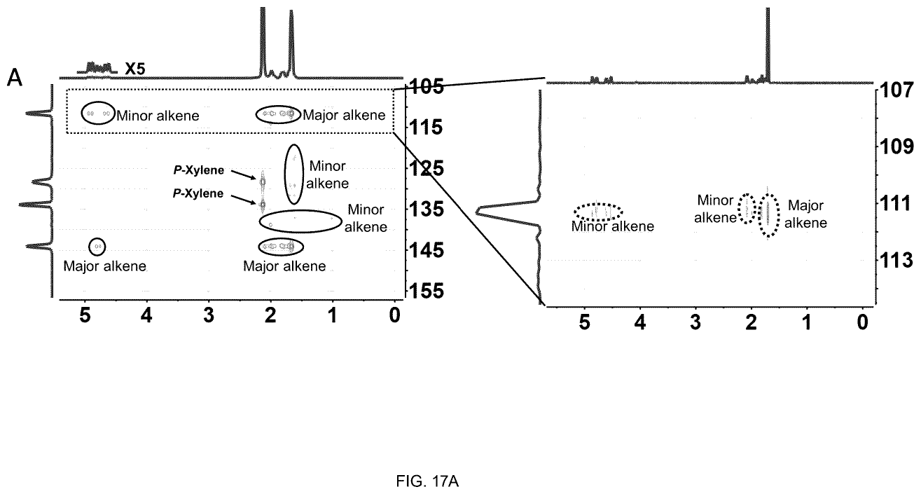

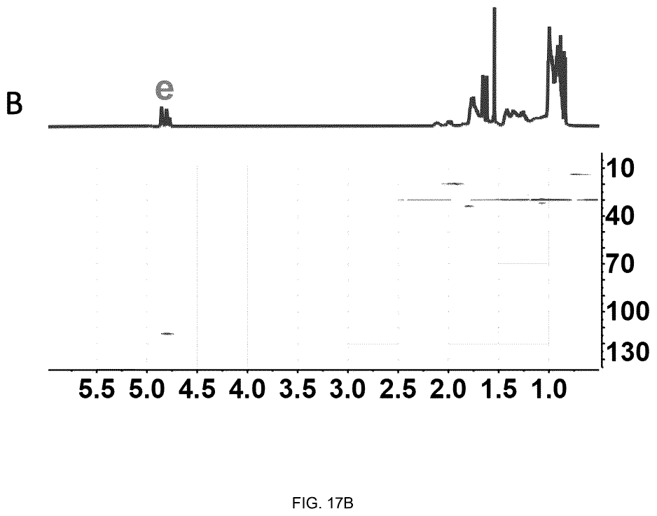

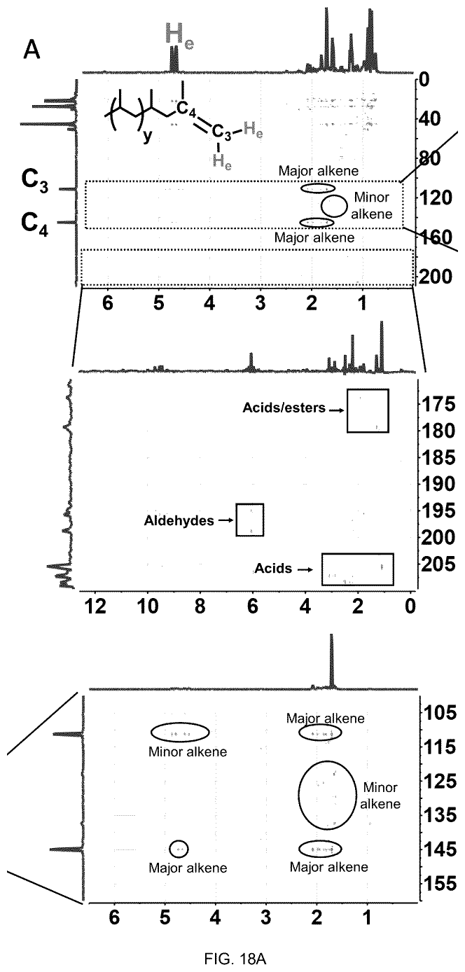

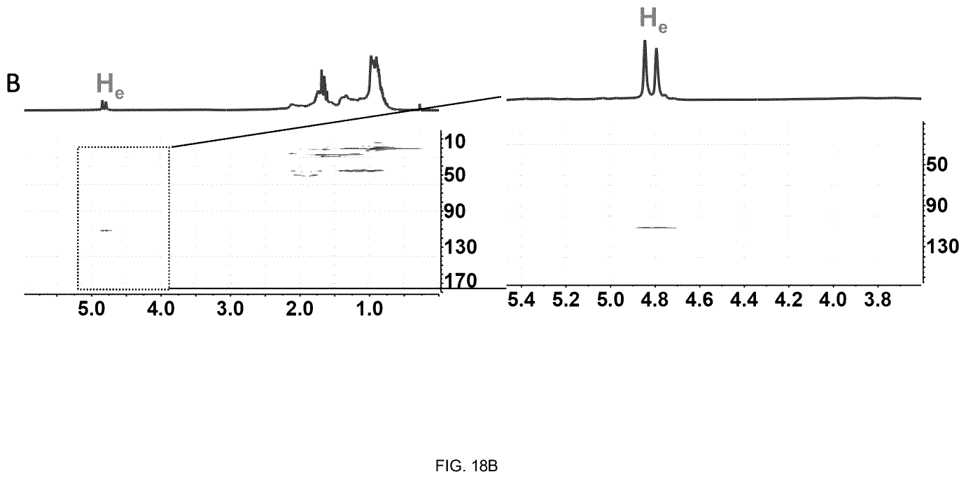

After successfully converting PE to fatty acids, the process was applied to PP under similar reaction conditions (N₂, 10 vol % O₂ in N₂, and air). Degradation products in N₂ (PP—N₂-wax), 10 vol % O₂ (PP—O-wax), and air (PP-air-wax) showed wax yields of 92 wt. %, 85 wt. %, and 87 wt. %, respectively (FIG. 3A and Table 2, exp. 4-6, 10-12, and 14), with a small amount of coke and gaseous products (FIG. 15). Unlike PE, the PP wax yield remained high in the air, eliminating the need for controlled gases in the process and making it more economically attractive. Therefore, the degradation of PP in 10 vol % O₂ was not investigated further. GC-MS analysis of PP-derived waxes showed broad multimodal distributions of primarily alkene products in GC-MS (FIG. 16). The carbon numbers of alkenes were mostly multiples of 3 (or 3n in the range of C9-C36), and that of the rest of alkanes, alkenes, and dienes were mainly 3n+1. This interesting phenomenon suggested that the primary degradation mechanism could be chain scission on the PP backbone because each PP repeating unit has three carbons (this agrees with the simulations below). With air present, the chromatogram of PP-air-wax became crowded and hard to analyze (FIG. 9A). Similar to a previous report,²⁸ PP—N₂-wax and PP-air-wax were characterized by HT-GPC and APCI-MS (FIGS. 9B and C), and the latter showed slightly more short-hydrocarbons due to air-induced oxidation. Like PE degradation, PP—N₂-wax and PP-air-wax were primarily composed of terminal alkenes with minor internal alkenes (FIGS. 3C, 19, and 20). The primary form of the terminal alkene was 2-methyl-2-propenyl, as evidenced by the correlations in the HMBC and HSQC. Additionally, some minor forms of terminal alkenes were noticed, overlapping the major form in the C¹³ NMR but possessing slightly different chemical shifts in the ¹H NMR spectra (FIG. 17A). The chemical structures were indeterminable due to the low abundance. PP-air-wax contained ketones, aldehydes, and esters due to oxygen-induced oxidation (FIG. 18), but the alkenyl region was similar to that of the PP—N₂-wax.

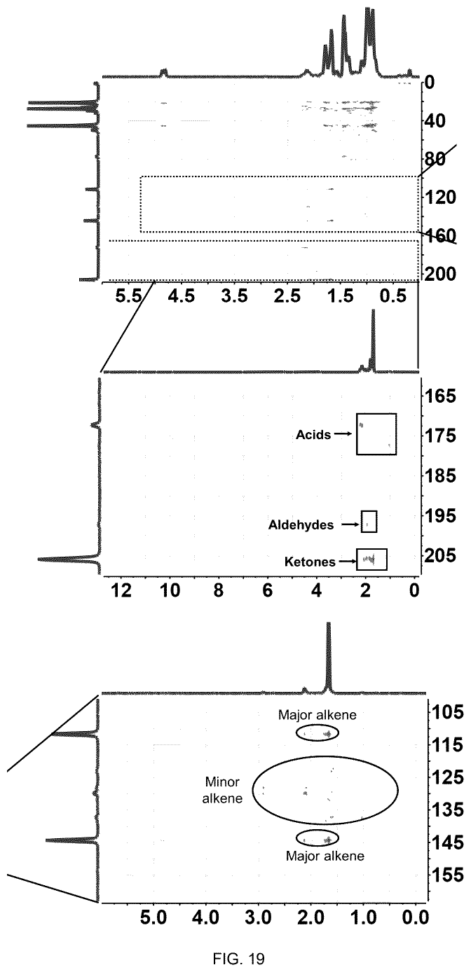

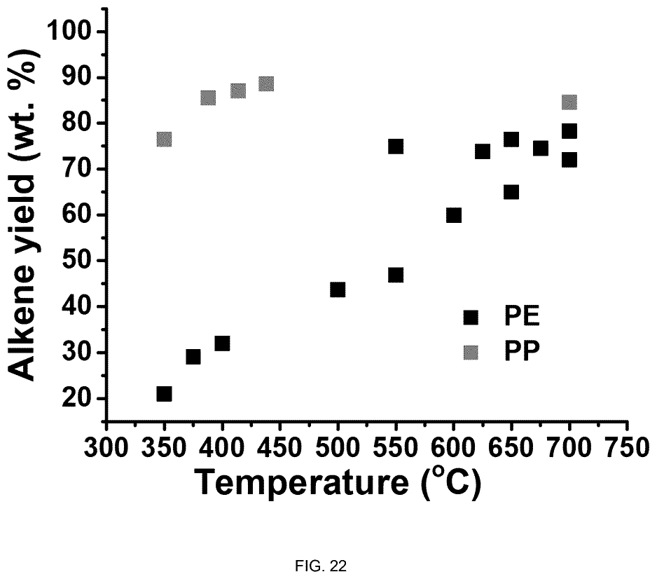

Similar to the PE-derived waxes, upcycling of PP—N₂-wax and PP-air-wax was conducted in air at 150° C. over Mn stearate. PP—N₂-wax oxidation was slower than PP-air-wax, which showed a CI of ~0.9 after four hours of oxidation (FIG. 12C). According to the NMR-HMBC, the oxidation introduced acid, aldehyde, and ketone carbonyls (FIG. 19). The resulting fatty acids (PP-air-FA) after hydrolysis were characterized by NMR-HMBC, showing no detectable aldehyde but stronger ketone carbonyl signals than PE-O-FA. The acid carbonyl has three correlations with proton (FIGS. 3D and 22), indicating possibly a 2-carboxylpropyl terminal structure. PP-air-FA exhibited an AN of 169 mg KOH/g, substantially higher than the theoretical value of 84 mg KOH/g for a monocarboxylic acid at 670 g/mol (C46) (Table 4), suggesting the presence of polyacids.

After successfully converting both PE and PP to wax and fatty acids at high conversions, Applicants tested the degradation of a mixture of HDPE (25 wt. %), PP (25 wt. %), LDPE (25 wt. %), and crosslinked PE (XLPE, 25 wt. %), yielding wax at a yield of 80% in N₂. The wax was further upcycled to fatty acids, giving an average acid number of 57.3 mg KOH/g (FIG. 1D and Table 4). Long-chain ketones and aldehydes could be present in the product. The ketones and aldehydes can advantageously adjust the product viscosity, function as soap softeners,²⁹ and modulate fragrance release.¹⁶ Because ketones and aldehydes are important additives in soap and cosmetic products, separating and reducing the ketone and aldehyde carbonyls are unnecessary.

Applicants used the Benson group additivity method^{30, 31} to evaluate the standard Gibbs free energy (ΔG⁰) (Equation 6 and Table 6) of PE β-scission (Δ_{PE}⁰=51.1 kJ/mol) and PP β-scission (Δ_{PP}⁰=45.7 kJ/mol) Thermodynamically, alkene formation from PP and PE is disfavored at 298 K (Table 7). At elevated temperatures (633 K and 823 K), PE and PP β-scission becomes increasingly thermodynamically favorable. Under the experimental conditions (633 K), the reaction enthalpies and Gibbs free energies of PE and PP degradation have reduced (ΔH_{PP,635K}=88.9 kJ/mol and ΔG_{PP,633K}=−5.60 kJ/mol; ΔH_{PE,633K}=94.3 kJ/mol and ΔG_{PE,633K}=1.20 kJ/mol). However, it is still slightly disfavored for PE. Once increasing the temperature to 823 K, both PE and PP have favored β-scission (ΔH_{PP,823K}=86.9 kJ/mol and ΔG_{PP,823K}=−33.1 kJ/mol; ΔH_{PE,823K}=92.9 kJ/mol and ΔG_{PE,823K}=−26.5 kJ/mol). The kinetic parameters and constants of β-scission were also predicted using the group additivity method based on model reactions (FIG. 5A).³² PP β-scission showed lower activation energies and higher kinetic constants than PE at all temperatures (Table 8). In general, alkene formation from PP β-scission is more favored and faster than from PE (this agrees well with the experiments and simulations above). The observation of PE and PP β-scission dependence on temperature also agrees well with the literature, where the alkene yield from PE pyrolysis increased from ~30% at 500-700 K to ~70% at above 800 K, while that from PP pyrolysis stayed high (>70%) regardless of the temperature (FIG. 22).^{20, 33-40}

### Summary and Conclusion

This work reports a versatile strategy to chemically upcycle PE and PP into fatty acids and surfactant products such as soaps and detergents. The process starts with temperature-gradient pyrolysis to form aliphatic chains of controlled lengths, followed by oxidation to produce fatty acids. The fatty acids have a wide range of applications, and their downstream surfactant products possess at least twice the market value of virgin plastics, representing an economically competitive process for plastic waste utilization. In addition, surfactants have a market volume matching that of end-of-life plastic wastes, thus representing a volume-impactful method for plastic waste removal. The controlled pyrolysis in a temperature-gradient reactor is the key to controlling the yield of the wax products, ensuring a nearly 90% wax yield instead of small gaseous molecules. Unlike other existing processes,¹⁹ the process tolerates oxygen and requires no expensive catalysts or stringent reaction conditions. More importantly, the process is applicable to PE and PP mixtures, removing the need to separate the two lighter-than-water commodity plastics. The resulting fatty acids show good acid values for PE-(96 mg KOH/g) and PP-derived fatty acids (169 mg KOH/g). Applicants anticipate the process to be amendable to a diverse range of other plastic wastes.⁴¹⁻⁴³ With the possibility of producing high-value high-market-volume detergents and sanitizers, the process should be appealing to the industry for recycling/upcycling the enormous amount of polyolefin waste generated during the COVID-19 pandemic.

### Experimental Section

### Materials

Unless otherwise stated, all chemicals were purchased from Sigma-Aldrich with a purity of >99%. Deuterated benzene (C₆D₆, 99.8%), toluene (C₇H₈, 99.8%), and p-xylene (C₈H₁₀, 99.5%) were purchased from Cambridge Isotope Laboratories, Inc. and used as received. Mn stearate and Mn/Ni oxides were synthesized following procedures in the literature.^{44, 45} Degradation was conducted in a custom-designed quartz reactor manufactured by Tuoda Quartz Tcl®.

### Instrumentations

Gas chromatography (GC) analyses were performed on a 6890 GC equipped with a DB-5 capillary column (30 m long×250 μm I.D. with a film thickness of 0.25 μm) from J&W Scientific (Wilmington, DE) and a flame ionization detector (FID). The following operating parameters were used for each GC analysis:
Injection Port Temp. 300° C.
Purge Valve 3 mL min⁻¹
Purge Time 1 min
Total Flow 11 mL min⁻¹
Constant Flow 0.8 mL min⁻¹
Injection Volume 1 μL, split 1:10
Column Oven Initial Temp. 50° C.
Column Oven Initial Time 3 min
Column Oven Ramp Rate 10° C. min⁻¹ to 300° C.
Column Oven Final Temp. 300° C.
Column Oven Final Time 53 min

All Gas chromatography-mass spectrometry (GC-MS) analyses were performed on a 6890 GC with a 5973 Mass Selective Detector (MSD) from Agilent. The MS Wiley library was used to identify the peaks. Separation was performed using the same GC column at the same operating conditions. The MSD transfer line temperature was 280° C.

Quantitative proton nuclear magnetic resonance (Q-¹H NMR) spectroscopy was performed on a Bruker Avance II 600 spectrometer at 600 MHz in a deuterated solvent with a relaxation time of 5 s and 128 scans. The characterizations of PE-N₂-wax were conducted in deuterated p-xylene due to its poor solubility in deuterated benzene. All other PE and PP-derived waxes, oxidized waxes, and soaps were dissolved in deuterated benzene unless otherwise stated.

Heteronuclear multiple bond correlation (HMBC) and heteronuclear single quantum coherence (HSQC) experiments were performed on a Bruker Avance II 600 spectrometer at 600 MHz in a deuterated solvent, with a relaxation time of 2 s, 16 scans, and digitizing increment of 400.

Fourier transform infrared spectroscopy (FTIR) was performed at room temperature using a PerkinElmer ATR-FTIR (model Spectrum 100) in the range of 4000-1000 cm⁻¹ with 256 scans at a resolution of 4 cm⁻¹.

The reaction temperature was determined using a thermal imaging camera (HIKMICRO™ E1L®) with 160×120 resolution (FIG. 5).

Melt rheological studies were performed on an AR-G2 rheometer (TA Instruments). All measurements were performed in an oscillatory time sweep mode using 25 mm ETC aluminum parallel plates at 100° C. and a gap spacing of 1 mm (frequency: 1 Hz).

Atmospheric pressure chemical ionization mass spectroscopy (APCI-MS) was performed on a Shimadzu LCMS9030 interfaced with a UPLC (LC-40B×3) equipped with an autosampler (SIL-40C×3) and column oven (CTO-40C), all from Shimadzu. The flow rate was maintained at 200 uL/min at an oven temperature of 40° C. Mobile phases were Solvent A (60:40 water:acetonitrile containing 10 mM ammonium formate) and Solvent B (90:10 isopropanol:acetonitrile containing 10 mM ammonium formate), maintained at a ratio of 5:95 (A:B). Samples were prepared in xylenes, and an aliquot (90 uL) was mixed with isopropanol containing 0.1% formic acid (10 uL). These solutions were analyzed in flow injection mode at 2 uL/injection in positive ion mode. Data were recorded in profile mode using a mass range of 100-1500 m/z and a scan time of 0.1 sec. Ionization was performed using a dual ionization source (DUSI) with the corona needle voltage set to 4.5 kV and the interface at 4 kV. Nebulizing Gas Flow: 2.0 L/min, Heating Gas Flow: 10.0 L/min, Interface Temperature: 300° C., Desolvation Temperature: 526° C., Drying Gas Flow: 10.0 L/min, DL Temperature: 250° C., Heat Block: 400° C.

### PE and PP Degradation

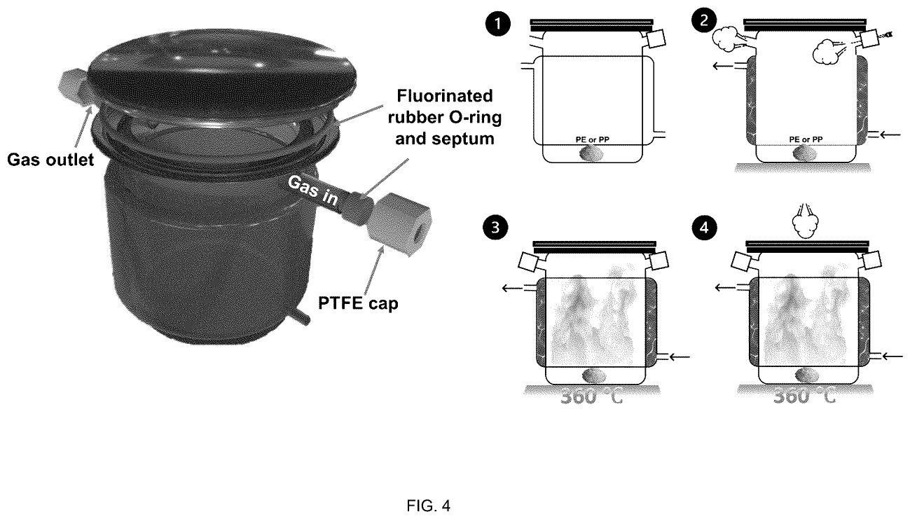

Degradation in N₂/O₂ mixture is described as follows, and the degradation in N₂ and air followed similar procedures. PE or PP (~500 mg) was added to a custom-designed quartz reactor (FIG. 4). The reactor was capped with a quartz plate and sealed with a fluorinated rubber O-ring. The reactor assembly was reinforced by two clamps. The gas inlet was sealed with a fluorinated septum and fixed by a Teflon cap, while the gas outlet was initially left open (FIG. 4, step 1). The reactor is then degassed for 15 min by a mixture of N₂ and air. Simultaneously, heating and cooling water were provided to balance the interior pressure with the ambient pressure (Caution: heating the reactor and giving cooling water after degassing would over-pressurize and depressurize the reactor, respectively). The reactor was heated stepwise (~100° C./5 min), and the internal temperature reached ~360° C. after ~15 min (FIG. 4, step 2). The N₂ and air flows were kept for another 30 s and stopped immediately after the polymers in the reactor started to “smoke” (FIG. 4, step 3). The “smoke” signified the initiation of polymer degradation. A red laser beam could detect the light smoke at the early stage of degradation (FIG. 4). Immediately after stopping the gas flow, the outlet was sealed with a fluorinated septum and fixed by a Teflon cap. The quartz plate at the top of the reactor was chilled by a stream of cool air to keep its temperature low (FIG. 4, step 4). At this point, only the reactor bottom was hot, and the reactor interior wall and ceiling were near room temperature. The reaction was stopped after 16 h, and the reactor was cooled down to room temperature.

### PE and PP Upcycling

The upcycling consisted of two steps. 1. Oxidation. In a typical experiment, 500 mg of wax and 25.0 mg of manganese stearate (5 wt. % with respect to the wax mass) were transferred to a reactor equipped with a stir bar. A constant flow of air was fed into the reactor at a rate of ~50 mL/s. The internal temperature was adjusted to 150° C., and the reaction proceeded for 10 h. 2. Saponification. After oxidation, the oxidized products were subjected to saponification in 0.1 M KOH (wax concentration, ~20 mL/g). The aqueous mixture was refluxed for 12 h and then transferred to a clean beaker (Note, long saponification time in the concentrated base may etch the glass reactor, forming silicate). By adjusting pH to ~1 using concentrated HCl, fatty acids were crushed out and floated on the solution. The fatty acids were collected by centrifugation and washed with water until the pH level reached ~7. (Silicate may appear at the bottom of the centrifuge tube due to glassware etching caused by KOH). The fatty acids were dried and weighed to evaluate the yield.

### Supporting Information

### Experimental Methods.

### Characterizations of PE and PP Degradation

1. Gas flow and reactor interior temperature. The degradation atmosphere was controlled by a stream of gas at controlled flow rates. The interior temperature of the quartz reactor was measured using an IR camera (FIG. 5A). The temperature at the reactor bottom was set to ~360° C. during the degradation reaction.
2. Yield determination. The wax yield was measured directly using an analytical balance. First, the wax condensed on the quartz cap was scratched into the reactor using a piece of soft plastic, and the residue was washed into the reactor with hexanes. Afterward, about 100 mL of hexanes was added to the reactor, and then the reactor was capped for refluxing. By refluxing hexanes, the wax on the reactor wall was also collected. Note that cooling water for the reactor should not be used during the refluxing. After refluxing, the hot wax/hexanes solution was transferred to a pre-weighted flask (m₀), followed by solvent removal using a rotary evaporator (50° C., 100 mbar). Any residual hexanes and light hydrocarbons were allowed to vaporize overnight. The final mass (m₁) was recorded to evaluate the mass of the intermediate wax (m₁−m₀).
3. GC and APCI characterizations. After PE or PP degradation, the reactor was cooled to room temperature. The negative pressure in the reactor was balanced to the ambient by refilling N₂ through the gas inlet. The gases in the reactor were immediately sampled and characterized using GC-MS and GC-FID. The liquid and solid products were collected using a spatula, transferred into a GC vial filled with toluene, heated to complete dissolution on a hot plate, and then sampled for GC analysis. (Note: For PE-derived waxes, the solution must be kept warm during GC-MS injection because PE-derived waxes have a low solubility in toluene at room temperature. Xylenes are a better solvent, but they usually contain complex isomers that could overlap the wax peaks in GC). For APCI-MS characterization, the waxes were dissolved in xylenes because of the better solubility of hydrocarbon in xylenes at elevated temperatures. The solution concentrations were roughly 0.5 mg/mL. Solvation of PE-N₂-wax in xylenes was slow, and therefore heated at 110° C. until fully dissolved.

The number average (Mₙ) and weight average molecular weights (M_{w}) of waxes were determined based on GC (Equation S1) and APCI (Equation S2)

$${M}_{n} = \frac{\sum {m}_{i}}{\sum {n}_{i}} = \frac{{\sum }_{1}^{n} {KA}_{i}}{{\sum }_{1}^{n} \frac{{KA}_{i}}{{MW}_{i}}} = \frac{{\sum }_{1}^{n} {A}_{i}}{{\sum }_{1}^{n} \frac{{A}_{i}}{{MW}_{i}}} \qquad ( 1 )$$

$${M}_{w} = \frac{\sum {m}_{i} \times {MW}_{i}}{\sum {m}_{i}} = \frac{{\sum }_{1}^{n} {KA}_{i} \times {MW}_{i}}{{\sum }_{1}^{n} {KA}_{i}} = \frac{{\sum }_{1}^{n} {A}_{i} \times {MW}_{i}}{{\sum }_{1}^{n} {A}_{i}}$$

$${M}_{n} = \frac{\sum {m}_{i}}{\sum {n}_{i}} = \frac{{\sum }_{1}^{n} C \times {I}_{i} \times {MW}_{i}}{{\sum }_{1}^{n} C \times {I}_{i}} \qquad ( 2 )$$

$${M}_{w} = \frac{\sum {m}_{i} \times {MW}_{i}}{\sum {m}_{i}} = \frac{{\sum }_{1}^{n} C \times {I}_{i} \times {MW}_{i} \times {MW}_{i}}{{\sum }_{1}^{n} C \times {I}_{i} \times {MW}_{i}}$$

where m₊ and n₊ are the mass and molar number of a compound; MW₊ is the molecular weight of a compound determined by GC-MS or APCI-MS (FIG. 9); K represents the FID mass response factor, which can be assumed as a constant for alkanes and alkenes according to literature;^{1, 2} A₊ is the peak area from GC-FID. 0
where Ii is ion intensity of an ionized species; C represents the MS molar response factor and is assumed to be a constant, due to the minor change of value for long-chain hydrocarbons with different carbon number (0.8-1.1).³

### Characterization of PE and PP Upcycling

1. Oxidation kinetic study. The wax oxidation was monitored using a carbonyl index (CI) that can be evaluated using ATR-FTIR. After degradation, the wax products were divided and distributed into 4-5 flasks, each containing waxes of ~100 mg and Mₙ stearate catalyst (5 wt. %). Parallel oxidations of varying oxidation times were conducted under the same temperature and airflow. The carbonyl index was calculated using Equation S3.

$$CI = \frac{{h}_{C = O}}{{h}_{C - 8}} \qquad ( 3 )$$

where h_{C═O} is the carbonyl stretching peak intensity at ~1700 cm⁻¹; h_{C—H} is the C—H stretching peak intensity at 2800 cm⁻¹.
2. Acid number determination. Acid numbers of PE and PP-derived fatty acids were determined using a modified titration method based on the standard GB T 5510-2011. As suggested by a similar standard, ISO 7537:1997, toluene was utilized as the solvent instead of the benzene introduced in GB T 5510-2011, due to the lower toxicity and better solvation ability of toluene. The theoretical values were estimated using Equation S4, assuming one acid group per molecule.

$$AN = \frac{{M}_{KOH}}{{M}_{PA}} \times 1000 \qquad ( 4 )$$

Where AN is the theoretical acid number; M_{KOH} is the molecular weight of potassium hydroxide; and M_{FA} is the number average molecular weight of fatty acid.

### Thermodynamic and Kinetic Parameters of PE and PP Degradation

PE and PP degradation follows the initiation, radical transfer/depolymerization, and termination mechanisms. During the radical transfer step, the β-scission reaction is the primary contributor to the chain scission and alkene formation. Therefore, the thermodynamic and kinetic parameters of β-scission are evaluated to understand the difference in the PE and PP degradations.
1. Thermodynamic parameter prediction by Benson group additivity method. The (3-scission thermodynamics of PE and PP at various temperatures was assessed using data calculated by Benson group increment theory for gas phase alkanes and olefins at 298 K.^{4,5} Increment values of moieties g₁ to g₉ are defined and compiled in Table 6.

The increment values of moieties (Table 6, g₁ to g₉) at 633 K and 823 K are estimated using Kirchhoff's laws. The heat capacity term was obtained by fitting heat capacity values at various temperatures using the empirical expression of heat capacity (Equation S5)

$${C}_{P} = a + bT + \frac{c}{{T}^{2}} \qquad ( 5 )$$

where C″ is heat capacity at constant pressure; a, b, and c are constant; T is temperature.

The enthalpy and entropy values of a linear PE radical (Equation S6) is

$$2 n \times {g}_{1} + 2 {g}_{2} + 2 m \times {g}_{1} + {g}_{5} \qquad ( 6 )$$

where n and m are the number of repeating units.

The enthalpy and entropy values of a PP radical is

$$n \times {g}_{1} + n \times {g}_{2} + n \times {g}_{7} + 3 {g}_{2} + m \times {g}_{1} + m \times {g}_{2} + m \times {g}_{7} + {g}_{8} \qquad ( 7 )$$

The enthalpy and entropy values of the olefins derived from PE radical β-scission is

$$2 n \times {g}_{1} + {g}_{2} + {g}_{3} + {g}_{4} \qquad ( 8 )$$

The enthalpy and entropy values of the olefins derived from PP radical β-scission is

$$n \times {g}_{1} + n \times {g}_{2} + n \times {g}_{7} + 2 {g}_{2} + {g}_{3} + {g}_{4} \qquad ( 9 )$$

The enthalpy and entropy values of the oligomer radical derived from PE radical β-scission is

$$2 ( m - 1 ) \times {g}_{1} + {g}_{2} + {g}_{6} \qquad ( 10 )$$

The enthalpy and entropy values of the oligomer radical derived from PP radical β-scission is

$$( m - 1 ) \times {g}_{1} + ( m - 1 ) \times {g}_{2} + ( m - 1 ) \times {g}_{7} + 2 {g}_{2} + {g}_{5} \qquad ( 11 )$$

The predicted thermodynamic parameters were summarized in Table 7.
2. Kinetic parameter prediction by group additive method. The β-scission kinetics of PE- and PP-based radicals was calculated using the group additive method⁶ based on the corresponding model reactions. The labeled carbons (C₁, C₂, C₃) corresponded to the labeled carbons in the reference reaction, methyl radical addition to ethene forming propyl radical. The contributions of the nearest atoms/groups to the kinetic parameters can be reliably evaluated using the model. Pre-exponential factors (A) and activation energy (Eₐ) at 298 K were calculated and tabulated in Table 8. Because temperature has a minor effect on the group contributions, its effect on the kinetic parameters was ignored. At a wide temperature range of 300-1300 K, the changes in group additive value of activation energy (ΔGAV_{Ea}) is smaller than ±4 kJ/mol out of 125 kJ/mol, and the changes in group additive value of pre-exponential factor (ΔGAV_{lgA}) is smaller than ±0.6 lg(/s) out of 13.181 lg(/s).⁶ Number of event (nₑ) was omitted to simplify the calculation of the pre-exponential factor.

### Quantitative NMR Analysis of Alkenyl Group Concentration

1. Calibrations of deuterated solvents. The concentrations of regular benzene (C₆H₆) and p-xylene (C₃H₁₀) in deuterated benzene (C₆D₆) and p-xylene (C₆D₁₀) were measured using an external reference method. The masses of deuterated solvent (C₆D₆ or C₆D₁₀, ~1 mL) and an external reference CHCl₃ were accurately measured using an analytical balance. After adding CHCl₃ to the deuterated solvents, the mixtures were sealed and swirled to ensure thorough mixing. The mixtures were then immediately characterized with NMR. The concentration of C₆H₆ and C₃H₁₀ in the deuterated solvents were calculated to be 3.273 mg/g and 1.656 mg/g, respectively.
2. Determination of alkenyl group concentration in waxes and fatty acids. The concentrations of alkenyl groups in the products after degradation and upcycling were determined using an external reference method. The regular benzene (C₆H₆) and p-xylene (C₈H₁₀) in the deuterated solvents were utilized as external references. The masses of the degradation and upcycling products and the deuterated solvents were accurately measured in clean GC vials. The vials were sealed with PTFE caps and warmed at 60° C. for complete dissolution. The mixtures were immediately characterized with NMR to avoid any potential vaporization. The alkenyl groups' mass concentrations (mol/g) were determined using Equation S12.

$${c}_{C = C} = \frac{{m}_{d - solvent}}{{M}_{d - solvent}} \times {c}_{CH} \times \frac{{n}_{phen - H} \times r}{{n}_{ene - H} \times m} \qquad ( 12 )$$

where C_{C═C} is the alkenyl mass concentration; m_{d-solvent} is the mass of deuterated solvents; M_{d-solvent} is the molar mass of deuterated solvents; C_{CH} is the concentration of regular benzene (C₆H₆) and p-xylene (C₃H₁₀) in the deuterated solvents; n_{phen-H} is the number of H on C₆H₆ or C₈H₁₀; r is the ratio of alkenyl over C₆H₆ or C₈H₁₀; n_{ene-H} is the number of H on alkenyl groups, 3 and 2 for PE and PP, respectively; m is the mass of the sample.

### Supplementary Discussion.

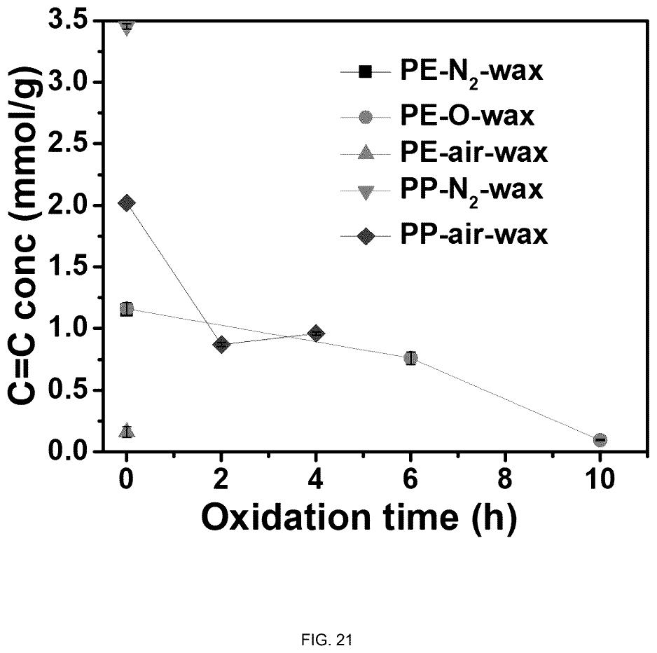

Oxidation of alkenes and potential side reactions. The concentration of alkenyl groups in PE- and PP-derived waxes decreased sharply during the oxidation over Mₙ (Ill) stearate. The alkenyl concentration in PE-O-wax decreased from ~1 mmol/g to ~0.8 mmol/g after 6-h oxidation, and to almost zero after 10 h (FIG. 21). PP-air-wax underwent a similar reduction from ~2 mmol/g to ~0.9 mmol/g after 2 h, but the alkenyl concentration recovered to ~1 mmol/g after 4 h due to the formation of internal alkene. This initial alkenyl concentration drop may be attributed to two types of reaction: 1) polymerization and oxidative crosslinking of olefin waxes; 2) alkenyl-related oxidations to carbonyl-containing groups. Some monomers can potentially polymerize in the air due to thermal initiation,⁷ peroxide,⁸ or other alkene reactions,^{7, 9} causing an increase in molecular weight and viscosity. Although the rheometer confirmed the viscosity increment (~20 Pa S) during thermal treatment, the molecular weight increment of PE-O-FA (Mₙ~700 Da and M_{w}~750 Da) and PP-air-FA (Mₙ~670 Da and M_{w}~740 Da) was rather small (<100 Da) according to APCI-MS (FIG. 9 and Table 2). Considering the high alkenyl conversion (>50%) and introduction of oxygen atoms to the hydrocarbons through carbonyl and acid, the polymerization reaction must be minor. Therefore, the main function of alkenyl was to form acids and other oxygen-containing groups. Supposedly, one alkenyl can be oxidized to one carboxylic acid, the theoretical acid numbers of PE-O-wax and PP-air-wax, by the change of alkenyl concentration (~1 mmol/g), are smaller than the determined AN (FIG. 1D). Therefore, not all acids were converted by alkenyl oxidation, and alkyl group oxidation was another important contributor to the carboxylic acid.

TABLE 1
Prices of different products pertinent to the project.

| Products | Market prices |
|---|---|
| Crude oil^{a} | $540/ton |
| Paraffin wax^{b} | $1,200/ton |
| BTX^{c} | $933/ton; $800/ton; |
| | $850/ton |
| Stearic acid^{d} | $1,300/ton |
| Virgin HDPE^{e} | $1,216/ton |
| Virgin PP | $1,208/ton |
| Household surfactant products^{f} | $2,300-10,000/ton |
| Sodium stearate^{g} | $1,790/ton |

^{a}Crude oil prices were obtained from Brant (November 2021)
^{b}Paraffin wax price were obtained from ECHEMI, converted from RMB to USD (November 2022)
^{c}BTX are benzene, toluene, and xylene. BTX prices were obtained from Statista, ECHEMI, and Statistics, respectively. (2021)
^{d}Steric acid price was obtained from ECHEMI, converted from RMB to USD (November 2022)
^{e}Prices of the polyolefins were obtained from Statista (2022)
^{f}Based on the US market, the average price range of a soap unit (0.5-1 kg) was obtained from common soap commodities, such as body wash, bar soap, liquid soap, and sanitizers.
^{g}Average price from 10 different suppliers in IndiaMart, converted from [symbol] to $ (December 2022).

TABLE 2
The yields of polymer degradations at different oxygen levels

| | | Oxygen | Plastic | Wax | Waxes |
|---|---|---|---|---|---|
| | | level | mass | mass | Yield |
| exp | polymer | (vol %)^{a} | (mg) | (mg) | (%)^{b} |
| 1 | PE | 0% | 514 | 443 | 86 |
| 2 | | (N₂) | 512 | 438 | 85 |
| 3 | | | 519 | 459 | 88 |
| 4 | PP | | 501 | 440 | 88 |
| 5 | | | 520 | 492 | 95 |
| 6 | | | 486 | 420 | 86 |
| 7 | PE | 10% | 502 | 400 | 80 |
| 8 | | | 501 | 398 | 79 |
| 9 | | | 547 | 421 | 77 |
| 10 | | | 510 | 412 | 83 |
| 11 | PP | | 527 | 460 | 87 |
| 12 | | | 534 | 459 | 86 |
| 13 | PE | 21% | 532 | 295 | 55 |
| 14-a | PP | (Air) | 526 | 458 | 87 |
| 14-b | | | 502 | 447 | 89 |
| 14-c | | | 498 | 421 | 86 |
| 15 | C-LDPE | 0% | 660 | 601 | 91 |
| 16 | C-HDPE | (N₂) | 506 | 440 | 87 |
| 17 | X-PE | | 514 | 380 | 74 |
| 18 | C-PP | | 500 | 380 | 76 |

^{a}Oxygen volume ratio was controlled by N₂ gas and air flow rate.
^{b}Wax yield was calculated based on the weight of wax as measured using an analytical balance.

TABLE 3
Average molecular weights of PE- and
PP-derived waxes and fatty acids.

| | | | Molecular weights | | | |
|---|---|---|---|---|---|---|
| | | Oxygen | GC^{a} | | APCI-MS^{c} | |
| Entry | Polymer | level (%) | Mₙ | M_{w} | Mₙ | M_{w} |
| 1 | PE | 0% | 312 | 336 | 640 | 700 |
| | | (i.e., N₂) | | | | |
| 2 | | 10% | 277 | 332 | 590 | 650 |
| 3^{b} | | | — | — | 700 | 750 |
| 4 | PP | 0% | 294 | 325 | 640 | 670 |
| | | (i.e., N₂) | | | | |
| 5^{b} | | 21% | — | — | 580 | 650 |
| 6^{b} | | (i.e., Air) | — | — | 670 | 740 |

^{a}The molecular weights were evaluated by GC and APCI-MS using Equation S1 and S2.
^{b}The molecular weights cannot be estimated due to poor separation in GC.
^{c}Values were rounded to 2 significant figures due to ion fragmentations.

TABLE 4
Yield and acid numbers (AN) of fatty acids

| | | Oxygen | Wax | Fatty | Acid |
|---|---|---|---|---|---|
| | | level | mass | acid mass | number |
| Entry | Polymer | (%) | (mg) | (mg) | (mgKOH/g) |
| 1^{a} | PP | 21 | 482 | 493 | 41.7 ± 3.2 |
| 2^{b} | PP | 21 | 1015 | 1022 | 169.1 ± 6.6 |
| 3^{b} | PE | 10 | 382 | 385 | 96.2 ± 4.7 |
| 4^{b} | PE + PP | 0 | 804 | 812 | 57.3 ± 3.7 |

^{a}Oxidation was conducted at 150° C. with an airflow rate of ~1 mL/s, giving fatty acids with a low acid number.
^{b}Oxidation was conducted at 150° C. with an airflow rate of ~50 mL/s, giving fatty acids with a high acid number.

TABLE 5
The C═C concentration in waxes, oxidized waxes, and fatty acids.

| | | | | | | | C═C | |
|---|---|---|---|---|---|---|---|---|
| | | Oxygen | sample | | | | concentration | |
| | | level | mass | | Solvent | Peak | in waxes | |
| Exp | polymer | (%) | (mg) | Solvent | mass | ratio | (mmol/g)e | |
| 1^{a} | PE | 0% | 5.84 | p-xylene | 921 | 0.139 | 1.15 | |
| | | (N₂) | 6.12 | d₁₀ | 972 | 0.140 | | |
| 7^{a} | PE | 10% | 5.23 | benzene | 682 | 0.105 | 1.16 | (±0.05) |
| | | | 5.15 | d₆ | 675 | 0.098 | | |
| 7-1^{bc} | | | 5.76 | | 604 | 0.089 | 0.76 | (±0.05) |
| | | | 5.34 | | 603 | 0.078 | | |
| 7-2^{b} | | | 9.72 | | 693 | 0.015 | 0.095 | (±0.007) |

| | | | | | | |
|---|---|---|---|---|---|---|
| | | | 6.48 | 462 | 0.020 | |
| 8^{a} | PE | 10% | 4.3 | 608 | 0.088 | 1.07 |
| 23 | PE | Air | 5.78 | 614 | 0.015 | 0.13 |
| 24 | PE | | 5.88 | 635 | 0.021 | 0.19 |
| 4^{a} | PP | 0% | 5.75 | 632 | 0.228 | 3.15 |
| 4^{a} | PP | (N₂) | 5.03 | 637 | 0.180 | 2.87 |
| 14^{a} | PP | Air | 11.72 | 1010 | 0.187 | 2.02 |
| | | | 7.41 | 634 | 0.184 | 2.02 |
| 14-1^{bd} | | | 4.19 | 858 | 0.04 | 0.88 |
| | | | 7.04 | 742 | 0.08 | 0.86 |
| 14-2^{b} | | | 7.05 | 665 | 0.08 | 0.95 |
| | | | 6.59 | 727 | 0.07 | 0.97 |

^{a}The sample was derived from the experiments in Table 2.
^{b}‘-1’ and ‘-2’ were the oxidized waxes and fatty acid obtained from waxes oxidation.
^{c}7-1 was sampled after 6 h of oxidation.
^{d}14-1 was sampled after 2 h of oxidation.
ethe mass concentrations of alkenyl were determined using Equation S12.

TABLE 6
Benson group increment values of some sub-groups at 298 K, 633 K, and 823 K. Benson group increments for
sub-groups found in PE, PP, and polymer radicals at 298 K. All data are extracted from NIST Database.⁵

| | | 298 K | | | | | | | | |
|---|---|---|---|---|---|---|---|---|---|---|
| | | ΔH^{o}_{f} | ΔS^{o}_{f} | C_{P, gas}(J/mol K) | | | | | | |
| Group label | | (kJ/mol) | (J/molK) | 300 K | 400 K | 500 K | 600 K | 800 K | 1000 K | 1500 K |
| g₁ | —CH₂— | −21.0 | 39.4 | 23.0 | 29.1 | 34.5 | 39.1 | 46.3 | 51.6 | 59.4 |
| g₂ | —CH₃ | −42.7 | 127. | 25.9 | 32.8 | 39.3 | 45.2 | 54.5 | 61.8 | 73.5 |
| g₃ | —CH═ | 36.0 | 33.3 | 17.4 | 21.0 | 24.3 | 27.2 | 32.0 | 35.4 | 40.3 |
| g₄ | CH₂═ | 26.0 | 116 | 21.3 | 26.6 | 31.4 | 35.6 | 42.1 | 47.2 | 55.2 |
| g₅ | C—C*H—C | 172 | 55.2 | 18.4 | 21.8 | 26.4 | 28.5 | 32.3 | 35.0 | 39.6 |
| g₆ | —C*H₂ | 164 | 136 | 22.7 | 27.4 | 33.6 | 37.0 | 42.9 | 46.5 | 53.4 |
| g₇ | >CH—C | −7.90 | −50.5 | 19.0 | 25.1 | 30.0 | 33.7 | 39.0 | 42.0 | 46.8 |
| g₈ | >C*—C | 178 | −26.6 | 17.0 | 20.6 | 22.7 | 24.1 | 26.2 | 26.6 | 27.3 |
| g₉ | >C═ | 43.1 | −53.1 | 17.2 | 19.3 | 20.9 | 22.0 | 24.3 | 25.4 | 26.6 |

The calculated Benson group increments⁵ for sub-groups found in PE, PP, and polymer radicals at 633 K and 823 K.

| | |
|---|---|
| 633 K | 823 K |

| Group | ΔH_{f} | ΔS_{f} | ΔH_{f} | ΔS_{f} |
|---|---|---|---|---|
| label | (kJ/mol) | (J/molK) | (kJ/mol) | (J/molK) |
| g₁ | −9.87 | 63.5 | −1.70 | 74.8 |
| g₂ | −30.0 | 155 | −20.4 | 168 |
| g₃ | 43.9 | 50.6 | 49.6 | 58.4 |
| g₄ | 36.1 | 138 | 43.6 | 148 |
| g₅ | 180 | 73.0 | 186 | 80.8 |
| g₆ | 175 | 159 | 182 | 169 |
| g₇ | 1.66 | −29.7 | 8.60 | −20.2 |
| g₈ | 185. | −10.5 | 190 | −3.87 |
| g₉ | 49.9 | −37.9 | 54.4 | −31.8 |

^{a} Group increment values at 633 K and 823 K were calculated using Kirchhoff's law. C_{P, as} Was estimated using Equation S5.

TABLE 7
Thermodynamic parameters of β-scission
on PE and PP at different temperatures.

| | PE | | | PP | | |
|---|---|---|---|---|---|---|
| Temperature (K) | 298 | 633 | 823 | 298 | 633 | 823 |
| ΔHᵣₓₙ (KJ/mol) | 96.0 | 94.3 | 92.9 | 92.0 | 88.9 | 86.9 |
| TΔSᵣₓₙ (KJ/mol) | 44.9 | 93.1 | 119 | 46.3 | 94.5 | 120 |
| ΔGᵣₓₙ (KJ/mol) | 51.1 | 1.20 | −26.5 | 45.7 | −5.60 | −33.1 |

TABLE 8
Group additive values (ΔGAV) for β-scission reactions
and kinetic parameters at different temperatures

| | | ΔGAV | | kinetic parameters^{a} | | kinetic constants | | |
|---|---|---|---|---|---|---|---|---|
| | additive | IgA | Eₐ | IgA | Eₐ | Igk | | |
| polymer | groups | (/s)^{b} | (kJ/mol) | (/s) | (kJ/mol) | 298 K | 633 K | 823 K |
| PE | C₁—(C)(H) | 0.017 | −1.40 | 13.2 | 117 | −7.21 | 3.60 | 5.82 |
| | C₃—(C)(H)2 | 0.027 | −7.10 | | | | | |
| PP | C₁—(C)2 | −0.333 | −4.00 | 12.9 | 106 | −5.69 | 4.13 | 6.15 |
| | C₃—(C)2(H) | 0.026 | −15.2 | | | | | |

^{a}For simplicity, the effect of temperature on kinetic parameters is ignored.
^{b}Pre-exponential factors are approximated values because the number of events was ignored.

### Example 2—Tuning Hydrocarbon Chain Length from Thermolysis of Polyolefins and the Subsequent Upcycling to Functional Molecules

### Abstract

The global plastic production and consumption has escalated the plastic waste pollution, since the mid 1950s. As a result, it has become imperative to devise practical strategies for plastic waste management to mitigate embedded ecological challenges. Herein, Applicants report a method for controlling the thermolysis products' molar mass and molar mass distribution of polyolefins, using a coolant fluid's (e.g., water) temperature. Following this strategy, the thermolysis of polyethylene (PE) and polypropylene (PP) at ≤400° C. was judiciously tailored to generate oil with hydrocarbon length in the range of C7-25, without any catalysts or additives. Notably, the oil from both PE,PP and their mixture featured at least twice higher concentrations of synthetically useful α-alkenyl groups than in wax. In a subsequent step, the addition of sulfuric acid across the alkenyl groups in the oil, followed by the neutralization with potassium hydroxide afforded sulfate detergents with excellent foaming behavior even at room temperature. Ultimately, the fast, catalyst and hydrogen-free thermolysis and upcycling of polyolefins presents a scalable and profitable technology to produce value-added chemicals (e.g., detergents) and contribute to addressing the plastic waste problem.

### Introduction

Numerous strategies are explored, including zeolite-assisted pyrolysis,^{[7]} photochemical hydrocracking,^{[11]} and cross-alkane metathesis^{[2]}. For instance, Kassargy et al. investigated USY zeolite for PE pyrolysis at 450° C. and found that USY zeolite featuring acidic sites substantially improved the oil fraction from 0 to 71 wt. %.^{[7]} Cross alkane metathesis (CAM) is a powerful polyolefin deconstruction strategy that involves dehydrogenation, alkene metathesis, and rehydrogenation.^{[13-14]} Jia et al. exploited the CAM strategy and evaluated the influence of iridium catalyst ligands on the HPD from PE degradation.^{[5]} Iridium catalyst featuring bis(phosphinite) ligands afforded a high oil yield after a 72-h reaction thanks to the enhanced selectivity towards internal alkene intermediates. Ru/TiO₂-catalyzed photochemical hydrocracking of PE under varying hydrogen pressures, produced wax and liquid oil in various proportions. Notably, the HPD shifted to low carbon numbers at a high hydrogen pressure of 40 bar, resulting in a high oil-to-wax ratio due to extensive polymer hydrogenolysis.^{[11]} Sadow and coworkers designed a heterogenous catalyst for processive PE hydrocracking, featuring Pt nanoparticles loaded at the bases of mesoporous SiO₂ (mSiO₂).^{[16]} In contrast to solid Pt/SiO₂-mediated hydrocracking, the mesopores in mSiO₂ produced a narrower HPD and lower carbon number products. Generally, the above methods rely on costly complex catalysts, high hydrogen pressures, and sometimes long reaction times to attain high oil yields. Therefore, viable catalyst/hydrogen-free approaches to regulate the oil-to-wax ratio in polyolefin thermolysis are highly demanded.

Long-chain hydrogensulfate detergents are ubiquitous in industry and household applications as cleaning supplies and emulsifiers, owing to their excellent amphipathic properties. Customary, sulfate detergents are manufactured from fats, oils, and petrochemical-derived products.^{[17]} As such, the utilization of these feedstocks can infringe upon global food resources and contribute to the depletion of fossil fuels.^{[13-21]} Therefore, it is crucial to develop alternate routes to procure synthetic detergents in a sustainable manner.

Recently, Applicants reported a facile method of using temperature-gradient thermolysis to convert PE and PP into intermediate waxes, followed by catalytic oxidation to generate fatty acids.^{[22]} To further improve the product selectivity, herein Applicants aim to modulate the PE and PP thermolysis product molar mass and distribution. Employing water as a coolant to control the temperature gradient, Applicants achieved tunable selectivity with controlled proportions of the solid wax to liquid oil. Furthermore, Applicants upcycled the intermediate alkene-rich pyrolysis oil, which has a relatively low market value, to sulfate detergents through sulfuric acid treatment followed by neutralization. (Insert) The use of cooling fluids to modulate temperature gradient and control thermolysis product distributions demonstrates the versatility, effectiveness, and practicality of the temperature-gradient thermolysis to access detergent-relevant precursors from low-cost plastic waste resources.

### Results and Discussion

To enable degrading and upcycling of PE and PP into hydrocarbons of tunable chain length, the key is to control the thermolysis product distribution. In temperature-gradient thermolysis, the gradient is controlled by setting the reactor bottom at a high temperature of T1 and the reactor top at a lower temperature of T2. T1 is sufficiently high to induce polymer chain scission, and T2 is low enough to quench the chain scission reactions and condense the product. To control the product chain length (or molar mass, used interchangeably in this context) and chain length distribution, Applicants hypothesize that Applicants can simply tune T2 in the quenching/condensation zone. In Applicants' previous report,^{[22]} constant cold water circulation in the reactor played a critical role in ensuring that the thermolysis did not predominantly produce gaseous products. This observation led to exploring the temperature of a coolant (e.g., water) as a parameter to modulate the carbon number range of degradation products and increase the thermolysis oil fraction.

### Polyethylene

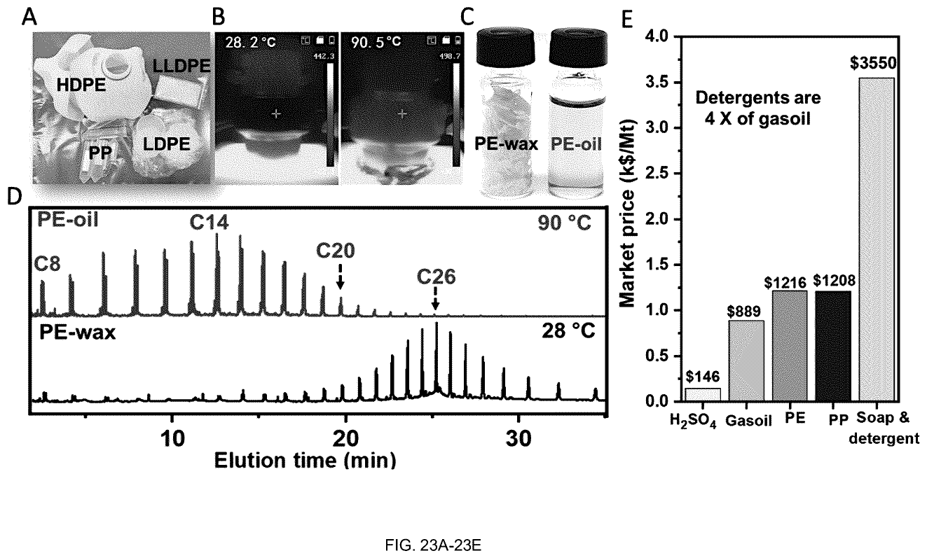

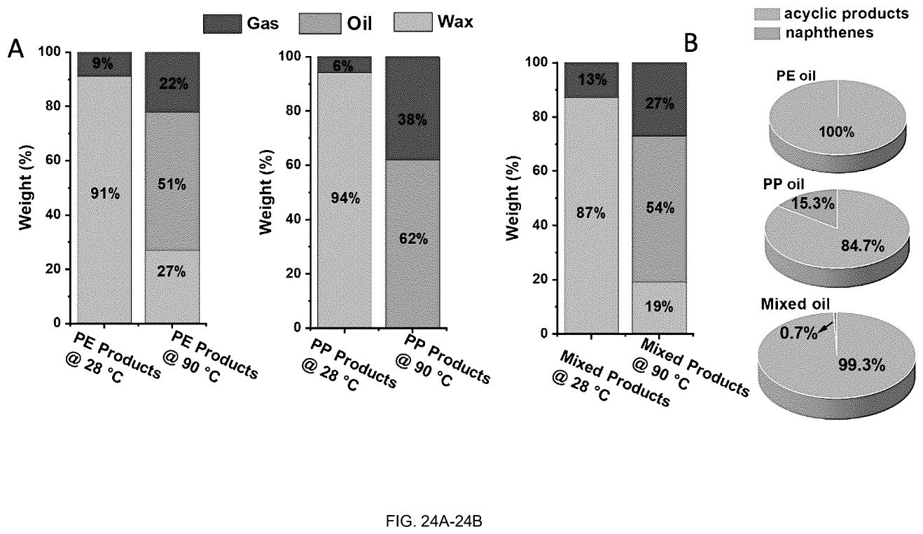

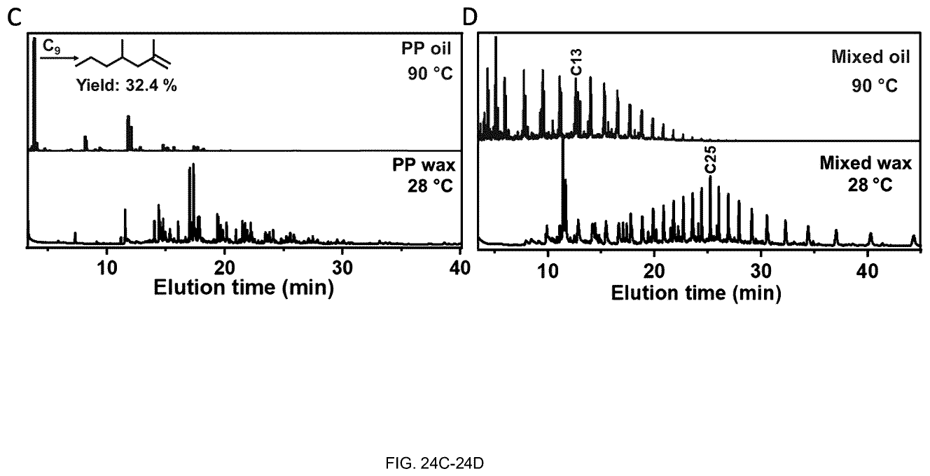

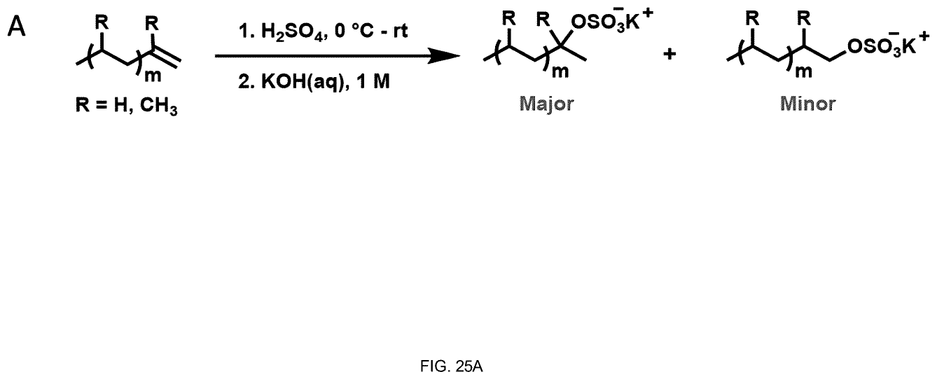

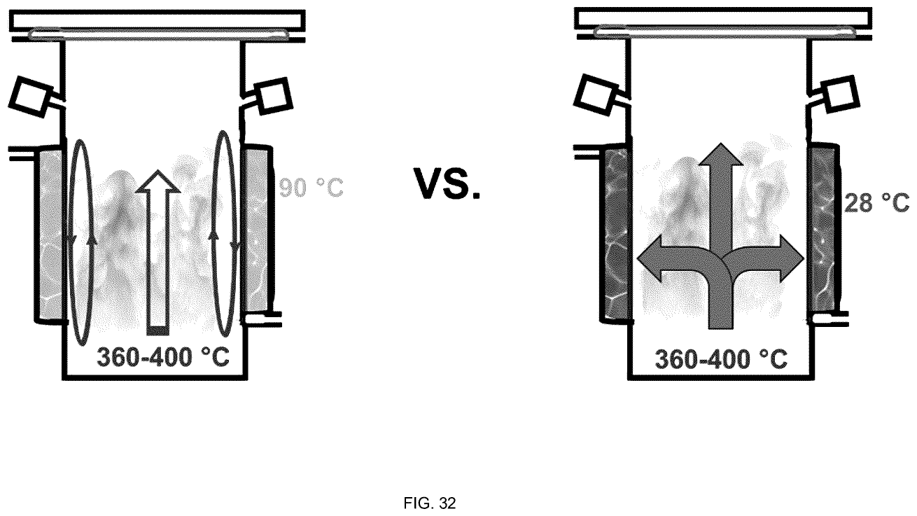

To prove the concept, HDPE (M_{w}, 88.38 kDa) was first subjected to a thermolysis condition of T1=360-400° C. and T2=28° C. by flowing room-temperature water in the reactor jacket (FIG. 23B left). This degradation reaction afforded 91 wt. % wax in the condensation zone consisting of both saturated and unsaturated hydrocarbons (FIG. 24A, left). Gas chromatogram (GC) of the wax in hot hexanes revealed a unimodal distribution centered at ~25.5 min, equivalent to C26 (FIG. 23D black curve). In contrast, flowing hot water through the reactor jacket, established a T2~90° C. in the cold trap zone (FIG. 23B right). The high T2 resulted in a different temperature gradient, which furnished 51 wt. % of oil in the reactor head space (FIG. 24A, PE products at 90° C.). Under the higher-T2 reaction condition, the components of the oil shifted to lower GC elution times, giving hydrocarbons centered at C14 (FIG. 23D red curve). Further characterization of the thermolysis oil by GC-MS revealed largely linear alkanes and alkenes along with minor dienes in the range of C7 to C26. No cyclic or branched products were detected, suggesting negligible intramolecular and intermolecular radical recombinations under the rection conditions.^{[23]} Besides the oil, wax (27 wt. %) accumulated near the reactor bottom after a 6-h reaction. As confirmed by GC, the residual wax under T2=90° C. and the wax collected at T2=28° C. revealed similar compositions, featuring both alkene and alkane components. In addition to oil and wax, the thermolysis of the PE produced ~22 wt. % of gaseous products consisting of mainly propane, E-2-butene, and pentane (FIG. 31). Presumably, the 90-° C. cold trap allowed the liquefaction of the vaporized hydrocarbons which flowed back to the reactor bottom, creating a reflux-like phenomenon (FIG. 32). Thus, the observed change in the oil-to-wax selectivity can be ascribed to the more sustained chain cleavage and degradations as a result of a longer residence time at T1=360-400° C. In contrast, the 28-° C. cold trap was not hot enough to cause the melting of condensed products to sustain the hydrocarbons “reflux”. Thus, the vaporized products were quenched and solidified on the walls of the cold trap. The two examples of controlled temperatures at ~28° C. and 90° C. demonstrates the capability of leveraging the coolant temperature T2 to achieve tunable hydrocarbon chain lengths.

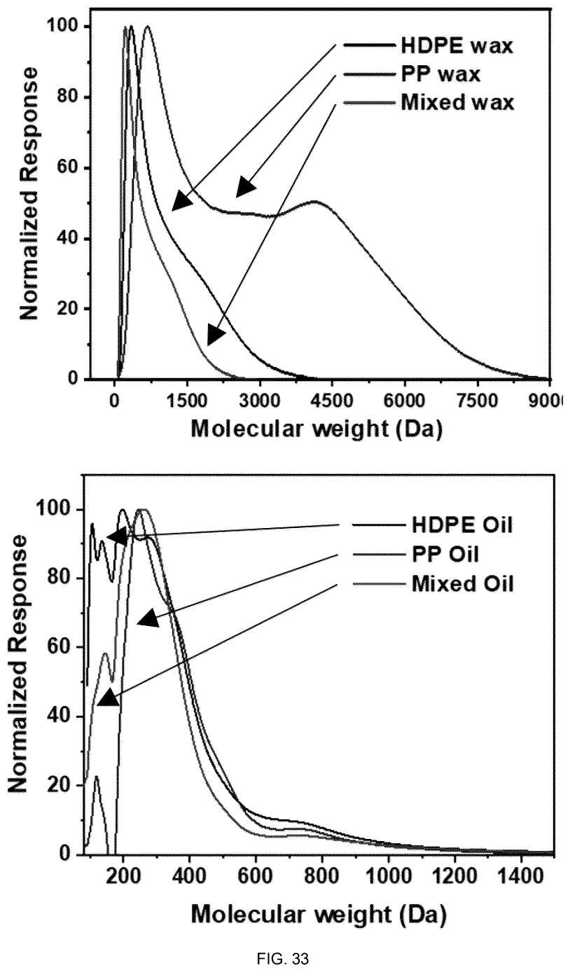

Further spectroscopic analysis of HDPE-derived hydrocarbons revealed a high amount of α-olefins useful for downstream derivatization. The thermolysis at T2=90° C. demonstrated a high selectivity toward α-olefins in the oil (90.1 mol % of α-olefins and 9.9 mol % internal olefins) compared to that in the wax (78.7 mol % of α-olefins and 21.3 mol % internal olefins) (Table 10). The high selectivity toward terminal alkenes in the oil is likely caused by extensive β-scission, which shortens the product chain length and statistically promotes terminal alkene formation. This conjecture is supported by GPC and HT-GPC data, which showed a number average molar mass of ~180 g/mol for the oil versus 380 g/mol for the wax (FIG. 33 and Table 11). Notably, the synthetically useful α-olefins in the thermolysis oil consisted of mostly diesel range hydrocarbon, opening up an opportunity for alternative fuel applications. On the contrary, the thermolysis at T2=28° C. resulted in a lower α-olefin yield probably due the less β-scission events caused by a relatively shorter residence time at the reactor bottom (Table 10).

### Polypropylene and Mixed Plastics

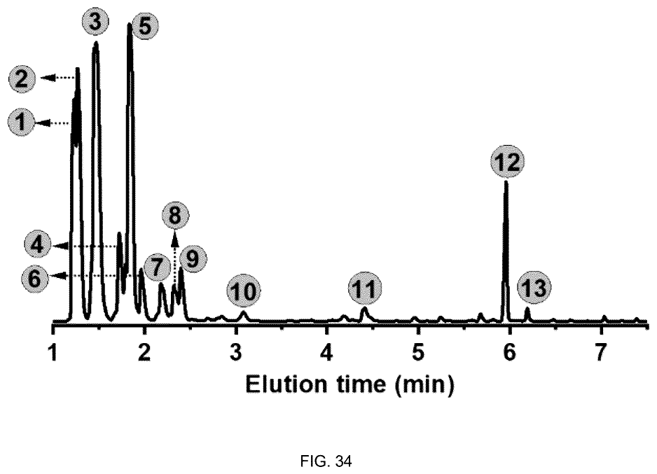

Pulverized PP was loaded into the reactor and subjected to thermolysis under two different heating gradients. Similar to HDPE, wax was the main product when T2=28° C. (FIG. 24A, middle). By increasing T2 to 90° C., thermolysis oil emerged as the main product with a yield of 62%, similar to previous studies^{[24]} at comparable temperatures (FIG. 24A, middle “PP products at 90° C.”) The degradation generated a 32.4 mole % yield of 2,4-dimethyl-1-heptene in the oil fraction (FIG. 24C), a trimer fragment (C₉) that was reported in previous PP pyrolysis studies.^{[25-26]} Up to 38 wt. % of the polymer was converted into gaseous products, likely due to the easily degradable branched tertiary C—C structure of PP. The gas phase was primarily composed of acyclic compounds, including E-2-butene, pentane, and 2-methyl-1-pentene (FIG. 34); cyclopropane was the only gaseous cycloparaffin detected in the GC-MS. In the end, no wax was collected from the reactor after full PP degradation in 2 h. GC confirmed a narrower product distribution in the oil, mostly s C20 light hydrocarbons (FIG. 24C). Additionally, GPC and HT-GPC results validated the overall decrease in product molar mass upon elevating T2, showing an average molar mass of ~570 g/mol for the wax and ~250 g/mol for the oil (FIG. 33). Altogether, these results uphold the practicality of varying temperature gradient in regulating the extent of chain scission in polyolefin thermolysis.

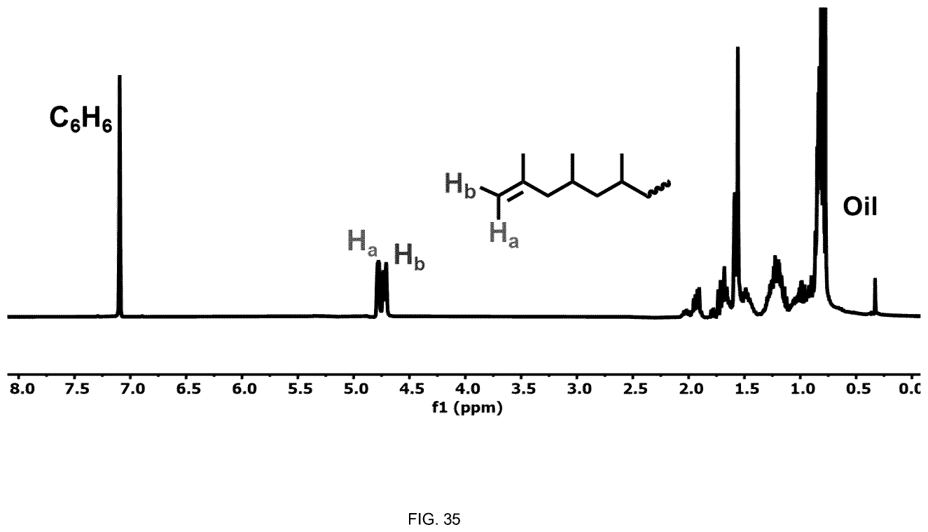

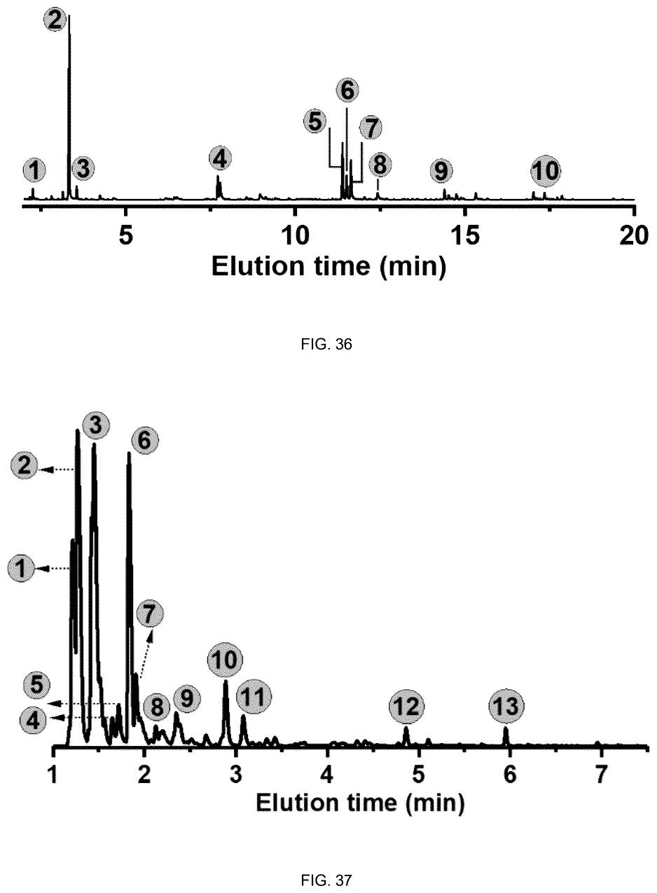

Similar to PE thermolysis, the alkenyl concentration (C_{C=C}) of PP-oil was substantially higher than that of the wax produced under the condition of T2=28° C. (7.08 mmol/g for PP-oil-90° C. vs. 4.61 mmol/g for PP-wax-28° C., Table 10). The higher C_{C═C} in PP-oil than in PE stems from the thermodynamic stability of carbon-centered radical intermediates owing to the methyl substitution at every second carbon.^{[27]} Therefore, the varied heating gradient serves the dual purpose of improving the concentration of alkenes groups, in addition to modulating the molar mass of thermolysis products. Interestingly, most alkenes in PP-oil were acyclic α-olefins. ¹H NMR showed no signals in the typical range of internal alkene (beyond 5.0 ppm, FIG. 35). Furthermore, GC-MS substantiated the predominance of α-olefins, as the most intense peaks in chromatogram corresponded to 2,4-dimethyl-1-heptene (1), 2,4-dimethyl-1-decene (5), and 4, 6, 8-trimethyl-1-nonene (7) (FIG. 36). Contrasting with PE-derived oil, minor cyclic products, including 1, 3, 5-trimethylcyclohexane, were detected in the PP thermolysis oil, indicating some intramolecular radical recombination (FIGS. 36 and 24B middle). Nonetheless, acyclic alkenes and alkanes comprised the majority of PP thermolysis oil.

Real-world plastic waste is a complex mixture of many polymers. To test the capability of converting plastic mixtures into value-added products, Applicants performed the thermolysis of PE together varying amounts of PP. PE/PP mixtures are interesting choices because these two polyolefins are hard to separate from each other due to comparable densities and chemical composition.^{[28]} A mixture of 25 wt. % HDPE (milk jug), 25 wt. % LDPE (specimen container lid), 25 wt. % LLDPE (commercial grade), and 25 wt. % PP (laboratory centrifuge tube) was exposed to the two thermolysis conditions. A high wax yield of 87 wt. % was obtained under the reaction condition of T2=28° C., whereas the reaction condition of T2=90° C. afforded 54 wt. % yield of oil as the major product (FIG. 24A right). The gas phase under T2=90° C. accounted for ~27 wt. % of the products and was comprised of light alkenes, including propene and E-2-butene along with minor ≥C5 alkanes (FIG. 37). As established in the case of single polymer thermolysis, there was an overall shift of the products distribution to the low molar mass regime upon increasing the temperature of the condensation zone (FIG. 24D). This observation is further supported by GPC and HT-GPC data which revealed a higher Mₙ (~244 g/mol) for the plastic mixture-derived wax than ~200 g/mol for the oil (FIG. 33).

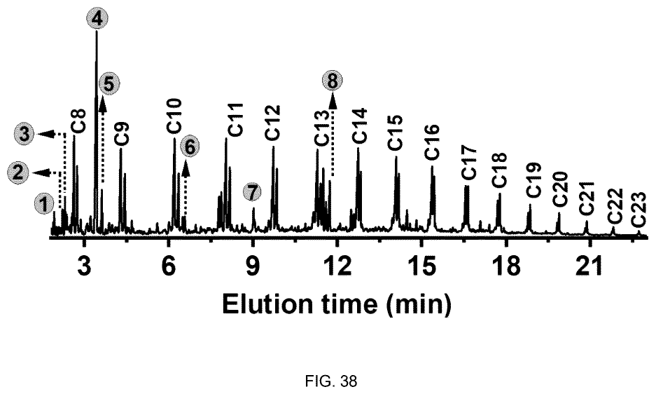

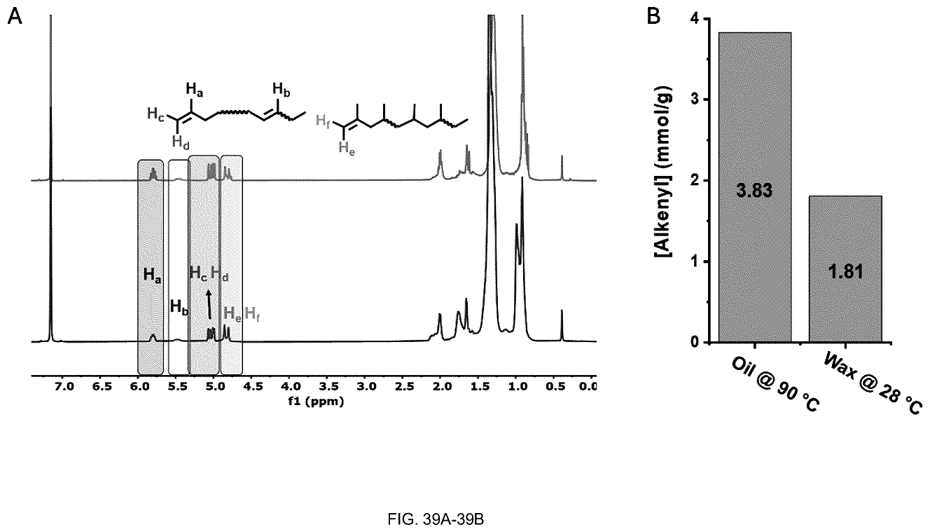

Structural analysis showed a combination of products characteristic of PE and PP thermolysis. In addition to linear alkanes, alkenes, and dienes from the thermolysis of PE component, methyl-substituted acyclic alkane and terminal alkenes were detected by GC-MS, in consistence with PP fragmentation compounds (FIG. 38, products 2, 3, 4, 6, 7, and 8). Moreover, the presence of PP led to the generation of a small amount of cycloparaffins in the oil phase, such as 1, 3, 5-trimethylcyclohexane (5) (FIG. 38). The mixed plastic waste exhibited higher selectivity for α-olefins in the oil fraction (93.4%) than pure HDPE oil, probably because the introduction of PP featured exceptional selectivity for terminal olefins (Table 10). On the other hand, the thermolysis of the same mixture feedstock under the condition of T2=28° C. furnished 84.4% α-olefins in the wax (¹H-NMR FIG. 39A). As aforementioned, the disparity in the selectivity towards α-olefins by the two thermolysis conditions is attributed to the differences in the degree of chain scissions that produce alkene-rich hydrocarbons.

### Upcycling to Sulfate Detergents

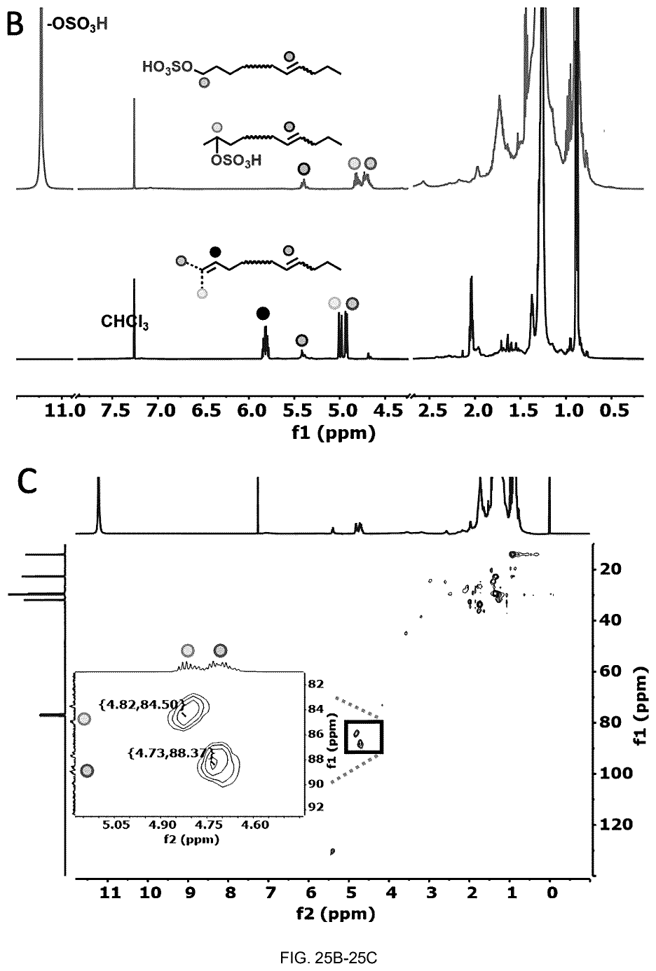

PE- and PP-oil can undergo further functionalization to produce fatty acids, alcohols, and sulfonic acids, and their corresponding salts. In the current study, Applicants targeted soap and detergent products given their high demand and market values (FIG. 23E). As a proof of concept for plastic waste valorization, PE and PP thermolysis oils were converted to ionic detergents in two steps. First, chilled oils in a cold bath were reacted with concentrated sulfuric acid to produce alkyl hydrogen sulfates. The hydrogen sulfates were then neutralized with aqueous potassium hydroxide (KOH, 1 M) to generate ionic detergents (FIG. 25A). The addition H₂SO₄ to PE-oil converted all α-alkenyls to alkyl hydrogen sulfates as evidenced by the disappearance of the alkene peaks at 4.90-5.04 ppm and 5.82 ppm in the ¹H NMR (FIG. 25B). The two new resonance peaks at 4.71 and 4.82 ppm-attributed to the Markovnikov and anti-Markovnikov products, respectively-were correlated to carbon signals between 84.50 and 88.37 in the 2D ¹H-¹³C HSQC NMR (FIG. 25C). Contrary to α-alkenyl groups, the minor internal alkenes (9.9 mol % in PE oil) were unaffected by the sulfation reaction, probably due to the mild rection condition employed. However, since olefin groups are present in many surfactant compounds and beneficial for lathering and moisturizing properties,^{[29]} Applicants did not pursue further sulfation of residual alkene groups. The sulfation reaction effectively transformed both PP- and PE/PP-oil into the corresponding alkyl hydrogen sulfates (figure SX, SY). However, the unreacted internal alkene groups (6.6 mol % in the mixed oil) carried through from the thermolysis were detected in both 1D NMR and HSQC. Eventually, the alkyl hydrogen sulfates were neutralized and basified with KOH until pH reached ~9 before further characterization.

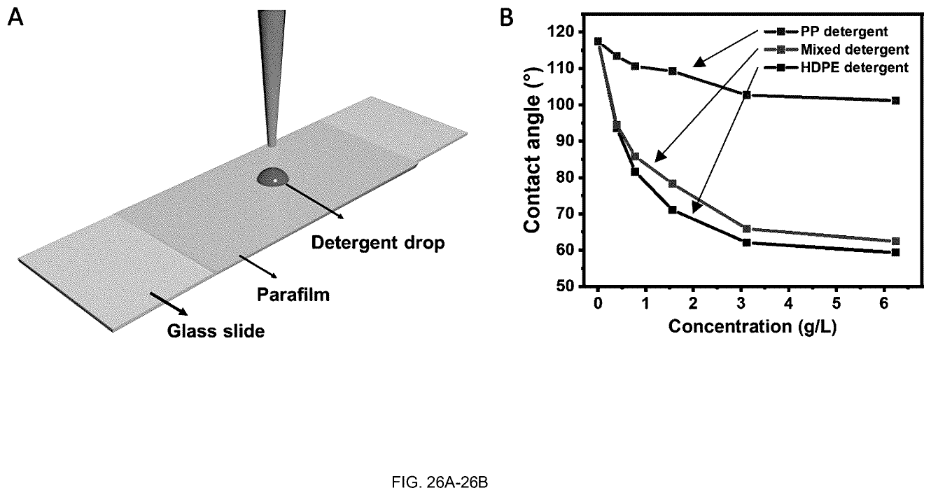

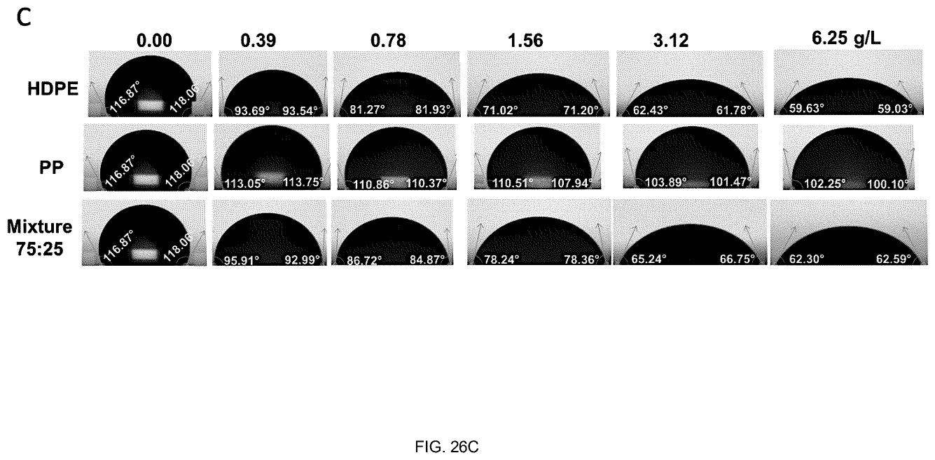

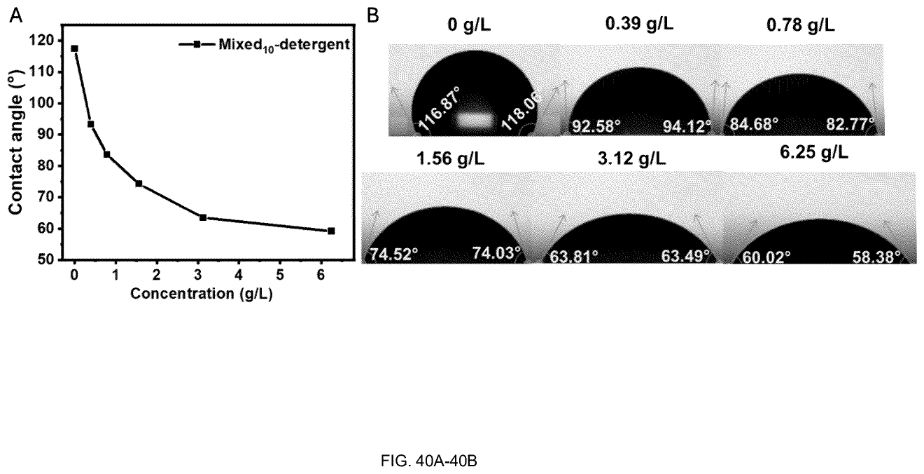

Detergent properties were investigated using various instrumentation and techniques. The wettability of soap and detergents determines how well their solutions spread across the surface of a substrate. To determine the wettability, Applicants measured the contact angles of a series of detergent concentrations ranging from 0 to 6.25 g/L on a hydrophobic surface. The hydrophobic surface was created by wrapping a strip of parafilm around a glass slide (FIG. 26A). For all PE-, PP-, and PE/PP-detergent, the contact angle decreased with increasing detergent concentration (FIG. 26B). PE detergents showed superior wettability compared to both the mixed and PP counterparts (FIG. 26C). The improved wettability is attributed to the favorable interactions between the detergents' alkyl chains and the hydrophobic parafilm chains at the interface. Conversely, The incorporation of methyl-substituted chains in PP-oil, mostly short-chain 2,4-dimethyl-1-heptene, hindered the same interchain interactions likely because of the poor chain flexibility.^{[30]} Thus, the introduction of PP-derived molecules in the mixed detergent formulations slightly worsened the wetting properties (FIG. 26B, red curve). Nevertheless, adequate wettability was maintained at low PP weight loadings of up to 10 wt. % (FIG. 40).

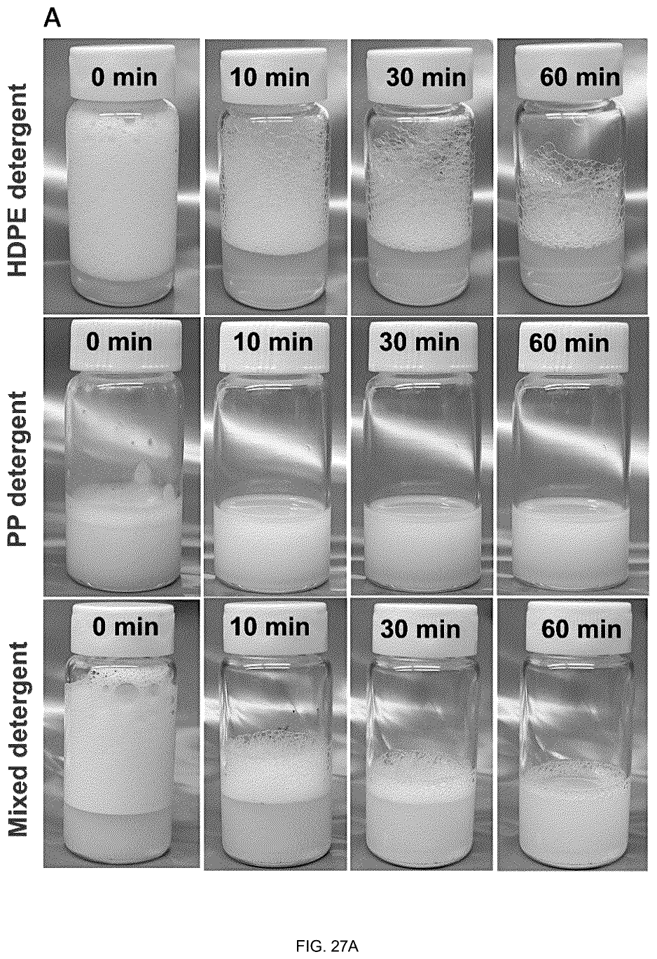

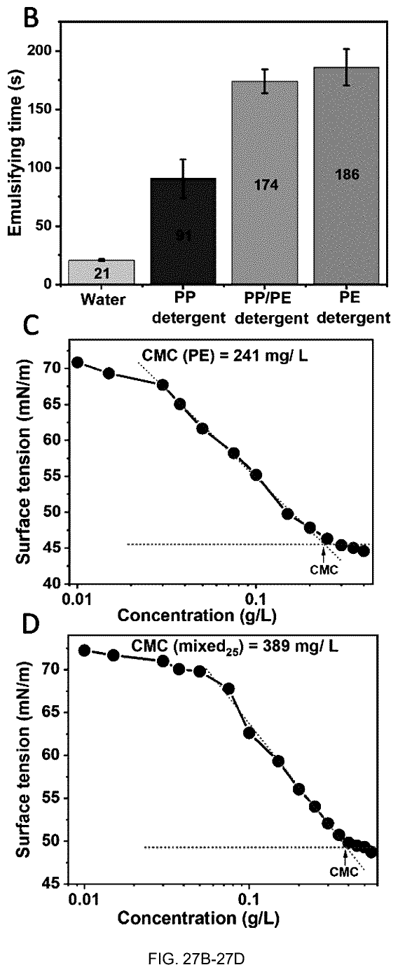

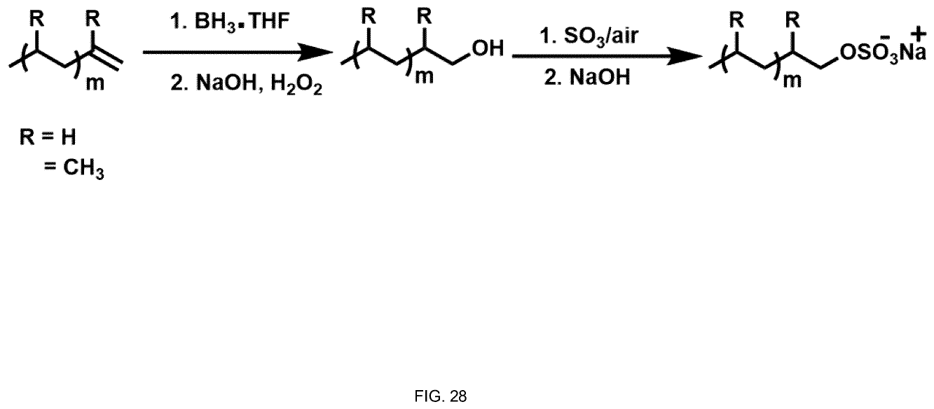

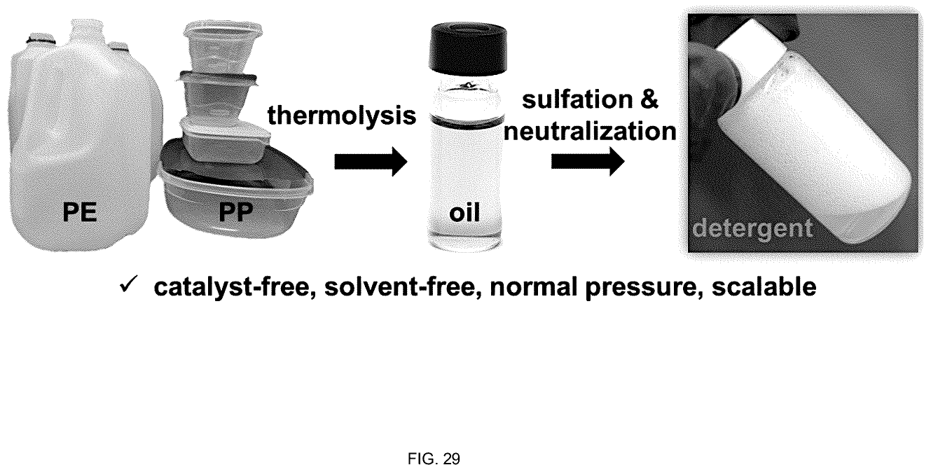

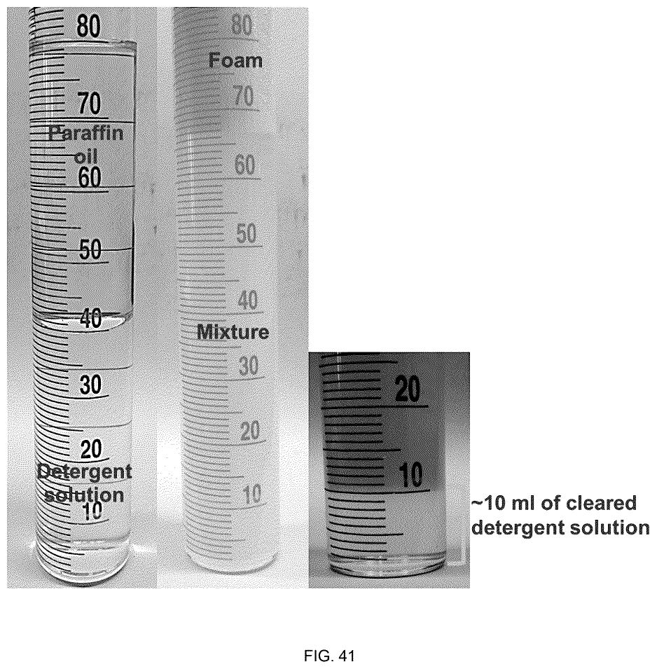

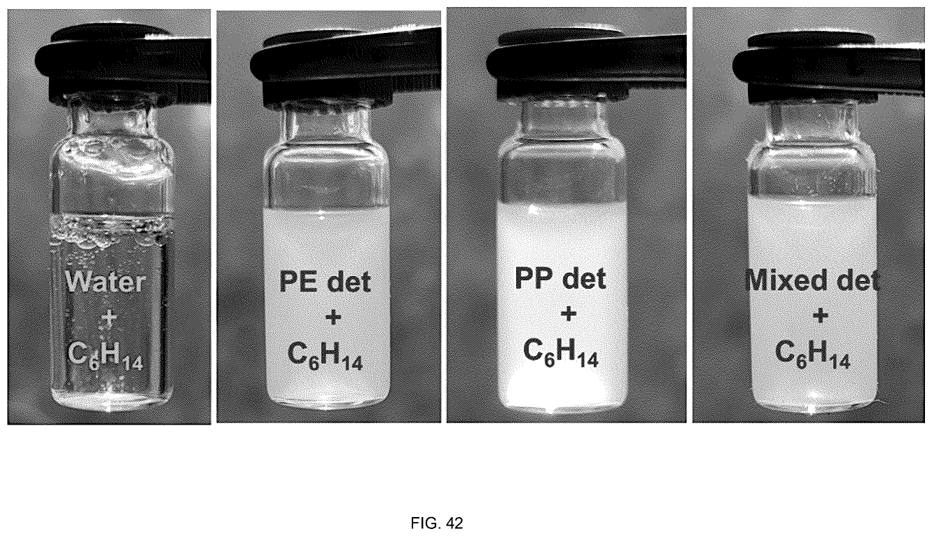

PE- and PE/PP-derived ionic detergents displayed excellent foaming behavior and emulsifying capacity at room temperature. PE-detergent exhibited a well sustained foamy lather over a period of 1 h (FIG. 27A, 1st row). In contrast, PP-containing detergents could not sustain the formation of a stable foamy lather (FIG. 27A, 2^{nd} and 3^{rd} row), presumably because of the defoaming characteristic of branched chains^{[31]} Nonetheless, the low-foam feature of PP-detergent can be exploited to formulate PE/PP mixed surfactants presenting excellent wettability and defoaming performance for industrial applications.^{[32]} Furthermore, an effective detergent should have affinity for both water and organic substances, to achieve amphiphilic (i.e., hydrophilic and lipophilic) properties. To determine the emulsifying capacity of the plastic waste-derived detergents, the separation time for 10 mL of water from a paraffin oil-water mixture was recorded (FIG. 41).^{[33]} In the absence of a detergent, the separation was swift and required 21 s to isolate 10 mL of water from the mixture (FIG. 27B). The addition of PP- and PE-detergent with a concentration of 1.25 mg/mL drastically bolstered the emulsifying time to 91 s and 186 s, respectively. Remarkably, PE/PP-detergent also demonstrated great emulsification performance comparable to pure PE-detergent, illustrating the feasibility of turning unsorted mixed polyolefin wastes into sustainable emulsifiers. Besides paraffin oil, the detergent solutions (1.2 mL) mixed well with 50 μL of hexane, which further corroborates their excellent emulsification properties (FIG. 42).

To study the detergents' ability to lower the surface tension (γ) of water, Applicants prepared a series of detergent solutions with varying concentrations and examined γ using a theta flow tensiometer in pendant drop mode. PE-detergent resulted in the highest reduction of γ at the air-water interface, reaching 45.5 mN/m at the critical micellar concentration (γ_{CMC}=45.5 mN/m, CMC=241 mg/L, FIG. 27C). PP-detergent produced minimal change in γ at low detergent concentrations and only underwent micellization at higher concentrations (γ_{CMC}=51.6 mN/m, CMC=518 mg/L, FIG. 43A), as a consequence of poor hydrophobicity and aggregation of short alkyl chains.^{[34]} Due to this reason, the inclusion of 25 wt. % of PP in the PE/PP mixture precursor led to a CMC value of 389 mg/L and γ_{CMC} of 49.3 mN/m for PE/PP-detergent (FIG. 27D), higher than pure PE-detergent. Nonetheless, detergents derived from mixed PE/PP waste containing up to 10 wt. % of PP still exhibited a high reduction in γ (γ_{CMC}=48.4) at a relatively low CMC of 238 mg/L on par with pure PE-detergent (FIG. 43B), which suggests the latter's ability to tolerate “polymer impurities”. Compared to some benchmark detergents, such as sodium dodecyl sulfate (CMC>2 g/L)^{[35]} the CMC of PE and PE/PP mixture-derived detergents is comparatively lower, illustrating their superior performance even at low concentrations.

### Discussion

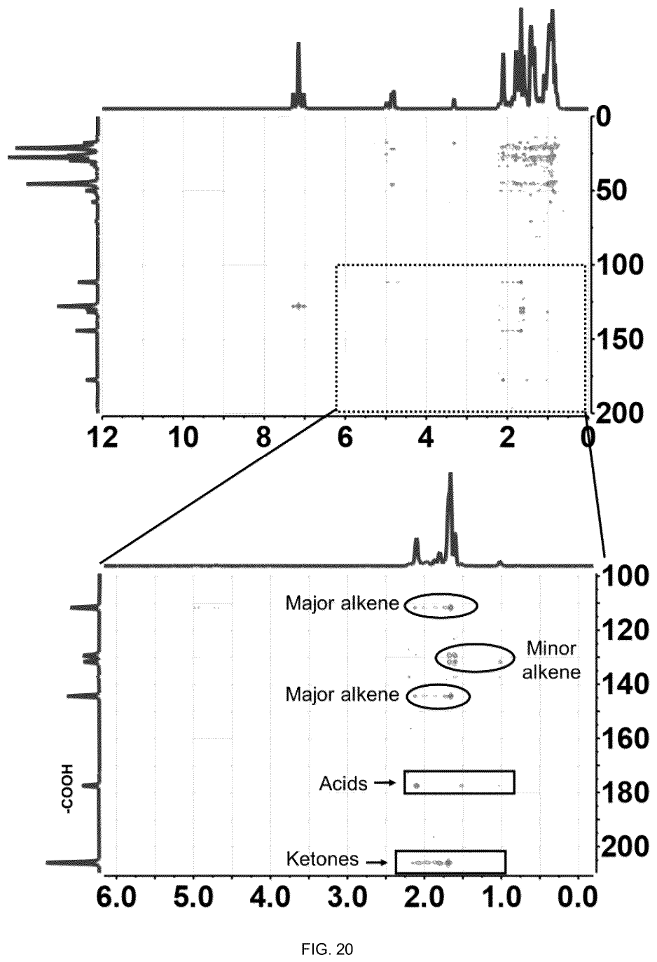

The custom-designed quartz reactor with a cooling zone enables the synthesis of valuable hydrocarbons for various downstream applications (e.g., detergents). The hydrogen and catalyst-free process is practically superior to conventional hydrocracking strategies because the olefinic hydrocarbon intermediates can easily be chemically transformed to high-value products.^{[36-37]} In addition, the saturated side products can undergo oxidation in the presence of inorganic catalysts or microorganisms to form useful value-added chemicals.^{[38-39]} Moreover, the relatively mild thermolysis reaction conditions is key to avoiding the generation of low value char, which has been reported to form at temperatures upwards of 450° C.^{[4]} Applicants anticipate to improve the thermolysis oil yield by utilizing a reactor with a sufficient head space to accumulate the total volume of oils. Besides generating detergents and surfactants, the PE and PP thermolysis oils can be used as diesel fuels once hydrogenated.^{[41]} It is noteworthy that naphthenes observed in the PP-oil are allowed in diesel formulations, and they can make up ~40% of the total composition.^{[42]} Future studies will explore the possibility of targeting terminal alkyl sulfates exclusively in the upcycling reaction. Specifically, the α-olefins in the plastic-derived oils can be converted to primary fatty alcohol through hydroboration, followed by the sulfonation with air/SO₃ mixture (see FIG. 20 for preliminary results on the synthesis of fatty alcohols). Nevertheless, there is a considerable trade-off in that this approach involves more synthetic steps, thus potentially adding costs in large-scale production.

### Outlook

Although single-use plastics have continued to accumulate in the natural environment for the last six decades, concerted efforts are being put into curbing this pollution problem. Among the most promising approaches, the utilization of plastic waste as feedstocks for preparing a variety of useful chemicals and products has shown notable success. The method herein employs this underutilized resource to generate detergents of high value. The modulation of the temperature gradient using a coolant (e.g., water) effectively adjusts the overall molar mass of intermediate hydrocarbon products and enables the final production of thermolysis oils instead of waxes. To further valorize the intermediates, the olefin-rich oil was reacted with sulfuric acid to furnish ionic detergents. Ultimately, this work highlights a viable chemical strategy to obtain indispensable high-value products from plastic waste, while contributing to the goal of achieving a circular economy.

### Experimental

### Materials

Deuterated benzene (C₆D₆, 99.8%, Cambridge Isotope Laboratories, Inc.), sulfuric acid (98.0%; Fisher Scientific), hexanes (≥98.5%; VWR Chemicals), potassium hydroxide (pure pellets; Sigma-Aldrich), were purchased and used without further purification. HDPE (milk jug), LDPE (specimen container lid), and iPP (centrifuge tube) were obtained locally in Blacksburg, VA. And washed, air dried, before pulverization. LLDPE pellets (commercial grade) were used without further purification. All polymers were pulverized into powders in a Homend® pulverizer for 15 min (5 minutes, 3×) before thermolysis.

### Instrumentation

GC-FID. GC analysis was carried out on a 5890 Series II Gas Chromatograph equipped with a DB-5 capillary column (30 m×0.25 mm×0.25 μm) and a flame ionization detector (FID). The following conditions were applied: helium column flow rate, 11 ml/min; injection port temperature, 280° C.; detector temperature, 280° C.; initial column temperature, 50° C.; ramp rate, 10° C./min; final column temperature, 280° C.

GC-MS. All GC-MS analyses were performed using a 6890 coupled to a 5973 MSD from Agilent (Wilmington, DE). Separations were obtained using a DB-5 column (30 m, 250 μm I.D., with a film thickness of 0.25 μm). The following operating conditions were used for the analyses:
Injection Port Temp.: 280° C.
Split Valve: 1/25
Purge Flow: 3 mL/min
Constant Flow: 1 mL/min
Injection Volume: 1 μL
Column Oven Initial Temp.: 50° C.
Column Initial Time: 3 min
Column Oven Ramp Rate: 10° C./min
Column Oven Final Time: 280° C.
Mass Spec. Transfer Line Temp.: 250° C.
Mass Spec. Database: Wiley
MS Scan Mod Range: 10-800

HT-GPC. HT-GPC was performed using a Tosoh EcoSec HLC-8321 High Temperature GPC System at 160° C. (for polymers and 50° C. for waxes) with a sample flow rate of 1.0 mL/min and a reference flow rate of 0.5 mL/min, equipped with a refractive index (RI) detector. The mobile phase was 1,2,4-trichlorobenzene (TCB, Fischer Scientific-HPLC Grade). Polymer separation was performed using 4 Tosoh TSKgel columns attached in the following order, 1×TSKgel guard column HHR (30) HT2 7.5 mm I.D.×7.5 cm. (PN 22891), 2×TSKgel G2000 HHR (20) HT2 7.8 mm I.D.×30 cm columns (PN 22890), and 1×TSKgel GMH HR—H (S) HT2 7.8 mm I.D.×30 cm column (PN 22889).

Lignin-GPC. 15-20 mg of sample were dissolved in THF to achieve a concentration of ~2 mg/mL and stirred for 30 minutes. The THF solution was filtered through a 0.2 μm syringe filter into an HPLC vial. 20 μL of sample was injected on an HPLC fitted with three PLgel 7.5×300 mm columns in series: 10 μm×50 Å, 10 μm×103 Å, 10 μm×104 Å (Agilent Technologies, Stockport, UK) at ambient temperature with an isocratic 1 mL min-1 100% tetrahydrofuran (Sigma-Aldrich inhibitor-free, suitable for HPLC 99.9%) for 40 minutes. Analytes are monitored at 210 nm, 260 nm, and 270 nm on the diode-array detection.

NMR. All ¹H NMR experiments were performed at 298 K on a 500 MHz Bruker Avance II 500 spectrometer with 16 scans. All spectra were recorded using deuterated benzene and chloroform. ¹³CNMR experiments of oils were conducted at 298 K on a 500 MHz Bruker Avance II 500 spectrometer using a 2 s relaxation delay and 1024 scans. ¹³C NMR experiments for alkyl hydrogensulfates were performed using a 6 s relaxation delay and 3072 scans. 2D-HSQC were conducted at 298 K on a 500 MHz Bruker Avance Ill 500 spectrometer with a relaxation time of 2 s, 16 scans, and a digitizing increment of 400.

Theta flow tensiometer. Contact angle and surface tension measurements were conducted at room temperature on a Biolin Scientific theta flow tensiometer. Contact angle experiments were performed in a sessile drop mode with a drop volume of ~5 μL, a drop rate of 1 μL/s, and a run time of ~10 s. Surface tension measurements were evaluated in a pendant drop mode with a drop volume of ~10 μL, a drop rate of 1 μL/s, and a run time of ~10 s.

### Thermolysis Procedures

Typically, 1.5 g of pulverized HDPE (particle size, 2.7 mm) or PP (particle size, 1.6 mm) were loaded into a custom-designed quartz reactor and purged with nitrogen at 200° C. for 15 min. After purging, the temperature was slowly ramped (rate, 20° C./min) to the operational temperature range (bottom of reactor was ~400° C., and the top layer of the plastic melt was ~360° C.). At the same time, room temperature water or heated water were circulated in the reactor outer jacket. After 10 min, the cold zone temperature stabilized at ~28° C. and ~90° C., respectively. The thermolysis lasted for 6 h for HDPE and 2 h for PP. After completion, the thermolysis oil in the headspace was collected using a glass pipette and weighed on an analytical balance. Solid wax was extracted from the reactor with hexanes twice (10 ml each), dried under vacuo, and weighed to determine the yield.

To upcycle PE- and PP-oil to sulfate detergents, 100 mg of each oil was weighed and transferred to a flame-dried 25-ml vial fitted with a stir bar. The test tube was set in a cold bath at 0° C., and 50 mg of concentrated sulfuric acid were added dropwise while stirring. After 10 min, the vial and its contents were stirred at room temperature for 10 min and neutralized with 1 M KOH solution (1.2 ml) to afford the ionic detergents. The detergents solutions were diluted to 8 ml of DI water. The unconverted alkane component was isolated by washing the crude solution with 15 ml of hexanes (5 ml, 3×). The combined hexane extracts were dried over Na₂SO₄, concentrated under vacuo, and weighed before taking a small sample out for GC and GC-MS characterization. To remove residual hexanes in the purified detergent solution, a moderate vacuum of 300 mmHg was applied to the detergent vial at 45° C.

### Supplementary Information

### Supplementary Discussion

The global detergent market size is currently over USD 120 billion annually and their demand is expected to continue to grow over the next decades.^{[1]} In addition to animal fats and oleochemicals, a large percentage of detergents are prepared from petrochemicals (up to 44%)^{[2]} Consequently, several environmental and ecological damages have been associated with surfactant and detergent manufacturing. Those include deforestation and the rising global greenhouse gas emissions due to the consumption of large volumes of petrochemicals in production operations.^{[3-4]} As a result, industries have been encouraged to integrate renewable resources and raw materials in their processes in order to reduce their carbon footprint. In the recent years, alternative detergents have been produced from sustainable resources. However, to substantially improve sustainability in the detergent and soap industry, new scalable processes relying on widely available and inexpensive feedstocks are desperately needed.

The approach presented herein utilizes real-world plastic waste to generate ionic detergents in 6 hours or less without using any catalysts or solvent. Specifically, PE and PP plastics of M, ranging from 35.3 to 146.7 kDa (Table 3) are first deconstructed and converted into saturated and unsaturated oil. Importantly, the coolant's temperature is key to controlling the ratio of oil versus wax produced. It is notable that water at temperatures between 28° C. and 90° C. can effectively modulate the aforementioned ratio, eliminating the need to procure expensive coolant fluids. Therefore, unlike other batch reactors utilized in pyrolytic technologies, the design where the condenser is not separated from the reactor enables control over the product molar mass.

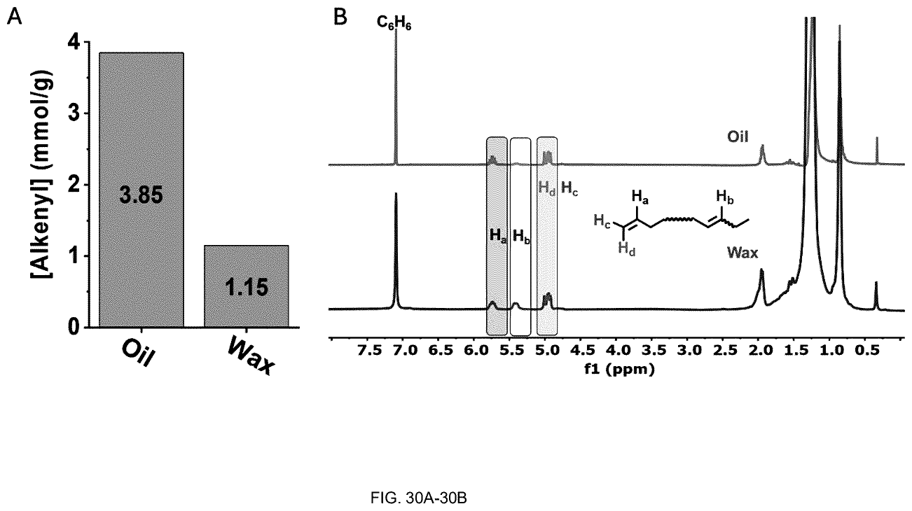

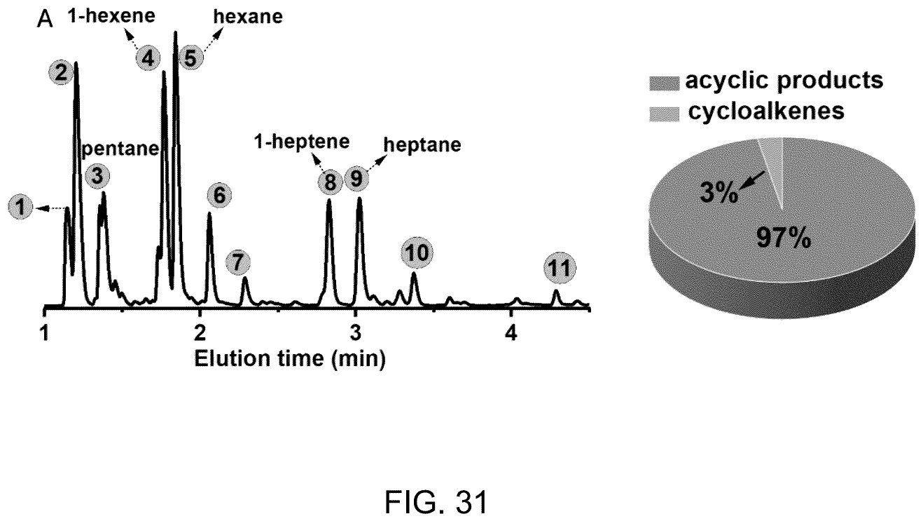

The concentration of alkenyl groups in both the oil and wax was evaluated through ¹H NMR experiments in C₆D₆ containing a known amount of residual C₆H₆(FIGS. 30, 35, and 39). By setting the C₆H₆ signal as the internal standard, the alkenyl concentration (c_{./.}) was determined based on the equation:

$${c}_{C = C} = \frac{{m}_{solvent} f}{{M}_{solvent}} \times \frac{{n}_{ref - H}}{{n}_{ene - H}} \times r \times \frac{1}{m}$$

where mₛₒₗᵥₑₙₜ is the mass of the solvent; Mₛₒₗᵥₑₙₜ is the molar mass of the C₆D₆; f is the mass fraction of regular benzene in deuterated benzene; n_{ref-H} is the number of hydrogen on a solvent molecule (n_{ref-H}=6); r is the NMR integration ratio of alkenyl over C₆H₆; n_{ene-H} is the number of hydrogen on an alkenyl group (n_{ene-H}=3 for terminal alkenes); and m is the mass of the sample. In all cases, the oil from thermolyzed plastics exhibited a higher concentration of alkene groups in comparison to the wax. Applicants speculate that the difference in C_{C═C} is attributable to the variation in the extent of chain scission incurred by the polymers under the two thermolysis conditions. Put in another way, the vaporized hydrocarbons during thermolysis condense and then melt as they reach the condensation zone at T2=90° C. (PE wax melting point=68.8-80.1° C.). Eventually, the melted products return to the bottom of the reactor at T1=360-400° C. where the chain cleavage process continues.

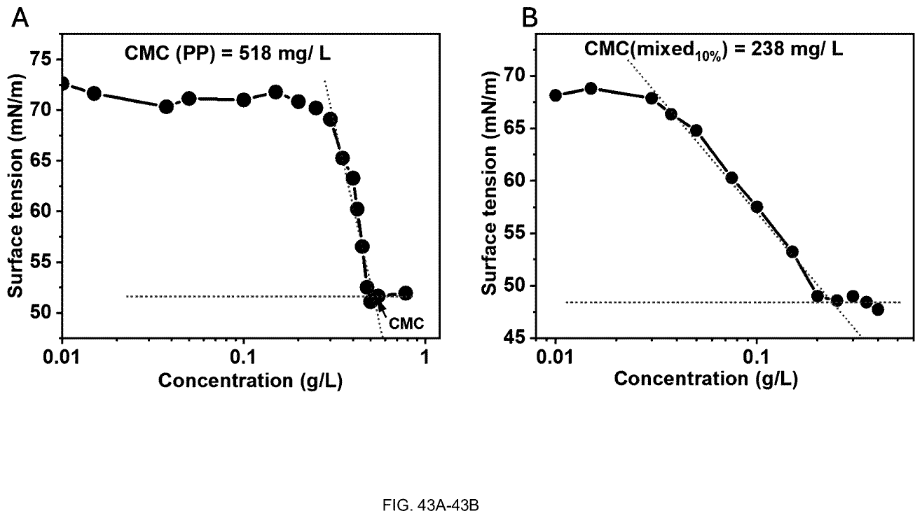

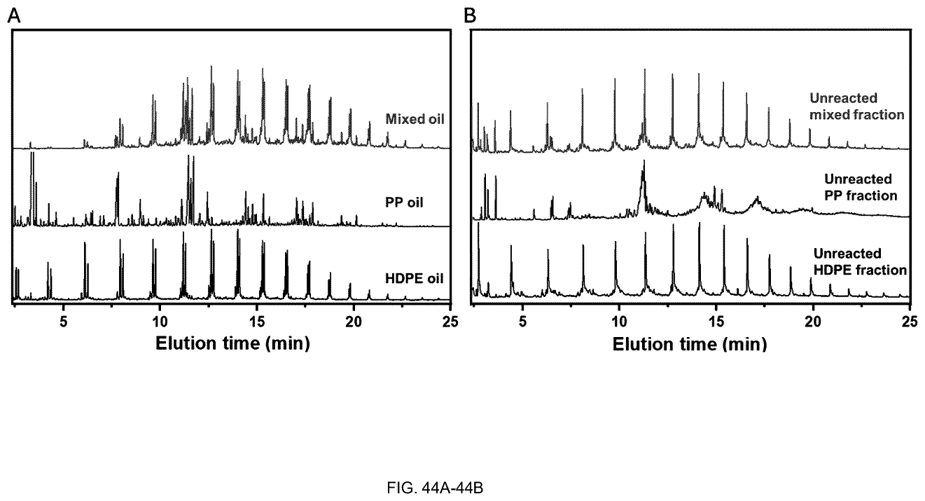

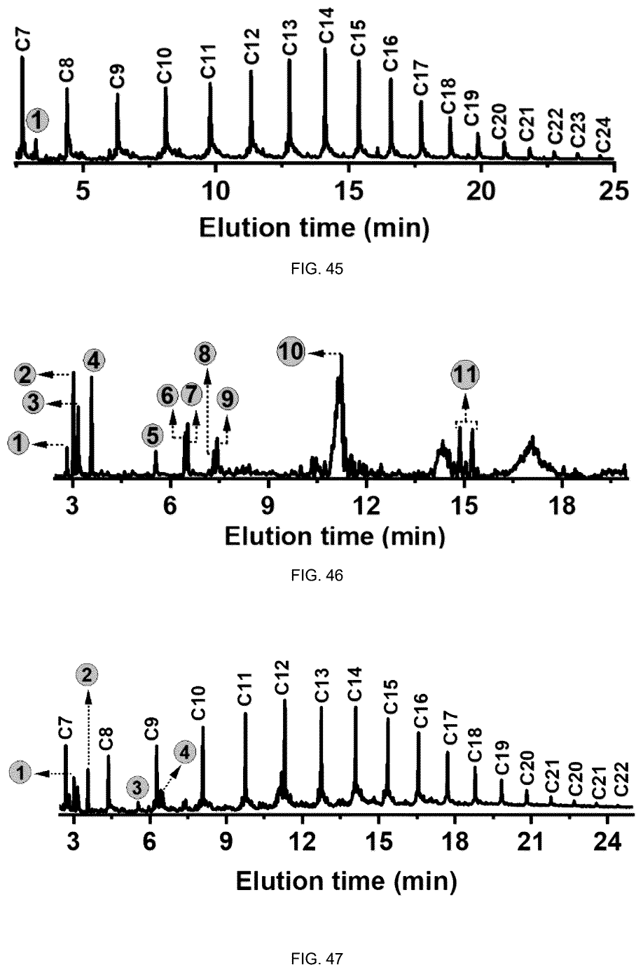

The alkene component of the oil was functionalized through sulfation with concentrated sulfuric acid (conc. H₂SO₄) under mild temperatures. Conc. H₂SO₄ is a widely available and cheap chemical ($146/ton) and is thus a practical choice for large scale upcycling. The resulting alkyl hydrogensulfates were neutralized using aqueous KOH to form sulfate detergents. Notably, the alkane component was unaffected by the sulfation condition and could be extracted out by washing the reaction crude with hexanes. GC-MS confirms that the extracts are comprised of mostly saturated hydrocarbons within the ~C₇ to C₂₆ range (FIGS. 44-47). As such, the unreacted fraction of the thermolysis oil can serve as alternative fuel without additional hydrogenation treatment.

TABLE 9
Hydrocarbon product distributions from previous reports and this work.

| Polymer | Method | Catalyst | Condition | C# range^{a} | Reference |
|---|---|---|---|---|---|
| PE, PP | hydrocracking | mSiO₂/Pt/SiO₂ | H₂ (13.8 bar), | C₁₁₋₂₄ | ^{[16]} |
| | | | 250° C., 6 h | | |
| PE | alkane metathesis | [Ir]/γ-Al₂O₃ and | 175° C., | C₆₋₃₆ | ^{[15]} |
| | | Re₂O₇/γ-Al₂O₃ | 24-72 h | | |
| PE | photothermal | Ru/TiO2 | H₂(40 bar), | C₅₋₂₁ | ^{[11]} |
| | hydrocracking | | 200-300° C., 3 h | | |
| PE, PP | temperature- | No need | hot zone: 360- | C₇₋₂₆ | This work |
| | gradient | | 400° C., | | |
| | thermolysis | | cold zone (rt- | | |
| | | | 90° C.), 1 atm | | |

^{a}carbon number range of the oil fraction

TABLE 10
Alkenyl concentrations in plastic thermolysis
products. The concentrations were evaluated with
¹H NMR through the internal standard method.

| | Wax alkenyl concentration | | | Oil alkenyl concentration | | |
|---|---|---|---|---|---|---|
| | | Internal | terminal | | Internal | terminal |
| Polymer | c_{C═C} | C═C | C═C | c_{C═C} | C═C | C═C |
| feedstock | (mmol/g) | (mol %) | (mol %) | (mmol/g) | (mol %) | (mol %) |
| HDPE | 1.2 | 21.3 | 78.7 | 3.8 | 9.9 | 90.1 |
| PP | 4.6 | 7.5 | 92.5 | 7.1 | ~0.0 | ~100.0 |
| Mixture | 1.8 | 15.6 | 84.4 | 3.8 | 6.6 | 93.4 |

TABLE 11
Molar mass characterization of thermolysis products
obtained from plastic wastes. Both lignin-GPC and
HT-GPC were utilized to determine the molar masses.

| | Wax molecular | | Oil molecular | |
|---|---|---|---|---|
| Polymer | weights | | weights | |
| feedstock | Mw (Da) | Mn (Da) | Mw (Da) | Mn (Da) |
| PE | 653 | 382 | 230 | 180 |
| PP | 1289 | 565 | 300 | 250 |
| Mixture | 515 | 244 | 250 | 200 |
| (75% PE, 25% PP) | | | | |

TABLE 12
Molar mass characterization of plastics employed in the degradation
experiments. The studies were performed using HT-GPC.

| Polymer | M_{w} (kDa) | Mₙ (kDa) | Dispersity |
|---|---|---|---|
| HDPE | 88.4 | 21.3 | 4.2 |
| LDPE | 70.6 | 23.8 | 3.0 |
| LLDPE | 35.3 | 13.5 | 2.6 |
| PP | 147.6 | 49.0 | 3.0 |

### REFERENCES

Unless specified elsewhere in the disclosure, references cited in the disclosure are enumerated below. References may be cited herein using the format of reference number(s) enclosed by parentheses corresponding to one or more of the following numbered references. References may also be cited herein using a superscript format. For example, citation of references numbers 1 and 2 immediately herein below could be indicated in the disclosure as (Refs. 1 and 2) or as the superscript “¹⁻².”

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. Furthermore, any incorporation by reference of patents and patent applications to which the instant application claims priority is not intended to extend to any lexicographical definitions in the patents and patent applications so incorporated and should not be read as limiting the accompanying claims.

The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

### REFERENCES FOR EXAMPLE 1

(1) Geyer, R.; Jambeck, J. R.; Law, K. L., Production, use, and fate of all plastics ever made. Science Advances 2017, 3 (7), e1700782.
(2) Nicholson, S. R.; Rorrer, N. A.; Carpenter, A. C.; Beckham, G. T., Manufacturing energy and greenhouse gas emissions associated with plastics consumption. Joule 2021, 5 (3), 673-686.
(3) Hopewell, J.; Dvorak, R.; Kosior, E., Plastics recycling: challenges and opportunities. Philosophical Transactions of the Royal Society B: Biological Sciences 2009, 364 (1526), 2115-2126.
(4) Zhang, Y.; Wang, G.; Zhang, Q.; Ji, Y.; Xu, H., What determines urban household intention and behavior of solid waste separation? A case study in China. Environmental Impact Assessment Review 2022, 93, 106728.
(5) Abel, B. A.; Snyder, R. L.; Coates, G. W., Chemically recyclable thermoplastics from reversible-deactivation polymerization of cyclic acetals. Science 2021, 373 (6556), 783-789.
(6) Korley, L. T. J.; Epps, T. H., 3rd; Helms, B. A.; Ryan, A. J., Toward polymer upcycling-adding value and tackling circularity. Science 2021, 373 (6550), 66-69.
(7) Jehanno, C.; Alty, J. W.; Roosen, M.; De Meester, S.; Dove, A. P.; Chen, E. Y.; Leibfarth, F. A.; Sardon, H., Critical advances and future opportunities in upcycling commodity polymers. Nature 2022, 603 (7903), 803-814.
(8) Chen, H.; Wan, K.; Zhang, Y.; Wang, Y., Waste to Wealth: Chemical Recycling and Chemical Upcycling of Waste Plastics for a Great Future. ChemSusChem 2021, 14 (19), 4123-4136.
(9) Huang, Z.; Shanmugam, M.; Liu, Z.; Brookfield, A.; Bennett, E. L.; Guan, R.; Vega Herrera, D. E.; Lopez-Sanchez, J. A.; Slater, A. G.; McInnes, E. J. L.; Qi, X.; Xiao, J., Chemical Recycling of Polystyrene to Valuable Chemicals via Selective Acid-Catalyzed Aerobic Oxidation under Visible Light. Journal of the American Chemical Society 2022, 144 (14), 6532-6542.
(10) Xu, Z.; Pan, F.; Sun, M.; Xu, J.; Munyaneza, N. E.; Croft, Z. L.; Cai, G.; Liu, G., Cascade degradation and upcycling of polystyrene waste to high-value chemicals. Proceedings of the National Academy of Sciences 2022, 119 (34), e2203346119.
(11) Cao, R.; Zhang, M.-Q.; Hu, C.; Xiao, D.; Wang, M.; Ma, D., Catalytic oxidation of polystyrene to aromatic oxygenates over a graphitic carbon nitride catalyst. Nature Communications 2022, 13 (1), 4809-4819.
(12) Conley, R., Thermal stability of polymers. Marcel Dakker Inc.: New York, 1970; Vol. 1.
(13) Jia, X.; Qin, C.; Friedberger, T.; Guan, Z.; Huang, Z., Efficient and selective degradation of polyethylenes into liquid fuels and waxes under mild conditions. Science Advances 2016, 2 (6), e1501591.
(14) Zhang, F.; Zeng, M.; Yappert, R. D.; Sun, J.; Lee, Y. H.; LaPointe, A. M.; Peters, B.; Abu-Omar, M. M.; Scott, S. L., Polyethylene upcycling to long-chain alkylaromatics by tandem hydrogenolysis/aromatization. Science 2020, 370 (6515), 437-441.
(15) Conk, R. J.; Hanna, S.; Shi, J. X.; Yang, J.; Ciccia, N. R.; Qi, L.; Bloomer, B. J.; Heuvel, S.; Wills, T.; Su, J.; Bell, A. T.; Hartwig, J. F., Catalytic deconstruction of waste polyethylene with ethylene to form propylene. Science 2022, 377 (6614), 1561-1566.
(16) Trachsel, A.; Chapuis, C.; Herrmann, A., Slow release of fragrance aldehydes and ketones in functional perfumery from dynamic mixtures generated with N-heteroarylmethyl-substituted secondary diamines. Flavour and Fragrance Journal 2013, 28 (5), 280-293.
(17) Kumar Sen, S.; Raut, S., Microbial degradation of low density polyethylene (LDPE): A review. Journal of Environmental Chemical Engineering 2015, 3 (1), 462-473.
(18) Melby, L. R., Nitric Acid Oxidation of High-Density Polyethylene. Organic Chemical Aspects. Macromolecules 2002, 11 (1), 50-56.
(19) Kanbur, U.; Zang, G.; Paterson, A. L.; Chatterjee, P.; Hackler, R. A.; Delferro, M.; Slowing, I. I.; Perras, F. A.; Sun, P.; Sadow, A. D., Catalytic carbon-carbon bond cleavage and carbon-element bond formation give new life for polyolefins as biodegradable surfactants. Chem 2021, 7(5), 1347-1362.
(20) Gracida-Alvarez, U. R.; Mitchell, M. K.; Sacramento-Rivero, J. C.; Shonnard, D. R., Effect of Temperature and Vapor Residence Time on the Micropyrolysis Products of Waste High Density Polyethylene. Industrial & Engineering Chemistry Research 2018, 57 (6), 1912-1923.
(21) Holmström, A.; Sörvik, E., Thermal degradation of polyethylene in a nitrogen atmosphere of low oxygen content. Ill. Structural changes occurring in low-density polyethylene at oxygen contents below 1.2%. Journal of Applied Polymer Science 1974, 18 (10), 3153-3178.
(22) Al-Salem, S. M.; Dutta, A., Wax Recovery from the Pyrolysis of Virgin and Waste Plastics. Industrial & Engineering Chemistry Research 2021, 60 (22), 8301-8309.
(23) Celik, G.; Kennedy, R. M.; Hackler, R. A.; Ferrandon, M.; Tennakoon, A.; Patnaik, S.; LaPointe, A. M.; Ammal, S. C.; Heyden, A.; Perras, F. A.; Pruski, M.; Scott, S. L.; Poeppelmeier, K. R.; Sadow, A. D.; Delferro, M., Upcycling Single-Use Polyethylene into High-Quality Liquid Products. ACS Central Science 2019, 5 (11), 1795-1803.
(24) Vrkoslav, V.; Mikove, R.; Cvac̆ka, J., Characterization of natural wax esters by MALDI-TOF mass spectrometry. Journal of Mass Spectrometry 2009, 44 (1), 101-110.
(25) Egloff, G. In THE EFFECT OF METAL OXIDES ON PARAFFIN HYDROCARBONS, 2nd World Petroleum Congress, 1937.
(26) Waters, C., The Catalytic Oxidation of Petroleum Oils. Industrial & Engineering Chemistry 1921, 13 (10), 901-903.
(27) George, P.; Rideal, E. K.; Robertson, A., The oxidation of liquid hydrocarbons. I. The chain formation of hydroperoxides and their decomposition. Proceedings of the Royal Society of London. Series A. Mathematical and Physical Sciences 1946, 185 (1002), 288-309.
(28) Sullivan, K. P.; Werner, A. Z.; Ramirez, K. J.; Ellis, L. D.; Bussard, J. R.; Black, B. A.; Brandner, D. G.; Bratti, F.; Buss, B. L.; Dong, X.; Haugen, S. J.; Ingraham, M. A.; Konev, M. O.; Michener, W. E.; Miscall, J.; Pardo, I.; Woodworth, S. P.; Guss, A. M.; Romen-Leshkov, Y.; Stahl, S. S.; Beckham, G. T., Mixed plastics waste valorization through tandem chemical oxidation and biological funneling. Science 2022, 378 (6616), 207-211.
(29) Meziani, A.; Touraud, D.; Zradba, A.; Clausse, M.; Kunz, W., Co-surfactant properties of ketones. Journal of Molecular Liquids 2000, 84 (3), 301-311.
(30) Benson, S. W.; Buss, J. H., Additivity Rules for the Estimation of Molecular Properties. Thermodynamic Properties. The Journal of Chemical Physics 1958, 29 (3), 546-572.
(31) Stein, S. E.; Brown, R. L., Structures and Properties Group Additivity Model. In NIST Chemistry WebBook, Linstrom, P. J.; Mallard, W. G., Eds.
(32) Sabbe, M. K.; Reyniers, M. F.; Van Speybroeck, V.; Waroquier, M.; Marin, G. B., Carbon-centered radical addition and beta-scission reactions: modeling of activation energies and pre-exponential factors. Chemphyschem 2008, 9 (1), 124-40.
(33) Bockhorn, H.; Hornung, A.; Hornung, U.; Schawaller, D., Kinetic study on the thermal degradation of polypropylene and polyethylene. Journal of Analytical and Applied Pyrolysis 1999, 48 (2), 93-109.
(34) Marcilla, A.; Beltren, M. I.; Navarro, R., Evolution of products during the degradation of polyethylene in a batch reactor. Journal of Analytical and Applied Pyrolysis 2009, 86 (1), 14-21.
(35) Zhao, D.; Wang, X.; Miller, J. B.; Huber, G. W., The Chemistry and Kinetics of Polyethylene Pyrolysis: A Process to Produce Fuels and Chemicals. ChemSusChem 2020, 13 (7), 1764-1774.
(36) Kiang, J. K. Y.; Uden, P. C.; Chien, J. C. W., Polymer reactions-Part VII: Thermal pyrolysis of polypropylene. Polymer Degradation and Stability 1980, 2 (2), 113-127.
(37) De Amorim, M. T. S. P.; Comel, C.; Vermande, P., Pyrolysis of polypropylene: I. Identification of compounds and degradation reactions. Journal of Analytical and Applied Pyrolysis 1982, 4 (1), 73-81.
(38) Michal, J.; Mitera, J.; Tardon, S., Toxicity of thermal degradation products of polyethylene and polypropylene. Fire and Materials 1976, 1 (4), 160-168.
(39) Elordi, G.; Olazar, M.; Lopez, G.; Artetxe, M.; Bilbao, J., Product Yields and Compositions in the Continuous Pyrolysis of High-Density Polyethylene in a Conical Spouted Bed Reactor. Industrial & Engineering Chemistry Research 2011, 50 (11), 6650-6659.
(40) Das, P.; Tiwari, P., Valorization of packaging plastic waste by slow pyrolysis. Resources, Conservation and Recycling 2018, 128, 69-77.
(41) Sabine, H. Oxidation of paraffinic hydrocarbons. U.S. Pat. No. 2,391,236A, 1945.
(42) Favis, D. V. Selective ozone oxidation of hydrocarbons. 2955123, 1956.
(43) Wiel, A. V. D.; Ernsting, B. C. Wax treating process. 4140619, 1977.
(44) Wang, Y.; Zhao, Y.; Liu, J.; Li, Z.; Waterhouse, G. I. N.; Shi, R.; Wen, X.; Zhang, T., Manganese Oxide Modified Nickel Catalysts for Photothermal CO Hydrogenation to Light Olefins. Advanced Energy Materials 2019, 10 (5).
(45) Puglisi, A.; Mondini, S.; Cenedese, S.; Ferretti, A. M.; Santo, N.; Ponti, A., Monodisperse Octahedral α-MnS and MnO Nanoparticles by the Decomposition of Manganese Oleate in the Presence of Sulfur. Chemistry of Materials 2010, 22 (9), 2804-2813.

### REFERENCES FOR EXAMPLE 1 SUPPORTING INFORMATION

(1) Tong, H. Y.; Karasek, F. W., Flame ionization detector response factors for compound classes in quantitative analysis of complex organic mixtures. Analytical Chemistry 1984, 56 (12), 2124-2128.
(2) Jorgensen, A. D.; Picel, K. C.; Stamoudis, V. C., Prediction of gas chromatography flame ionization detector response factors from molecular structures. Analytical Chemistry 1990, 62 (7), 683-689.
(3) Jin, C.; Viidanoja, J.; Li, M.; Zhang, Y.; Ikonen, E.; Root, A.; Romanczyk, M.; Manheim, J.; Dziekonski, E.; Kenttamaa, H. I., Comparison of Atmospheric Pressure Chemical Ionization and Field Ionization Mass Spectrometry for the Analysis of Large Saturated Hydrocarbons. Anal Chem 2016, 88 (21), 10592-10598.
(4) Benson, S. W.; Buss, J. H., Additivity Rules for the Estimation of Molecular Properties. Thermodynamic Properties. The Journal of Chemical Physics 1958, 29 (3), 546-572.
(5 Stein, S. E.; Brown, R. L., Structures and Properties Group Additivity Model. In NIST Chemistry WebBook, Linstrom, P. J.; Mallard, W. G., Eds.
(6) Sabbe, M. K.; Reyniers, M. F.; Van Speybroeck, V.; Waroquier, M.; Marin, G. B., Carbon-centered radical addition and beta-scission reactions: modeling of activation energies and pre-exponential factors. Chemphyschem 2008, 9 (1), 124-40.
(7) Odian, G., Radical Chain Polymerization. In Principles of Polymerization, 2004; pp 198-349.
(8) Bartlett, P. D.; Altschul, R., The Polymerization of Allyl Compounds. I. Factors Governing the Acyl Peroxide-Induced Polymerization of Allyl Acetate, and the Fate of the Peroxide. Journal of the American Chemical Society 1946, 67 (5), 812-816.
(9) Bradley, T. F.; Tess, R. W., Thermal Polymerization of Esters of Drying Oil Acids. Industrial & Engineering Chemistry 2002, 41 (2), 310-319.
(10) Bockhorn, H.; Hornung, A.; Hornung, U.; Schawaller, D., Kinetic study on the thermal degradation of polypropylene and polyethylene. Journal of Analytical and Applied Pyrolysis 1999, 48 (2), 93-109.
(11) Kuroki, T.; Sawaguchi, T.; Niikuni, S.; Ikemura, T., Mechanism for long-chain branching in the thermal degradation of linear high-density polyethylene. Macromolecules 1982, 15 (6), 1460-1464.
(12) Kiang, J. K. Y.; Uden, P. C.; Chien, J. C. W., Polymer reactions-Part VII: Thermal pyrolysis of polypropylene. Polymer Degradation and Stability 1980, 2 (2), 113-127.
(13) De Amorim, M. T. S. P.; Comel, C.; Vermande, P., Pyrolysis of polypropylene. J. Anal. Appl. Pyrolysis 1982, 4 (1), 73-81.
(14) Gracida-Alvarez, U. R.; Mitchell, M. K.; Sacramento-Rivero, J. C.; Shonnard, D. R., Effect of Temperature and Vapor Residence Time on the Micropyrolysis Products of Waste High Density Polyethylene. Industrial & Engineering Chemistry Research 2018, 57 (6), 1912-1923.
(15) Zhao, D.; Wang, X.; Miller, J. B.; Huber, G. W., The Chemistry and Kinetics of Polyethylene Pyrolysis: A Process to Produce Fuels and Chemicals. ChemSusChem 2020, 13 (7), 1764-1774.
(16) Marcilla, A.; Beltren, M. I.; Navarro, R., Evolution of products during the degradation of polyethylene in a batch reactor. Journal of Analytical and Applied Pyrolysis 2009, 86 (1), 14-21.
(17) Michal, J.; Mitera, J.; Tardon, S., Toxicity of thermal degradation products of polyethylene and polypropylene. Fire and Materials 1976, 1 (4), 160-168.
(18) Elordi, G.; Olazar, M.; Lopez, G.; Artetxe, M.; Bilbao, J., Product Yields and Compositions in the Continuous Pyrolysis of High-Density Polyethylene in a Conical Spouted Bed Reactor. Industrial & Engineering Chemistry Research 2011, 50 (11), 6650-6659.
(19) Das, P.; Tiwari, P., Valorization of packaging plastic waste by slow pyrolysis. Resources, Conservation and Recycling 2018, 128, 69-77.

### REFERENCES FOR EXAMPLE 2

(1) G. Celik, R. M. Kennedy, R. A. Hackler, M. Ferrandon, A. Tennakoon, S. Patnaik, A. M. LaPointe, S. C. Ammal, A. Heyden, F. A. Perras, M. Pruski, S. L. Scott, K. R. Poeppelmeier, A. D. Sadow, M. Delferro, ACS Central Science 2019, 5, 1795-1803.
(2) V. Lahtela, M. Hyvsrinen, T. Karki, in Polymers, Vol. 11, 2019.
(3) E. Butler, G. Devlin, K. McDonnell, Waste and Biomass Valorization 2011, 2, 227-255.
(4) C.-F. Schleussner, G. Ganti, J. Rogelj, M. J. Gidden, Communications Earth & Environment 2022, 3, 135.
(5) S. D. Anuar Sharuddin, F. Abnisa, W. M. A. Wan Daud, M. K. Aroua, Energy Conversion and Management 2016, 115, 308-326.
(6) T. Thiounn, R. C. Smith, Journal of Polymer Science 2020, 58, 1347-1364.
(7) C. Kassargy, S. Awad, G. Burnens, K. Kahine, M. Tazerout, Journal of Analytical and Applied Pyrolysis 2017, 127, 31-37.
(8) S. Bezergianni, A. Dimitriadis, G.-C. Faussone, D. Karonis, in Energies, Vol. 10, 2017.
(9) V. L. Mangesh, T. Perumal, S. Subramanian, S. Padmanabhan, Energy & Fuels 2020, 34, 8824-8836.
(10) Z. Dobó, G. Kecsmár, G. Nagy, T. Koós, G. Muránszky, M. Ayari, Energy & Fuels 2021, 35, 2347-2356.
(11) Y. Miao, Y. Zhao, G. I. N. Waterhouse, R. Shi, L.-Z. Wu, T. Zhang, Nature Communications 2023, 14, 4242.
(12) X. Jia, C. Qin, T. Friedberger, Z. Guan, Z. Huang, Science Advances, 2, e1501591.
(13) L. D. Ellis, S. V. Orski, G. A. Kenlaw, A. G. Norman, K. L. Beers, Y. Romen-Leshkov, G. T. Beckham, ACS Sustainable Chemistry & Engineering 2021, 9, 623-628.
(14) D. Kim, Z. R. Hinton, P. Bai, L. T. J. Korley, T. H. Epps, R. F. Lobo, Applied Catalysis B: Environmental 2022, 318, 121873.
(15) X. Jia, C. Qin, T. Friedberger, Z. Guan, Z. Huang, Science Advances 2016, 2, e1501591.
(16) A. Tennakoon, X. Wu, A. L. Paterson, S. Patnaik, Y. Pei, A. M. LaPointe, S. C. Ammal, R. A. Hackler, A. Heyden, I. I. Slowing, G. W. Coates, M. Delferro, B. Peters, W. Huang, A. D. Sadow, F. A. Perras, Nature Catalysis 2020, 3, 893-901.
(17) J. Chupa, S. Misner, A. Sachdev, P. Wisniewski, G. A. Smith, in Handbook of Industrial Chemistry and Biotechnology (Ed.: J. A. Kent), Springer US, Boston, MA, 2012, pp. 1431-1471.
(18) M. G. Lucchetti, L. Paolotti, L. Rocchi, A. Boggia, Environmental and Climate Technologies 2019, 23, 238-257.
(19) L. Thannimalay, S. Yusoff, World Applied Sciences Journal 2014, 31, 1635-1647.
(20) B. Liu, T. Li, W. Wang, L. M. C. Sagis, Q. Yuan, X. Lei, M. A. Cohen Stuart, D. Li, C. Bao, J. Bai, Z. Yu, F. Ren, Y. Li, Nature Sustainability 2020, 3, 448-458.
(21) C. B. B. Farias, F. C. G. Almeida, I. A. Silva, T. C. Souza, H. M. Meira, R. d. C. F. Soares da Silva, J. M. Luna, V. A. Santos, A. Converti, I. M. Banat, L. A. Sarubbo, Electronic Journal of Biotechnology 2021, 51, 28-39.
(22) Z. Xu, N. E. Munyaneza, Q. Zhang, M. Sun, C. Posada, P. Venturo, N. A. Rorrer, J. Miscall, B. G. Sumpter, G. Liu, Science 2023, 381, 666-671.
(23) J. Aguado, D. Serrano, J. Escola, in Feedstock recycling and pyrolysis of waste plastics: converting waste plastics into diesel and other fuels, 2006, pp. 73-110.
(24) I. Ahmad, M. I. Khan, H. Khan, M. Ishaq, R. Tariq, K. Gul, W. Ahmad, International Journal of Green Energy 2015, 12, 663-671.
(25) L. Ballice, R. Reimert, Chemical Engineering and Processing: Process Intensification 2002, 41, 289-296.
(26) E. Jakab, G. Verhegyi, O. Faix, Journal of Analytical and Applied Pyrolysis 2000, 56, 273-285.
(27) P. Das, P. Tiwari, Resources, Conservation and Recycling 2018, 128, 69-77.
(28) M. Bauer, M. Lehner, D. Schwabl, H. Flachberger, L. Kranzinger, R. Pomberger, W. Hofer, Journal of Material Cycles and Waste Management 2018, 20, 1781-1791.
(29) N. Prieto Vidal, O. Adeseun Adigun, T. H. Pham, A. Mumtaz, C. Manful, G. Callahan, P. Stewart, D. Keough, R. H. Thomas, in Molecules, Vol. 23, 2018.
(30) K. M. Wilkinson, C. D. Bain, H. Matsubara, M. Aratono, ChemPhysChem 2005, 6, 547-555.
(31) L. Yang, X. Li, J. Dong, Colloids and Surfaces A: Physicochemical and Engineering Aspects 2022, 641, 128513.
(32) Y. Ju, J. Hua, H. Niu, H. Chen, Langmuir 2023, 39, 12497-12509.
(33) J. Li, Y. Li, Y. Song, Z. Wang, Q. Zhang, Journal of Molecular Liquids 2018, 271, 373-379.
(34) K. Bijma, J. B. F. N. Engberts, M. J. Blandamer, P. M. Cullis, P. M. Last, K. D. Irlam, L. Giorgio Soldi, Journal of the Chemical Society, Faraday Transactions 1997, 93, 1579-1584.
(35) S. A. Markarian, L. R. Harutyunyan, R. S. Harutyunyan, Journal of Solution Chemistry 2005, 34, 361-368.
(36) E. Bäckström, K. Odelius, M. Hakkarainen, Industrial & Engineering Chemistry Research 2017, 56, 14814-14821.
(37) L. Chen, K. G. Malollari, A. Uliana, D. Sanchez, P. B. Messersmith, J. F. Hartwig, Chem 2021, 7, 137-145.
(38) S. Albonetti, F. Cavani, F. TrifirÒ, Catalysis Reviews 1996, 38, 413-438.
(39) R. L. Raymond, Journal of Industrial Microbiology and Biotechnology 1999, 22, 206-215.
(40) J. A. Onwudili, N. Insura, P. T. Williams, Journal of Analytical and Applied Pyrolysis 2009, 86, 293-303.
(41) A. R. Ardiyanti, S. A. Khromova, R. H. Venderbosch, V. A. Yakovlev, H. J. Heeres, Applied Catalysis B: Environmental 2012, 117-118, 105-117.
(42) C. K. Westbrook, H. J. Curran, in Computer Aided Chemical Engineering, Vol. 45 (Eds.: T. Faravelli, F. Manenti, E. Ranzi), Elsevier, 2019, pp. 363-443.

### REFERENCES FOR EXAMPLE 2 SUPPLEMENTAL INFORMATION

(1) T. M. Research, in Detergents Market, 2022.
(2) S. Rebello, A. N. Anoopkumar, R. Sindhu, P. Binod, A. Pandey, E. M. Aneesh, in Refining Biomass Residues for Sustainable Energy and Bioproducts (Eds.: R. P. Kumar, E. Gnansounou, J. K. Raman, G. Baskar), Academic Press, 2020, pp. 511-521.
(3) J. Wisetkomolmat, P. Suppakittpaisarn, S. R. Sommano, in Resources, Vol. 8, 2019.
(4) H. Ritchie, M. Roser, Our World in Data 2024.

It should be emphasized that the above-described aspects of the present disclosure are merely possible examples of implementations, and are set forth only for a clear understanding of the principles of the disclosure. Many variations and modifications may be made to the above-described aspects of the disclosure without departing substantially from the spirit and principles of the disclosure. All such modifications and variations are intended to be included herein within the scope of this disclosure. It is intended that the specification and examples be considered as exemplary only, with a true scope and spirit of the disclosure being indicated by the following claims.

1. (canceled)

2. (canceled)

3. (canceled)

4. (canceled)

5. A method of preparing mixture of waxes and/or oils comprising introducing a polymer selected from the group consisting of a polypropylene, a polyethylene, and a combination thereof into a continuous flow reaction vessel in communication with a condenser or control system at a target temperature T_{c} to provide a sublimated mixture of waxes and/or oils collected on the condenser or heating control system, wherein the continuous flow reaction vessel is at or near a target temperature Tₕ and wherein the polymer has a residence time in the continuous flow reaction vessel to provide a mixture of waxes and/or oils.

6. (canceled)

7. The method according to claim 5, wherein the target temperature in the reaction vessel Tₕ is 260° C. to 500° C.

8. (canceled)

9. (canceled)

10. (canceled)

11. (canceled)

12. The method according to claim 5, wherein the polymer is exposed to an inert gas or to oxygen admixed with an inert gas, or to air admixed with an inert gas.

13. The method according to claim 12, wherein the inert gas is nitrogen or argon.

14. (canceled)

15. (canceled)

16. The method according to claim 5, wherein the vessel is heated at atmospheric pressure or near atmospheric pressure.

17. The method according to claim 5, wherein the polymer is selected from the group consisting of a crosslinked polypropylene, a crosslinked polyethylene, a linear polypropylene, a linear polyethylene, and combinations thereof.

18. The method according to claim 5, wherein the polymer is selected from the group consisting of a high-density polyethylene, a low-density polyethylene, a linear low-density polyethylene, a polyethylene copolymer, a polypropylene copolymer, a high-density crosslinked polyethylene, and combinations thereof.

19. (canceled)

20. (canceled)

21. The method according to claim 5, wherein the target temperature in the condenser or control system T_{c} is about −195° C. to 250° C.

22. (canceled)

23. (canceled)

24. The method according to claim 5, wherein a wt % of light hydrocarbons having 8 or fewer carbon atoms in the mixture of waxes and/or oils is about 10 wt % or less based upon a total weight of the mixture of waxes and/or oils.

25. (canceled)

26. The method according to claim 5, wherein the mixture of waxes and/or oils independently has a hydrocarbon length of C7-C47and is either acyclic, cyclic or a combination thereof.

27. The method according to claim 5, wherein the mixture of waxes and/or oils are independently unsaturated hydrocarbons, saturated hydrocarbons, or a combination thereof.

28. The method according to claim 5, wherein the method further comprises neutralization.

29. (canceled)

30. (canceled)

31. The method according to claim 5, wherein the waxes and/or oils are further hydrogenated, oxidized, sulfated, sulfonated, hydroformylated, or hydroborated.

32. (canceled)

33. (canceled)

34. The method according to claim 5, wherein manganese alkyl carboxylate is added to the mixture of waxes and/or oils.

35. (canceled)

36. (canceled)

37. (canceled)

38. (canceled)

39. The method according to claim 26, wherein the mixture of waxes and/or oils independently has a hydrocarbon length of C9-C36, and is either acyclic, cyclic, or a combination thereof.
